(19) United States
(12) Patent Application Publication
(10) Pub. No.: US 2023/0276470 A1
(43) Pub. Date: Aug. 31, 2023

(54) 5G MULTICAST-BROADCAST SERVICES (MBS) RADIO ACCESS NETWORK ARCHITECTURE AND OPERATION

(71) Applicant: INTERDIGITAL PATENT HOLDINGS, INC., Wilmington, DE (US)

(72) Inventors: Rocco DI GIROLAMO, Laval (CA); Pascal ADJAKPLE, Great Neck, NY (US); Kyle PAN, Saint James, NY (US); Zhuo CHEN, CLaymont, DE (US)

(21) Appl. No.: 18/040,338

(22) PCT Filed: Aug. 5, 2021
(86) PCT No.: PCT/US2021/044652

§ 371 Date: Feb. 2, 2023

Related U.S. Application Data
(60) Provisional application No. 63/061,764, filed on Aug. 5, 2020.
(60) Provisional application No. 63/168,515, filed on Mar. 31, 2021.

(51) Int. Cl. H04W 72/30

(52) U.S. Cl. CPC H04W 72/30

(57) ABSTRACT

Methods and apparatuses are described herein for 5G MBS operation. The proposed method and procedures overcome the limitations that have been observed in LTE and UTRAN MBMS operation, address the unique characteristic of 5G NR, and meet the requirements set out by the envisioned 5G MBS use cases by providing functions including RAN xcasting area concepts that are flexible and dynamic, MBS radio bearer (MRB) types to support MBS services, RAN architectures to support the various MBS radio bearer types, as well as functionality split across the RAN nodes to support these radio bearers, procedures to allow radio bearer selection, monitoring, and switching, and procedures to allow xcast area management.

### CROSS-REFERENCE TO RELATED APPLICATIONS

This application claims the benefit of U.S. Provisional Patent Application No. 63/061,764, filed Aug. 5, 2020, and U.S. Provisional Patent Application No. 63/168,515, filed Mar. 31, 2021, which are hereby incorporated by reference in their entirety.

### BACKGROUND

Multicast/Broadcast Multimedia services (MBMS) are characterized by the distribution of common interest content, from one source entity to a number of receive entities that are interested in the service. Mobile networks are primarily designed for unicast services, and as a result not optimized for multicast/broadcast services. Providing multicast/broadcast services therefore requires optimizations in how the traffic from these services is transported over the core network and over the radio access network. Accordingly, there is a need for improved multicast/broadcast services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Methods and procedures to allow 5G MBS operation. The proposed method and procedures overcome the limitations that have been observed in LTE and UTRAN MBMS operation, address the unique characteristic of 5G NR, and meet the requirements set out by the envisioned 5G MBS use cases. Embodiments are described herein for a RAN xcasting area concept that is flexible and dynamic; MBS radio bearer (MRB) types to support MBS services; RAN architectures to support the various MBS radio bearer types, as well as functionality split across the RAN nodes to support these radio bearers; designs for the MBS configuration; designs for mapping MBS traffic to G-RNTIs; designs for the MBS control information; procedures to allow radio bearer selection, (re)configuration, monitoring, and path switching; and procedures to allow xcast area management.

### BRIEF DESCRIPTION OF THE DRAWINGS

FIG. 1A illustrates an example communications system in which the methods and apparatuses described and claimed herein may be embodied;

FIG. 1B illustrates a block diagram of an example apparatus or device configured for wireless communications;

FIG. 1C illustrates a system diagram of an example radio access network (RAN) and core network;

FIG. 1D illustrates a system diagram of another example RAN and core network;

FIG. 1E is a system diagram of another example RAN and core network;

FIG. 1F illustrates a block diagram of an example computing system;

FIG. 1G illustrates a block diagram of another example communications system;

FIG. 2 shows an example MBSFN Transmission;

FIG. 3 illustrates RAN Xcast Areas;

FIG. 4 illustrates Architecture Option 1;

FIG. 5 illustrate Architecture Option 2;

FIG. 6 illustrates Architecture Option 3;

FIG. 7 illustrates Architecture Option 1: User Plane Architecture for SC-PTP, SC-PTM, and non-SFN MC-PTM radio bearers;

FIG. 8 illustrates Architecture Option 1: User Plane Architecture for non-SFN MC-PTM radio bearer;

FIG. 9 illustrates Architecture Option 2: User Plane Architecture for SC-PTP;

FIG. 10 illustrates Architecture Option 2: User Plane Architecture for SC-PTM & SFN MC-PTM;

FIG. 11 illustrates Architecture Option 2: User Plane Architecture for non SFN MC-PTM;

FIG. 12 illustrates Architecture Option 3: User Plane Architecture for SFN MC-PTM;

FIG. 13 illustrates Architecture Option 3: User Plane Architecture for non-SFN MC-PTM;

FIG. 14 illustrates Architecture Option 1: Control Plane Architecture;

FIG. 15 illustrates Architecture Option 2: Control Plane Architecture for SC-PTM;

FIG. 16 illustrates Architecture Option 2: Control Plane Architecture for SFN SC-PTM;

FIG. 17 Architecture Option 2: Control Plane Architecture for non-SFN SC-PTM;

FIG. 18 illustrates Architecture Option 3: Control Plane Architecture for SFN MC-PTM;

FIG. 19 illustrates Architecture Option 3: Control Plane Architecture for non SFN MC-PTM;

FIG. 20 illustrates L2 Data Structure at gNB;

FIG. 21 illustrates the Radio Bearer Options for MBS traffic;

FIG. 22 illustrates the Mapping of MBS Traffic to G-RNTI;

FIG. 23 illustrates an example Mapping per service;

FIG. 24 illustrates the Mapping options of MBS control information to MCCH;

FIG. 25 illustrates an example Radio Bearer Maintenance for 5G QoS Flow;

FIG. 26 illustrates an example Mapping of 5G MBS QoS Flow to radio bearers;

FIG. 27 illustrates a process for determination of number of legs; and

FIG. 28 illustrates UE actions upon change on xcast area.

### DETAILED DESCRIPTION

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

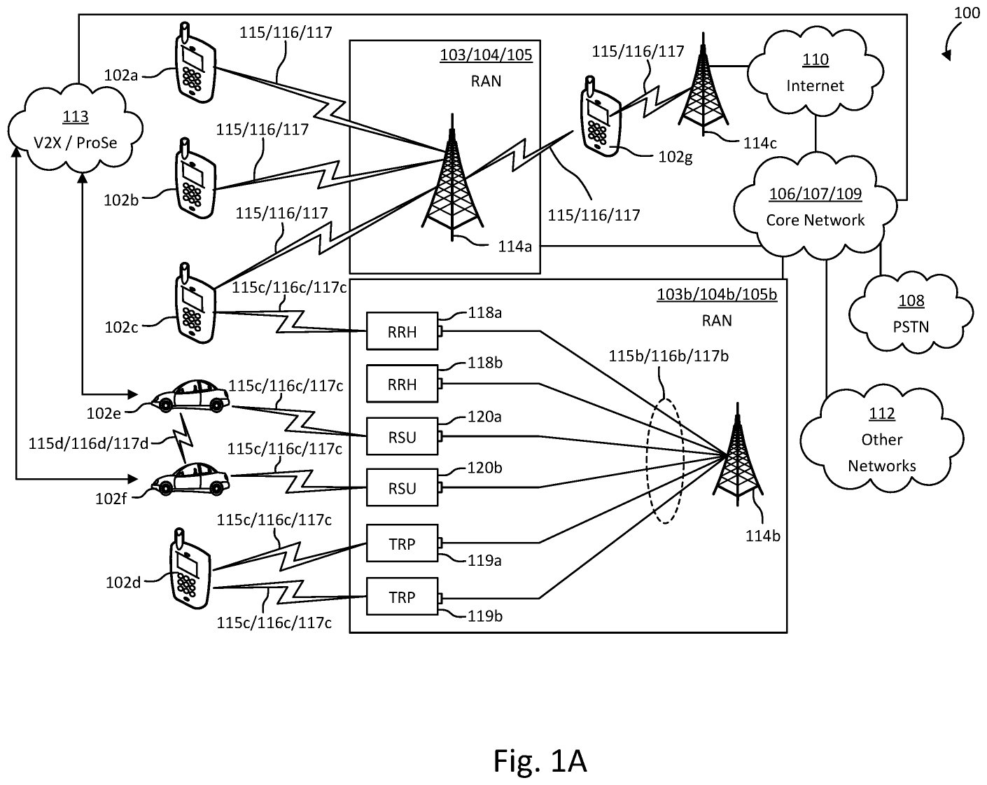

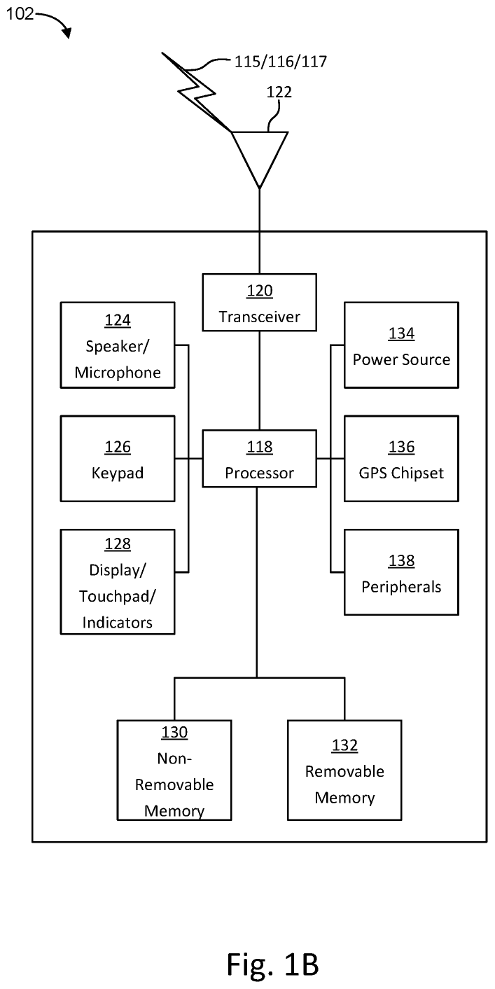

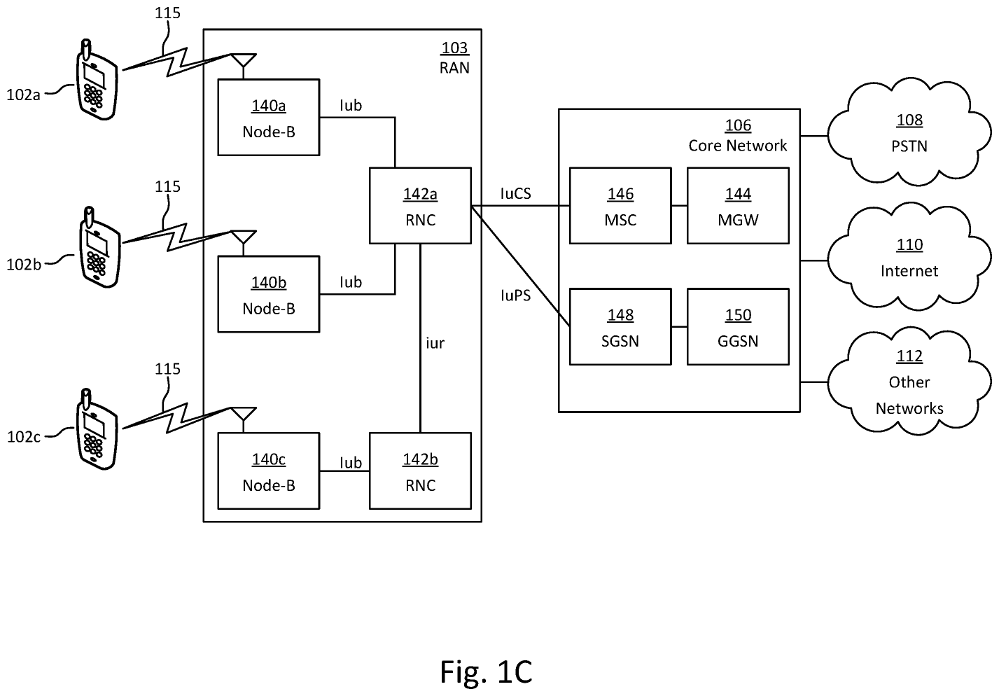

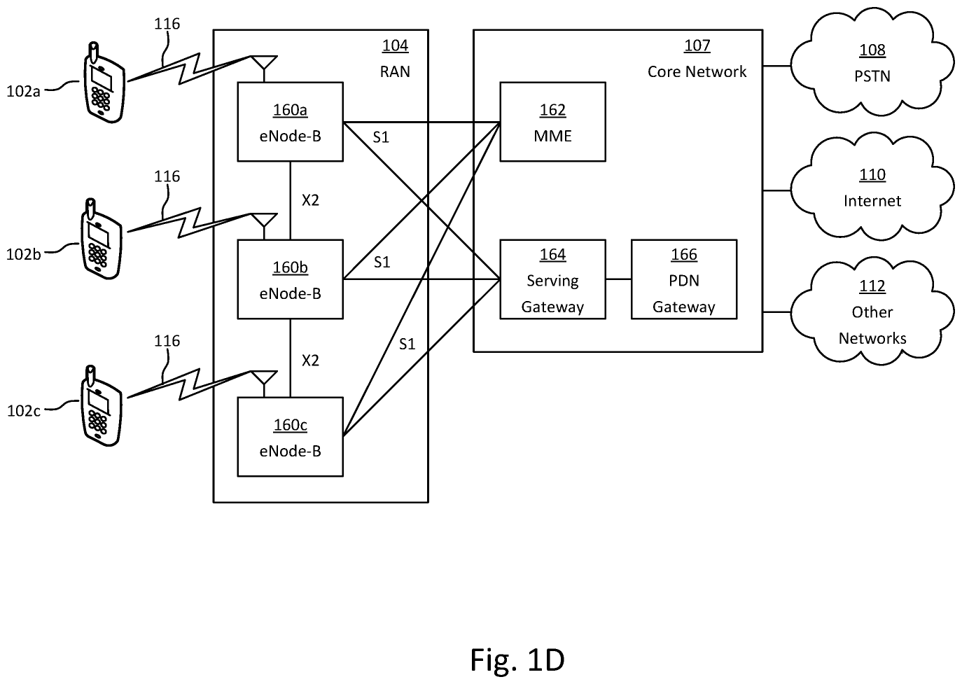

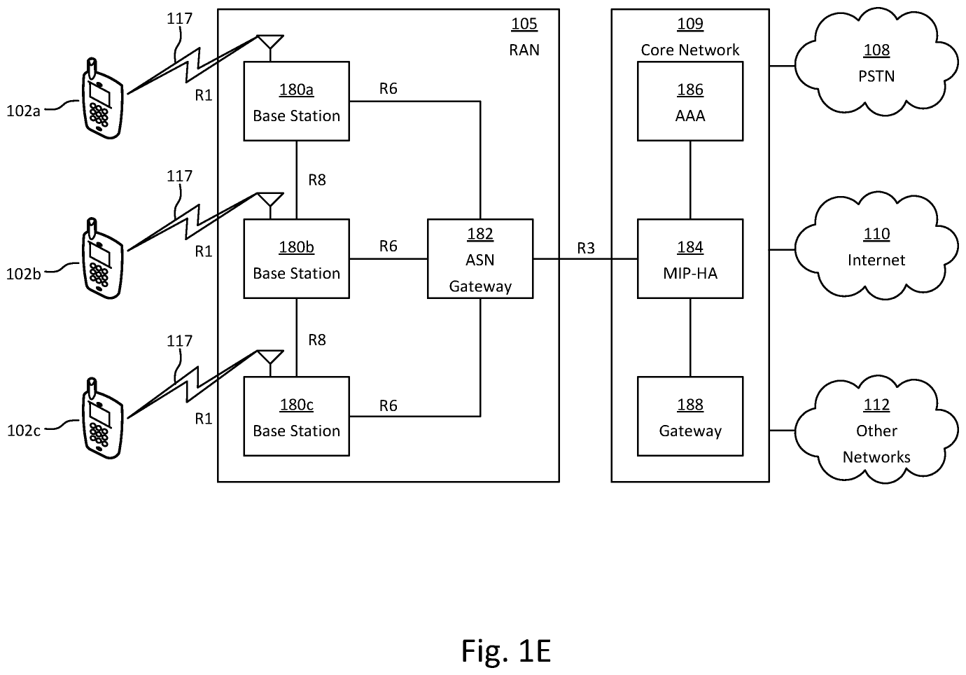

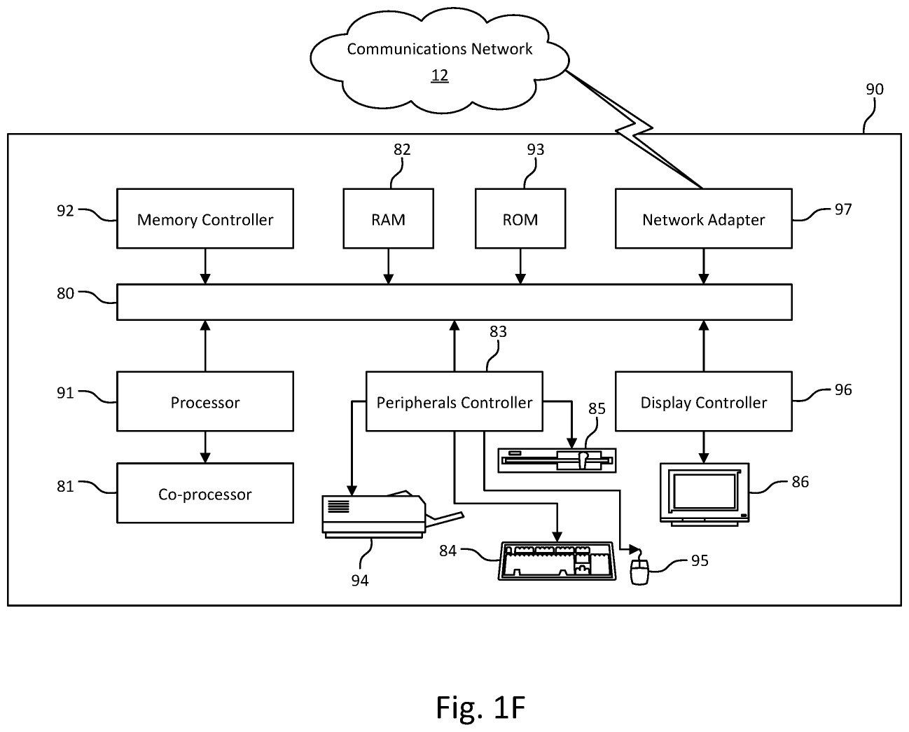

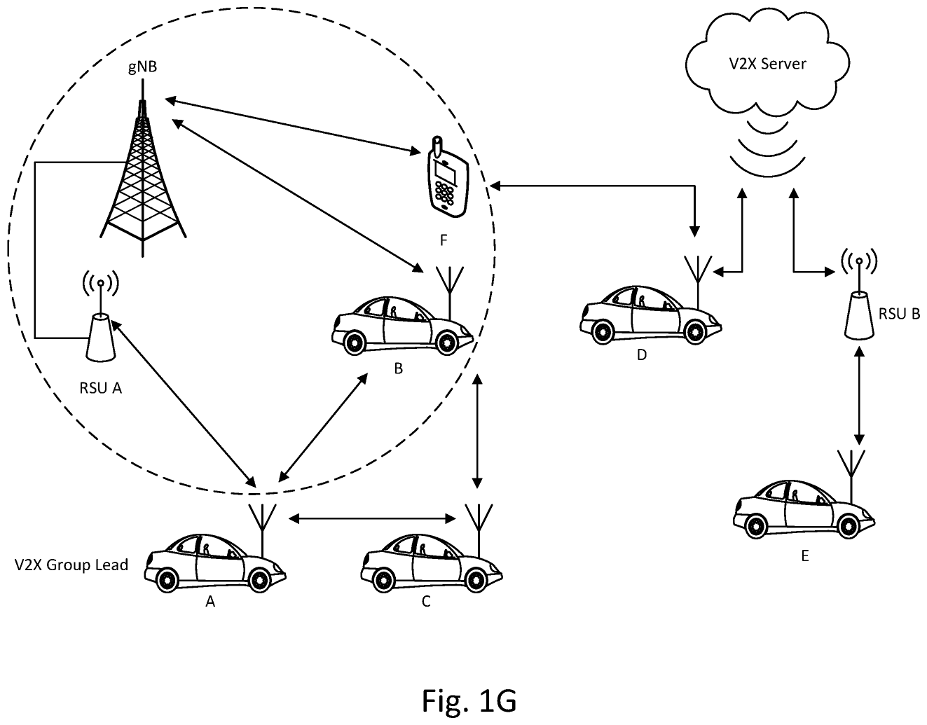

FIG. 1A illustrates one embodiment of an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 1A-1E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT). The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT)

The WTRUs 102a, 102b, 102c,102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications and etc.). The 3GPP NR technology includes NR V2X technologies and interface (such as Sidelink communications and etc.).

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 1A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 1A may be configured to communicate with the base station 114a, which may employ a cellular-based radio technology, and with the base station 114c, which may employ an IEEE 802 radio technology.

FIG. 1B is a block diagram of an example apparatus or device configured for wireless communications in accordance with the embodiments illustrated herein, such as for example, a WTRU 102. As shown in FIG. 1B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 1C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 1A, 1C, 1D, and 1E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 1A, 1B, 1C, 1D, and 1E are provided by way of example only, and it is understood that the subject matter disclosed and claimed herein may be embodied or implemented in any similar communication system, whether presently defined or defined in the future.

FIG. 1F is a block diagram of an exemplary computing system 90 in which one or more apparatuses of the communications networks illustrated in FIGS. 1A, 1C, 1D and 1E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 1A, 1B, 1C, 1D, and 1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 1G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

Multicast/Broadcast Multimedia services (MBMS) are characterized by the distribution of common interest content, from one source entity to a number of receive entities that are interested in the service. Mobile networks are primarily designed for unicast services, and as a result not optimized for multicast/broadcast services. Providing multicast/broadcast services therefore requires optimizations in how the traffic from these services is transported over the core network and over the radio access network.

The support of MBMS over LTE networks has evolved considerably over the various releases of LTE. Table 1 below shows a summary of the major changes/enhancements by release. Additional details are provided below.

TABLE 1
Evolution of MBMS in LTE

| Release 8 | Release 9 | Release 10-12 | Release 13 | Release 14 | Release 16 |
|---|---|---|---|---|---|
| Initial Release | Main use case was | Added counting, | Added SC- | Added SC- | Enhancements |
| of LTE. No | video broadcast | service | PTM | PTM for V2X | to terrestrial |
| MBS support | Introduced | continuity, | Mostly for | use cases to | broadcast (new |
| | changes to RAN | MBMS | public | address latency | frame |
| | and system | operation on | safety use | considerations | structures, new |
| | architecture | Demand | cases | and IoT use | cyclic prefixes) |
| | MBSFN included | (MooD) | | cases to | to find solutions |
| | from the start but | | | address | to allow EN-TV |
| | on a shared carrier | | | reaching a | to meet 5G |
| | | | | large number | broadcast |
| | | | | of constrained | requirements |
| | | | | UEs - possibly | for “terrestrial |
| | | | | in power | broadcast” |
| | | | | savings mode | |
| | | | | FeMBMS | |
| | | | | (EN-TV) | |
| | | | | MBMS | |
| | | | | dedicated | |
| | | | | carrier, new | |
| | | | | frame | |
| | | | | structure, | |
| | | | | receive only | |
| | | | | mode (i.e. no | |
| | | | | SIM card)) | |

LTE networks have supported MBMS since Release 9, through a mechanism referred to as MBSFN (Multicast Broadcast Single Frequency Network). MBMS was provided on carriers that were shared with unicast services. MBSFN required new logical entities in the core network, and relied on simultaneous transmission of the same MBMS traffic, from one or more eNBs.

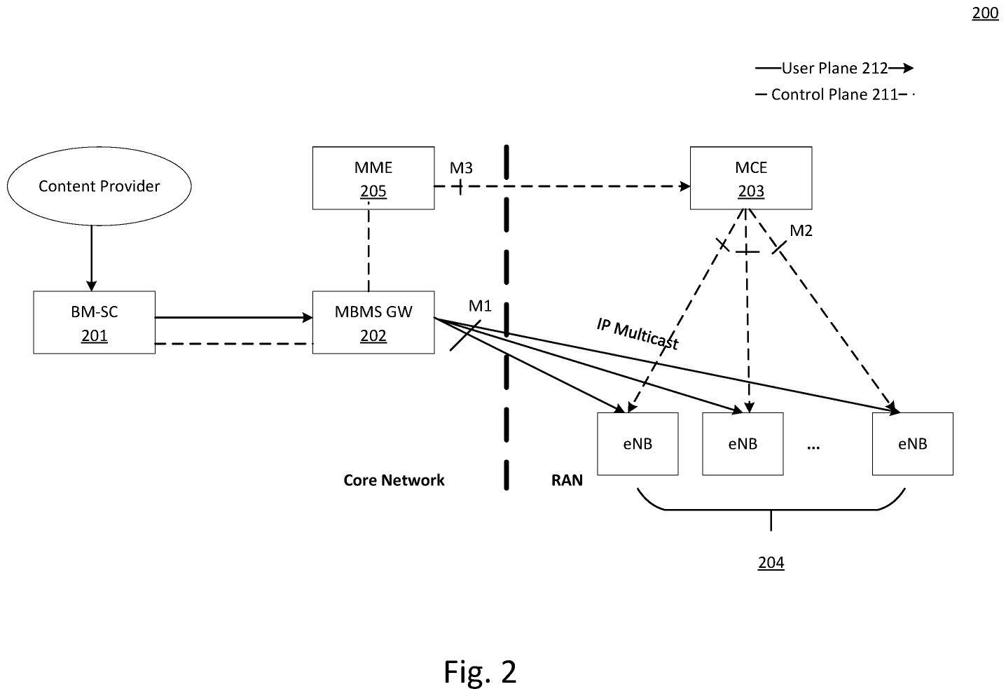

FIG. 2 shows the LTE architecture for MBSFN transmission 200. The logical entities include the BM-SC 201, the MBMS GW 202, MME 205, and the MCE 203. In addition, each of the eNBs 204 shown in the figure is involved in the MBSFN transmission. The transmissions from these eNBs 204 define an MBSFN Area, which is an area where a UE receives MBSFN transmissions from multiple eNBs 204. The transmissions are over a Multicast transport channel (MCH) that is mapped to a physical channel (PMCH—Physical Multicast Channel). The PMCH is transmitted in reserved subframes. That is, subframes that have been set aside by an eNB for the purpose of MBSFN transmission. These subframes are used to carry the MBMS control plane 211 information (Multicast Control Channel MCCH) and the MBS user plane 212 traffic (Multicast Traffic Channel MTCH). From system information, the UEs determine the subframes set aside for MBS, which of these subframes carry MCCH, as well as the configuration used for the PMCH—the latter allowing the UE to decode the traffic received on the PMCH in the reserved subframes. The UE then reads the MCCH to obtain scheduling information for the MBMS user plane 212 traffic. That is, which of the reserved subframes contain a flow from a particular multicast/broadcast flow. UEs can then use this scheduling information to determine the multicast/broadcast flows they are interested in and receive/decode the MBMS traffic. UEs monitor the MCCH to determine if there is any change in the MBMS service offering.

Of note for MBSFN operation:

It can be used for RRC_CONNECTED and RRC_IDLE UEs;

Only a single transport block may be transmitted in each reserved subframe;

Only a single transmission is used for MCH (neither blind HARQ repetitions nor RLC quick repeat); and

MTCH and MCCH use the RLC-UM mode (whose configuration is fixed and known by the UEs).

Release 10 introduced a RAN-based counting, of UEs in connected mode interested in an MBMS service. This release also allowed the RAN to use any unused MBSFN subframes for unicast transmission. This release enhanced the admission control for MBMS sessions by the introduction of the allocation and retention priority session parameters.

Release 11 introduced service acquisition and service continuity in multi-frequency deployments where the MBMS service is provided via more than one frequency. Initial releases of eMBMS assumed that MBMS features did not affect mobility procedures in E-UTRA. Thus, some UEs that were receiving or interested in MBMS services were unable to receive MBMS services due to cell reselection in RRC_IDLE or handover in RRC_CONNECTED. To address this issue, the network could provide assistance information to inform UEs about mapping information between carrier frequencies and MBMS services, and transmission timing of MBMS services. By using the assistance information, when the UE was interested in a particular MBMS service, the UE in RRC_IDLE could autonomously set the carrier frequency carrying the MBMS service to the highest cell reselection priority for the scheduled time. As a result, it was likely that the UE would reselect to a cell on the carrier frequency carrying the MBMS service. Also, in Release 11, for a UE in RRC_CONNECTED, the UE could inform the serving cell about carrier frequencies where MBMS services of interest were scheduled to be transmitted. For this purpose, the RRC layer introduced a new uplink message called the MBMSInterestIndication message. The intention was that the eNB would use this information to select a target cell for handover.

Release 12 introduced as one of the main enhancements: MooD (MBMS operation on Demand), which enables automatic and seamless MBMS service activation and deactivation based on the UEs' service consumption reporting.

A major enhancement was the introduction of Single-Cell Point-to-Multipoint (SC-PTM) in Release 13. SC-PTM uses the same new logical entities in the core network (BM-SC, MBMS-GW) but does not rely on simultaneous transmission from multiple eNBs (as in the MBSFN case). Rather each eNB individually schedules its own MBMS transmissions. These transmissions are transported over the Downlink Shared Channel (DL-SCH) and carried on the Physical Downlink Shared Channel (PDSCH). As a result, unicast traffic and MBMS traffic are multiplexed over the DL-SCH, resulting in more flexible and dynamic radio resource allocation for MBMS transmissions. Also, since the scheduling is not left to the MCE to be synchronized across eNBs, the end-to-end latency is expected to be reduced. For SC-PTM, MBMS is transmitted in the coverage of a single cell. The SC-PTM transmission carries both a control channel (SC-MCCH) and traffic channel (SC-MTCH). SC-MCCH and SC-MTCH transmissions are each indicated by a logical channel specific RNTI on the Physical Downlink Control Channel (PDCCH). Specifically an SC-RNTI for SC-MCCH and G-RNTIs for the SC-MTCHs. Note that there is a one-to-one mapping between each MBMS session supported in a cell, and G-RNTI used for the reception of the DL-SCH to which a SC-MTCH is mapped. Even though SC-PTM is scheduled like the unicast traffic, it does not rely on any UL feedback, and as a result SC-PTM does not support link adaptation or HARQ operation. During the 3GPP work item phase there was some discussion to exploit unicast UL feedback in order to allow advanced link adaptation schemes such as adaptive modulation and coding for groups with a small number of UEs. However, this feature was finally not standardized in Rel'13. In addition, MBMS transmissions can be configured with a MBMS specific DRX pattern, so that the UE need not continuously monitor for the SC-PTM RNTIs. This pattern follows a simple ON and OFF period, with the DRX Active time being extended when the UE receives SC-PTM traffic. This MBMS specific DRX pattern is independent of the UE specific DRX pattern. In addition, of note for SC-PTM operation:
Can be used for RRC_CONNECTED and RRC_IDLE UEs;
Only a single transmission is used for DL-SCH (neither blind HARQ repetitions nor RLC quick repeat);
SC-MTCH and SC-MCCH use the RLC-UM mode (whose configuration is fixed and known by the UEs).

Release 14 introduced MBSFN and SC-PTM for V2X (vehicular to everything) communications, SC-PTM for Internet of Things (IoT), eMTC (enhanced Machine-Type Communication), and NB-IoT (NarrowBand-IoT). Release 14 also introduced many features to enhance the delivery of TV services with eMBMS, to expand the reach of MBMS into traditional TV receivers and to enable the deployment of dedicated broadcast eMBMS networks supporting public broadcasting requirements. Services provided may be distributed in such a way that they can be received by all, including those who are not mobile subscribers. This is also referred to as Receive-only-Mode (ROM) or Free-to-Air.

Release 16 focused on enhancements to terrestrial broadcast (specifically new frame structures, new cyclic prefixes) to find solutions to allow EN-TV to meet 5G broadcast requirements for “terrestrial broadcast”

Despite the progress made over the many LTE releases, MBMS over LTE still suffers from a number of limitations. A few of these limitations are described below.

Limitation on Air Interface: LTE MBSFN and SC-PTM are characterized by rigid OFDM (Orthogonal Frequency Division Multiplexing) numerology parameters that limit the type of network deployments. Large area SFN require cyclic prefix lengths that are considerably larger than those allowed for LTE.

Limitation related to coverage area: the coverage area for MBMS deployments is very static and not adaptable. This results in number of limitations. For MBSFN transmissions, the MBSFN area is statically configured regardless of user distribution. Secondly, it is not possible to dynamically create an MBSFN Area on a cell level basis. Third, in a given coverage area, it is not possible to use point-to-point (PTP), single cell point-to-multipoint (PTM), and multi-cell (SFN) PTM to deliver the same service.

Limitation on Local/Regional coverage provision: local/Regional services can only be inserted by establishing different MBSFN Service Areas with TDM (Time Division Multiplexing). As a result, these local services may each have their own MBSFN area. In addition, MBSFN is inefficient for cell-area broadcasting since it cannot be configured using MIMO, a short CP and reduced pilot signal overhead.

Limitations on Unicast/Broadcast Multiplexing: For MBSFN, subframes occupy the entire bandwidth. Multiplexing with unicast transmission in the frequency domain is not allowed. TDM is the only multiplexing mechanism allowed in MBSFN.

Limitation on signal diversity techniques: MBSFN and SC-PTM lack frequency interleaving and time interleaving which could significantly improve the reliability of transmission for the receive-only mode that in itself lacks link adaptation techniques due to the uplink channel not being available.

Limitation on Single Frequency Network Operation in SC-PTM: SC-PTM cannot be configured in a SFN operation mode that can be beneficial when multiple cells are transmitting the same content

Limitation of resource allocation: Up to Rel'14, only up to 60% of subframes could be allocated to MBSFN services. Rel-14 added the option of using 2 additional subframes or the possibility of using all subframes for MBSFN, going up to 80% and 100% of resources allocated to the MBSFN services respectively. In addition, MBSFN resource allocation is static, and it cannot adapt to the network traffic load. Subframes reserved for MBSFN operation are transmitted regardless of the user demand. To overcome this limitation, LTE Release 14 allowed mapping of unicast data over the MBSFN subframes in the case that there is no broadcast content available, however only devices with certain capabilities are able to decode this data.

Limitation of control channel size: For SC-PTM, the mapping of downlink physical channels and signals to physical resources as defined in Rel-13 has a limitation in that the number of OFDM symbols used for carrying the control channel (as signaled by the Control Format Indicator, CFI) is fixed at 3 for 5 MHz and lower bandwidths, or 2 for 10 MHz and higher bandwidths.

Limitation on link adaptation: The possibility to feedback channel state information to the eNodeB (eNB) about the MBSFN reception for users with uplink capabilities can be useful to perform link adaptation techniques for a group of users. This feature can be especially interesting for deployments with small cells with a limited number of users demanding the same content. In the case of receive only mode receivers with large cells, this feature is less relevant.

Limitation related to feedback channel: There is no feedback from the radio access network to the core MBMS entities about the successful establishment of radio access bearers associated with a certain service. For both MBSFN and SC-PTM, no retransmissions are allowed for the Multicast Traffic Channel (MTCH)/SC-MTCH. There is no dedicated feedback for SC-PTM link adaptation. The RAN implementation could use the feedback mechanisms defined for unicast transmission in proprietary SC-PTM link adaptation solutions, but this is not optimal.

Limitations on Latency: Control plane requires about 5 seconds to setup an MBSFN radio bearer, due to the long Multicast Control Channel (MCCH) modification period. Until Rel-14, modification periods were 5.12 s or 10.24 s. In Rel-14 the protocols included fast reconfigurations, still require modification periods of 10 ms. Furthermore, MBSFN area configuration and available MBMS services have to be sent on MCCH periodically requiring an MCCH repetition period, which can be 320 ms and greater up to 2.56 s. With the fast reconfiguration in Rel'14, the repetition period is at least of 10 ms. For SC-PTM, modifications have to be first announced in one modification period and actually signaled in the next modification period. Modification period can be one radio frame in Rel-14, and up to 2, 4, 8, . . . , 256, . . . 65536 radio frames in Release 13. In addition, the offered MBMS services have to be sent on SC-MCCH periodically, where the repetition period is 1 radio frame in Rel-14, and 2, 4, 8, . . . , 256 radio frames in Rel-13. For MBSFN, the user plane requires a minimum delay of 40 ms (long multicast transport channel scheduling period,) for mixed unicast/broadcast transmission. For SC-PTM, scheduling information for each service (i.e., each SC-MTCH) is provided in the system information. The UE attempts to receive SC-MTCH continuously or according to the discontinuous reception configuration.

Limitations regarding Service continuity: Service continuity is limited in MBSFN to the MBSFN service area. To keep the service continuity in SC-PTM the UE is allowed to switch to unicast in a case of a handover and the new serving cell not transmitting a SC-PTM transmission. This feature is relevant for Mission Critical Services, where the degree of reliability of the service must be maintained.

Limitations on related to UE interest indication: In order to know, from the network side, the UE interest in a specific service, UEs have to indicate such interest via an “MBMS interest indication” Radio Resource Control (RRC) message in several cases including upon successful connection establishment, upon entering or leaving the service area, upon session start or stop, upon change of interest, upon change of priority between MBMS reception and unicast reception or upon a change to a PCell broadcasting. For MBSFN, the MCE (Multi-cell/multicast Coordination Entity) can use the MBMS counting procedure to count the number of RRC_CONNECTED mode UEs which are receiving via an MBS radio bearer (MRB) or interested to receive via an MRB the specified MBMS services.

Limitations regarding Inflexible control information acquisition: In order to save UE battery power in monitoring for the available of an MBMS broadcast, a trigger must come from the network side to wake up the MBMS reception. The control plane and the indication of control information change is shared by all MBMS services within an MBSFN area or cell. This may have negative impacts on many aspects of the system and the UE performance when multiple services with various latency requirements use MBMS in the same MBSFN area or the same cell. For example, a UE interested in an MBMS service allowing for longer latencies must monitor for the control information change more frequently than necessary resulting in battery drain. It may not be necessary to specify a specific/explicit trigger mechanism for broadcast control information acquisition in 5G but if may be sufficient to include an MBMS notification in the paging message.

Limitations on Power Savings: SC-PTM transmissions may be configured with a MBMS specific DRX pattern. This pattern is independent of the UE specific DRX pattern configured in the UE. As a result, the UE is monitoring the PDCCH when it is in Active time for either of these two configured DRX patterns. Because of the lack of coordination, this may lead to certain power consumption issues.

3GPP RAN has considered a number of use cases which would benefit from 5G MBS support. The use cases may be classified into 4 main categories:

Media & Entertainment: for example, a number of users may be interested in receiving shared Virtual Reality or Augmented Reality content.

Public Warning: Users may be notified with alerts carrying multimedia messages including the description of the type of alert and multimedia data giving instructions, advice, and additional information to users (e.g. picture of a missing child, map of last known location, instructions on what to do, etc.). This traffic is “ad-hoc” in nature as the user has not necessarily subscribed to this service.

Automotive: Various V2X applications require information delivered from the Intelligent Transport System (ITS) infrastructure (such as ITS roadside units and sensors) to the vehicle. For example: road safety, signage, mapping, autonomous driving, etc.

IoT: In many situations a firmware update may be sent to a large number of devices, or a new configuration to a large number of devices. The devices themselves may have reduced capability.

The requirements for these use cases in terms of bit rate, latency, user density, and reliability are rather varied, but each would benefit from a form of PTM transmission in the RAN. Based on these use cases, 3GPP has determined a number of requirements related to 5G MBS. During the scoping for Release 17, 3GPP RAN converged on a series of high level requirements that are expected from 5G MBS. This include:
Bit rate can be very high;
Latency can be very low;
Reliability must support use cases with extremely high reliability;
Density should be able to deal with extremely dense deployments;
Mobility should be able to handle high mobility UEs;
Flexibility:
Operator should be able to dynamically change the capacity reserved for
MBS (from 0% to 100%);
Operator should be able to dynamically change the size of service area
(service area can have granularity as small as a cell to as large as a country);
Operator should be able to provide MBS coverage over small areas and over
large areas (e.g. country wide);
Efficiency;
The operator should be able to dynamically change how the service is
provided to the UE (multicast, broadcast, unicast, PTP, PTM);
UE should be able to receive multiple parallel services (one or more unicast
services plus one or more MBS services);

As a result, a 3GPP RAN group has started a new work item that addresses some of the limitations of the MBMS operation over LTE and tries to meet the requirements listed above. The work item has 2 main objectives:

(1) Specify RAN basic functions for broadcast/multicast for UEs in RRC_CONNECTED state, including:
Specifying a group scheduling mechanism to allow UEs to receive Broadcast/Multicast service (also including specifying the necessary enhancements that are required to enable simultaneous operation with unicast reception;
Specifying support for dynamic change of Broadcast/Multicast service delivery between multicast (PTM) and unicast (PTP) with service continuity for a given UE;
Specifying support for basic mobility with service continuity;
Specifying required changes to improve reliability of Broadcast/Multicast service, e.g. by UL feedback. The level of reliability should be based on the requirements of the application/service provided; and
Study the support for dynamic control of the Broadcast/Multicast transmission area within one gNB-DU and specify what is needed to enable it, if anything.

(2) Specify RAN basic functions for broadcast/multicast for UEs in RRC_IDLE/RRC_INACTIVE states [RAN2, RAN1]:
Specifying required changes to enable the reception of Point to Multipoint transmissions by UEs in RRC_IDLE/RRC_INACTIVE states, with the aim of keeping maximum commonality between RRC_CONNECTED state;
RRC_IDLE/RRC_INACTIVE state for the configuration of PTM reception; and

Note that the work item does not include any objectives related to FR2 operation, SFN operation, dynamic resource allocation of up to 100% to MBS, and Receive only-mode operation. Despite this, there is a general requirement that any design decisions taken should not prevent introducing such features or operations in future releases.

The first two releases of 5G RAN do not support MBS. Release 15 and Release 16 design decisions were made to support only unicast services over the Uu interface. Based on the Release 16 5G design, the 5G MBS requirements and the LTE MBMS limitations, the following set of problems need to be resolved in order to allow 5G RAN to support MBS.

Architecture support for 5G MBS is one problem addressed by the embodiments described herein. The current 5G architecture does not support efficient MBS transmission. Based on the UTRAN and E-UTRAN MBMS architectures, a number of functionalities need to be added to the 5G architecture to allow MBS operation. The architecture needs to support dynamic control of the MBS transmission area allowing cells to be added or removed from this area. The architecture needs to support multiplexing of unicast QoS flows and MBS QoS flows to a specific UE. The architecture also needs to permit the gNB to dynamically change the resource allocation reserved for PTM traffic as well as to dynamically switch the RAN delivery method of an MBS QoS flow. The architecture needs to manage the synchronization issue for the SFN deployment, especially if the MBS transmission area is over multiple gNBs (for example a nationwide MBS). Furthermore, the architecture needs to support the different 5G MBS bearer types.

Radio Bearer Configuration Options for MBS traffic is another problem addressed by the embodiments described herein. For a single cell Xcast area, the network has many radio bearer configuration options for sending the MBS traffic for a service, to a set of interested UEs. The service is made up of one or more MBS QoS flows. The radio bearer configuration maps the MBS service to radio bearers and to the C-RNTI and/or G-RNTI used for transmission over the PDSCH. However, some of the details of the radio bearer configuration depend on the decisions made for the open issues, and as a result these details have not been addressed or considered.

The mapping of MBS services to G-RNTI has been identified as an open issue for further 5G MBS development, and this is another problem addressed by the embodiments described herein. However, at present, the granularity of this grouping has not considered that the MBS services may have multiple QoS flows, these flows may have different QoS requirements, the receiving UEs may be at different locations and have different capabilities, control traffic is needed to support these MBS services, etc. The grouping based on these other factors needs to be considered.

The signaling design of MBS control information is addressed by the embodiments described herein. The UE needs to be configured with the MBS control information to know how to receive the MBS services that it is interested in. How this MBS control information is sent to the UEs is not defined, especially for cases where there are multicast services with HARQ feedback, services that may be multiplexed over a G-RNTI, services with QoS flows that may be mapped to different MRBs, etc.

The bearer type selection/(re)configuration/monitoring/switching is addressed by the embodiments described herein. The RAN node should be allowed to select a bearer type for the MBMS QoS flow, monitor the MRB, and if necessary switch the bearer type based on a number of triggers. During bearer type selection the RAN node is provided with an indication of the QoS requirements of the MBS QoS flow, and needs to determine how to map this MBS QoS flow to one or more of the MRB types and configure the radio bearer. As part of the monitoring, a number of issues need to be addressed, for example: Who makes the decision? What assistance information can be used to help make the decision: from UE, from core network, from gNB (e.g. counting procedure). Lastly as part of the bearer type switching, the RAN node needs to determine when the switch is triggered, and how to deal with a bearer that changes from PTP to PTM and vice versa. For example, when there are PTP bearer, the UE is configured with SR, BSR, PHR, etc. All these configurations require uplink capability, which may not be available for a PTM radio bearer. In addition, how the UEs are configured with MRB information needs to be determined.

For a single cell Xcast area, a gNB may choose from a number of radio bearer configuration options. How the network makes this choice is not defined, and this is addressed by the embodiments described herein. In particular the network may require assistance information to help make this decision (from UEs, CN, RAN). Secondly, when the radio bearer configuration option for a UE is changed, the UE actions to ensure service continuity need to be defined. Lastly, in some cases it is expected that a UE may be configured with multiple radio bearer configurations (an old radio bearer configuration to new radio bearer configuration) for the same MBS services. In such cases, the UE needs triggers to decide when to change from old radio bearer configuration to new radio bearer configuration.

For a single cell Xcast area, a gNB may dynamically change the path of an MRB split bearer (between PTP and PTM). How the network makes this choice is not defined, and this is addressed by the embodiments described herein. In particular the network may require assistance information to help make this decision (from UEs, CN, RAN). Secondly, the path switching may be transparent to the UE. In such cases, it may be inefficient for the UE to process traffic from both the PTP and PTM legs, and rules are needed to tell the UE when to monitor PTP leg or PTM leg.

A multicast session may transition from an ACTIVE state to an INACTIVE state, and vice versa. In the INACTIVE state, the UEs that have joined the multicast session are guaranteed to not receive MBS traffic from this service. UE actions on transitioning to and from INACTIVE state are not defined. If no special action is taken, this will lead to unnecessary power consumption at the UEs.

Considering the limitations of the existing MBMS design as highlighted herein, NR MBS design may be different in many ways. New bearer management procedures including enhancements to the legacy MBMS bearer management procedures may be needed, and this is addressed by the embodiments described herein. NR MBS bearer management procedures such as MBS bearer establishment procedure, MBS bearer modification procedure and MBS bearer release procedures need to be specified. The use of UE interest indication for counting procedure, procedure for legacy MBMS like consumption report and MBMS Operation On Demand (MooD) in support of MBS bearer management need to be specified. For example, in the legacy system, in order to know, from the network side, the UE interest in a specific service, UEs have to indicate such interest via an “MBMS interest indication” Radio Resource Control (RRC) message in several cases including upon successful connection establishment, upon entering or leaving the service area, upon session start or stop, upon change of interest, upon change of priority between MBMS reception and unicast reception or upon a change to a PCell broadcasting. For legacy MBSFN, the MCE (Multi-cell/multicast Coordination Entity) can use the MBMS counting procedure to count the number of RRC_CONNECTED mode UEs which are receiving via an MRB or interested to receive via an MRB the specified MBMS services. Similar mechanisms or enhancement to such mechanisms need to be specified for NR taking into account NR MBS requirements.

Methods and procedures are described herein to allow 5G MBS operation. The proposed method and procedures try to 1) overcome the limitations that have been observed in LTE and UTRAN MBMS operation, 2) address the unique characteristic of 5G NR, and 3) meet the requirements set out by the envisioned 5G MBS use cases. Namely, the embodiments described herein are directed to:

A RAN xcasting area concept that is flexible and dynamic;

MBS radio bearer (MRB) types to support MBS services;

RAN architectures to support the various MBS radio bearer types, as well as functionality split across the RAN nodes to support these radio bearers;

Design options for the MBS configuration;

Design options for mapping MBS traffic to G-RNTIs;

Design options for the MBS control information;

Procedures to allow radio bearer selection, (re)configuration, monitoring, and path switching; and

Procedures to allow xcast area management.

Design options for the MBS configuration are described herein.

### EMBODIMENTS

Embodiment 1: A first device may be configured to receive MBS services via one or more MBS radio bearers (MRB) and/or one or more unicast data radio bearers (DRBs).

Embodiment 2: The first device of embodiment 1, where the MBS radio bearer may be a non-split bearer, configured with RLC-AM or RLC-UM

Embodiment 3: The first device of embodiment 1, where the MBS radio bearer may be a split bearer with two legs a PTM leg and a PTP leg. Either leg configured with RLC-AM or RLC-UM.

Embodiment 4: The first device of embodiment 1, where the MRB configuration includes the SDAP configuration, PDCP configuration, RLC configuration, MAC configuration, logical channel configuration, and PHY configuration

Embodiment 5: The first device of embodiment 4, where the SDAP layer configuration may have a single SDAP entity and includes a mapping of MRBs to MBS services.

Embodiment 6: The first device of embodiment 4, where the Logical Channel configuration may include the mapping of logical channels to a specific G-RNTI.

Embodiment 7: The first device of embodiment 4, where the MAC configuration may include the DRX configuration and the HARQ configuration of the MBS services, where this HARQ configuration includes whether HARQ feedback is enabled/disabled, whether the HARQ retransmissions are allowed over C-RNTI

Embodiment 8: The first device of embodiment 4, where the MRB configuration may include the configuration of the associated DRB for the associated PDU session of the MBS service. The associated DRB may be in suspended state until activated.

Mapping of MBS traffic to a G-RNTI(s) is described herein. Embodiments:

Embodiment 9: The first device of embodiment 1, where the MBS services are received over a shared G-RNTI. The UE provided with the configuration details for the G-RNTI: MBS service mapped G-RNTI; Multiple MBS services mapped to G-RNTI; G-RNTI used in cell; G-RNTI used in a geographic area/region; G-RNTI used in a beamforming area; MBS QoS flow mapped to G-RNTI; Multiple MBS QoS flow mapped to G-RNTI; MBS QoS attribute mapped to G-RNTI; Logical channel type mapped to G-RNTI; Logical channel mapped to G-RNTI; UE category mapped to G-RNTI

Embodiment 10: The first device of embodiment 9, where the MBS services are received over multiple shared G-RNTI.

A signaling design of MBS control information is described herein.

### Embodiments

Embodiment 11: The first device of embodiment 1, receiving MBS control information comprising the MRB configuration and the G-RNTI information, over one or more MCCH logical channels.

Embodiment 12: The first device of embodiment 11, where the MCCH logical channel carries the MBS control information per service, and where the information per service includes an MBS service identifier, and a set of one or more MRBs carrying traffic for this service. For each of the MRBs, the MCCH logical channel contains the MRB configuration and the G-RNTI information.

Embodiment 13: The first device of embodiment 11, where the MCCH logical channel carries the MBS control information per G-RNTI, and where the information per G-RNTI includes a set of MRBs carried over this G-RNTI. For each of the MRBs, the MCCH logical channel contains the MRB configuration and the MBS service identifier.

Embodiment 14: The first device of embodiment 11, where the MCCH logical channel is received over: dedicated signaling, common signaling using a modification and repetition period.

Procedures for radio bearer (re) configuration by the network are described herein. Embodiments:

Embodiment 15: A first device (e.g. gNB) that: determines the radio bearer configuration option to provide an MBS service to a second device (e.g. UE) that is interested in receiving the service, sends a first radio bearer configuration to the second device, reconfigures the radio bearer configuration for the MBS service to the second device, and sends a second radio bearer configuration to the second device.

Embodiment 16: The first device in embodiment 15, where the determination is based on one or more of the following: a mapping of MBS service to radio bearer configuration option, a mapping of QoS attributes to radio bearer configuration option, the number of UEs interested in the service, the location of the UEs interested in receiving the service, the RRC state of the UE interested in receiving the service, the number of HARQ transmission failures to a UE, the received RLC status reports from the UE, the received PDCP status reports from the UE, the measurement reports from the UE, the CSI reports from the UE, a request from the UE

Embodiment 17: The second device in embodiment 15, which sends a radio bearer configuration request to the first device. The request based on one or more of the following: monitored HARQ failures for a transport block, radio conditions to the serving cell, location, and range to serving cell, PDCP status, RLC status.

Embodiment 18: The second device in embodiment 15 where the SDAP layer maintains a reception buffer and performs duplicate detection and sending of status reports for missing SDAP PDUs.

Embodiment 19: The second device in embodiment 15, where the second radio bearer configuration includes the last PDCP SN the second device should monitor over the first radio bearer configuration

Embodiment 20: The second device in embodiment 19, using both first and second radio bearer configurations for a transitory period.

Embodiment 21: The second device in embodiment 15, where the second radio bearer configuration includes the mapping between the SN on the first radio bearer configuration and the second radio bearer configuration.

Embodiment 22: The second device in embodiment 15, that uses the first radio bearer configuration until one or more of the following events: receive a second radio bearer configuration, receive a PDCP SN of a certain value, receive an SDAP SN of a certain value, expiry of a timer, detection of activity on the second radio bearer configuration.

A procedure for path switching of an MRB is described herein.

### Embodiments

Embodiment 23: A first device (e.g. gNB) that: determines a split bearer radio bearer configuration option to provide an MBS service to a second device (e.g. UE) that is interested in receiving the service, selects a first path for transmission of the MBS services to the second device (e.g., UE), sends a first radio bearer configuration to the second device, and changes to a second path for transmission of the MBS services to the second device.

Embodiment 24: The first device in embodiment 23, where the selection is based on one or more of the following: a mapping of MBS service to radio bearer configuration option, a mapping of QoS attributes to radio bearer configuration option, the number of UEs interested in the service, the location of the UEs interested in receiving the service, the RRC state of the UE interested in receiving the service, the number of HARQ transmission failures to a UE, the received RLC status reports from the UE, the received PDCP status reports from the UE, the measurement reports from the UE, the CSI reports from the UE, a request from the UE.

Embodiment 25: The second device in embodiment 23, which sends a path switch request to the first device. The request based on one or more of the following: monitored HARQ failures for a transport block, radio conditions to the serving cell, location, and range to serving cell, PDCP status, RLC status.

Embodiment 26: The second device in embodiment 23, that determines when to stop processing transport blocks from the first path and start processing transport blocks from the second path.

Embodiment 27: The second device in embodiment 26, where the determination is activity based. For a PTM to PTP switch, the second device stops processing transport blocks from the PTM path when second device detects MBS traffic on the PTP leg.

Embodiment 28: The second device in embodiment 26, where the determination is timer based. For a PTP to PTM switch, the second device starts processing transport blocks from the PTM path after expiry of an inactivity timer.

Embodiment 29: The first device in embodiment 23, that further sends a path switching request to the second device.

RAN Xcast Areas (RXA) are described herein. One example MBS architecture concept described herein is the concept of xcast area. An MBS xcasting area denoted herein as RAN Xcast Area (RXA) may be introduced at the RAN level. Xcast is for multicast or broadcast. For example, gNB-CU level, a CU-RXA may be defined. Similarly, DU-RXA may be defined for RXA area at the DU level. A single cell casting area may also be defined as an SC-RXA xcasting area. Within a DU, the DU-RXA is identified solely by the DU-RXA Identity. Similarly, within a CU, the CU-RXA is identified solely by the CU-RXA identity. It should be noted that when there is no gNB split into CU and DUs, gNB-CU Xcast area and gNB-DU Xcast area may simply be referred to as gNB Xcast area. A single cell xcasting area is identified by the SC-RXA identity which might be for example the cell identity or any other identity configured into the UE, by the network, for this purpose. A gNB-CU level Xcast area may be comprised of a collection of gNB-DU level Xcast areas. Similarly, a gNB-DU level Xcast area may be comprised of a collection of SC-RXA areas. Alternatively, a RAN Xcast area may be defined above the level of a CU, for example encompassing multiple gNB CUs (or gNBs). As another alternative, a RAN Xcast area may be defined as any general grouping of cells which may belong to different gNB-DUs, gNB-CUs, or gNBs. In such a case, the RXA may be comprised of a collection of SC-RXA areas. A RAN Xcast area may be defined for a single MBS service or a group of MBS services. The grouping of MBS services belonging to the same RXA may be determined by the RAN node based on MBS traffic patterns, similar scheduling needs, etc. Alternatively, this may be provided by the core network based on, for example, the needs of the content provider.

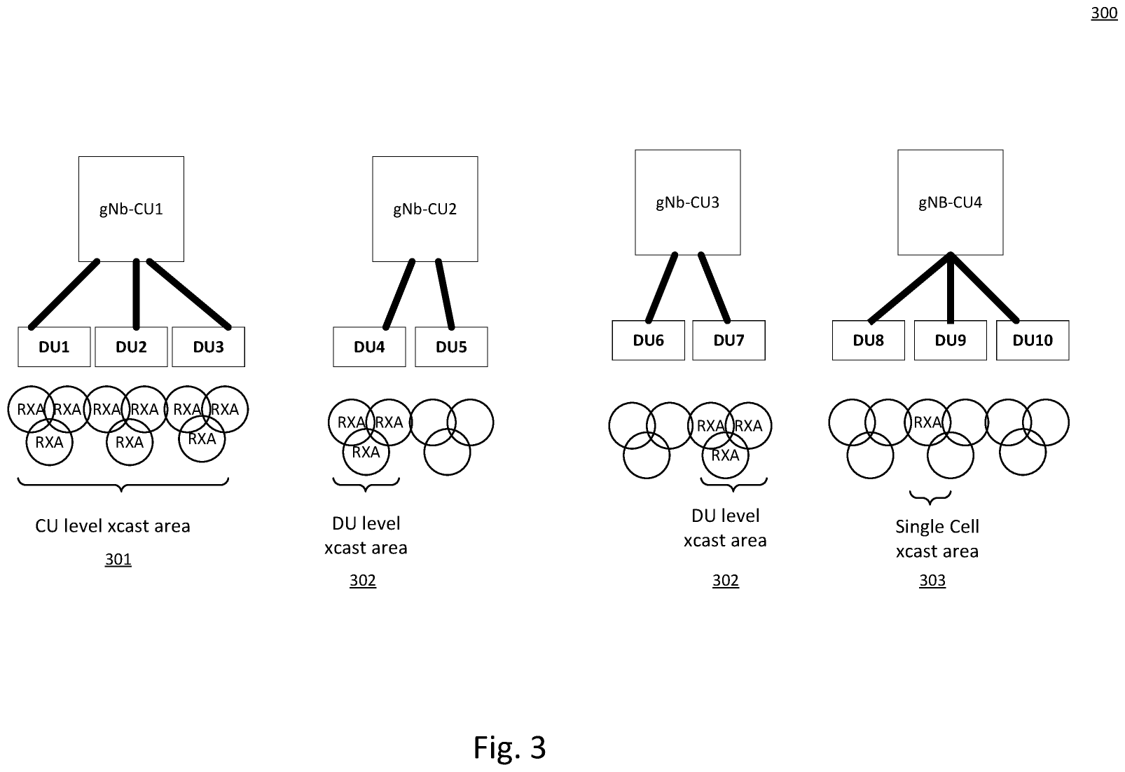

FIG. 3 shows an example RXA 300. The RXA may comprise a CU level xcast area 301, 2 DU level xcast areas, and one SC xcast area 303. It should be understood that this is only an example and any possible grouping of CU level, DU level, or single cell level xcast areas is possible. For example, a RAN Xcast area may be made up of a single CU level xcast area. Also note that the RAN xcast area need not necessarily be contiguous.

RAN delivery methods and MBS bearer types are described herein. 5G MBS may be offered through one or more of the following RAN delivery methods. RAN delivery methods may be of unicast radio bearer type or MRB type.

Single Cell point-to-point (SC-PTP): The MBMS service is provided through a PTP bearer over the RAN. There is a single SC-PTP bearer between a RAN node and each of the UEs receiving the MBS service. The delivery method may be used while the UE is in RRC_CONNECTED state.

Single Cell point-to-multipoint (SC-PTM): The MBMS service is provided through a PTM bearer over the RAN. There is a single shared SC-PTM bearer between a RAN node and each of the UEs receiving the MBS service in the cell. The delivery method may be used while the UE is in RRC_CONNECTED state, RRC_INACTIVE state, or RRC_IDLE state.

Multi Cell point-to-multipoint (MC-PTM): The MBMS service is provided through a PTM bearer over the RAN. The UEs receiving the MBS service may receive the MBS traffic from one or more RAN nodes. The RAN nodes send the same MBS traffic, and the transmissions from these nodes are synchronized. The delivery method may be used while the UE is in RRC_CONNECTED state, RRC_INACTIVE state, or RRC_IDLE state. There is a single shared MC-PTM bearer between each of the RAN nodes transmitting the MBS service and each of the UEs receive the MBS service.

The following Xcast bearer models are described herein:

MC-PTM xcast in non-SFN scheme: A same MBS content data packet may be xcasted from one or more cells within an xcast area wherein the transmission of the same data packet is time synchronized across the transmitting cells, but transmission from different cells may be on different radio resources including different carrier frequencies, and different transmission control parameters (e.g. MCS, TBS).

Corresponding to non-SFN MC-PTM transmission scheme, is non-SFN MC-PTM bearer type. This bearer type could be modelled as split bearer with the split at the SDAP or at the PDCP or at the RLC layers. The bearer is multi-cell bearer (i.e. inter-cell legs bearer or multi-cell leg bearer) by design as the number of legs in this bearer type is proportional to the number of cells within the xcast area providing coverage to the UE. There needs to be a procedure to limit how many legs the bearer may have. This may be tied to the UE capability or to the radio conditions between the UE and the cell. In one alternative, it is proposed to use the DL-SCH as transport channel for this bearer type, and the PDSCH as the physical downlink shared channel. The corresponding traffic logical channel and signaling control logical channel may be generically denoted MCMF-MTCH (multi-cell multi-frequency MTCH) and MCMF-MCCH (multi-cell multi-frequency MCCH) respectively. In another alternative, it is proposed to use MCH as transport channel, that might be mapped to a PMCH physical channel.

MC-PTM xcast in SFN scheme: a same MBS content data packet is xcasted from one or more cells within an xcast area wherein the transmission of the same data packet is time synchronized across the transmitting cells, and transmission from different cells use the same radio resources including the same carrier frequency and the same transmission control parameters (e.g. MCS, TBS).

Corresponding to SFN MC-PTM transmission scheme, is the SFN MC-PTM bearer. In this scheme the bearer may be one leg only based bearer (no inter-cell leg) in the sense that multi-cell transmission is transparent to the UE and the bearer is single-cell bearer by nature. There could be more than one intra-cell leg for this type of bearer. It is proposed to use the MCH as transport channel for this bearer type, and the PMCH as the physical channel. The corresponding traffic logical channel and signaling control logical channel may be MCSF-MTCH (Multi-cell single-frequency MTCH) and MCSF-MCCH (Multi-cell single-frequency MCCH) respectively.

SC-PTM xcast scheme: this is a special case of either non-SFN MC-PTM or SFN MC-PTM xcast scheme: the MBS content data packet is xcasted from one cell. The corresponding SC-PTM bearer is a single-cell bearer by design. Of course there could be more than one intra-cell leg for this type of bearer, where the legs are used for reliability or to assist in mobility. It is proposed to use the DL-SCH as transport channel for this bearer type and the PDSCH as the physical downlink share channel. The corresponding traffic logical channel and signaling control

Unicast PTP bearer: this is also a single cell bearer based by nature. For this bearer, the control information is provided to the UE over the DCCH while the traffic is carried over the DTCH logical channel.

The MBS radio bearer (MRB) types may be either of the first three types of bearers defined above (namely non-SFN MC-PTM, SFN MC-PTM, SC-PTM). Furthermore hereinafter, the term TrCh (transport Channel) may be used in reference to either MCH or DL-SCH unless otherwise explicitly stated. Hereinafter, the terms SC-PTP bearer and unicast PTP bearer are used interchangeably. Hereinafter, the term MC-PTM bearer may be used to refer to both non-SFN MC-PTM and SFN MC-PTM. Dynamic switching between MRB types is described in section “Bearer Type Selection/Monitoring/Switching”.

Deployment Architecture Alternatives are described herein. A number of RAN architecture deployments are possible to support 5G MBS. Each of these deployments must support a set of 5G MBS related logical functions, as listed below:

5G MBS Ingress Point: a function must support the reception of the MBS traffic from the content provider. This may be a dedicated network function in the core network control plane or alternatively a User Plane Function (UPF).

5G MBS Anchor point: function which distributes the MBS traffic to the RAN nodes that may transmit the traffic to the UEs. The Anchor Point functionality may be collocated with the Ingress Point functionality. It may be located in a UPF, in a dedicated MBS GW functionality (similar to the MBMS GW entity in E-UTRAN and UTRAN), or in a RAN node.

Security: In order to have restricted access to 5G MBS content, the 5G data needs to be encrypted. Furthermore, the security function should have the ability to regularly change encryption keys to prevent a UE from continuing to receive the MBS content after leaving a service.

Synchronization: In order to support MC-PTM, the transmission across the cells must be synchronized.

Scheduling: Depending on the MBS radio bearer type, the scheduling functionality over the RAN needs to either be centralized (for example for MC-PTM radio bearers) or distributed (especially for SC-PTP and SC-PTM radio bearers).

Management of MBS Transmission Area: this functionality allows the network to change the MBS transmission area according to a number of metrics. The granularity of this transmission area may be from cell, to DU, to CU (or gNB), to RAN notification area, to tracking area, or to some other grouping of cells defined for MBS. The metric may be based on the number of UEs interested in an MBS service within the MBS transmission area.

Management of RAN delivery method: functionality allowing the network to select and switch between the various RAN delivery methods (SC-PTP, SC-PTM, SNF MC-PTM, and non-SNF MC-PTM).

Management of resource allocation: functionality allowing the RAN to dynamically change the amount of resources allocated in a cell for MBS transmission. For example, the RAN may allocate from 0% to 100% of resources to MBS.

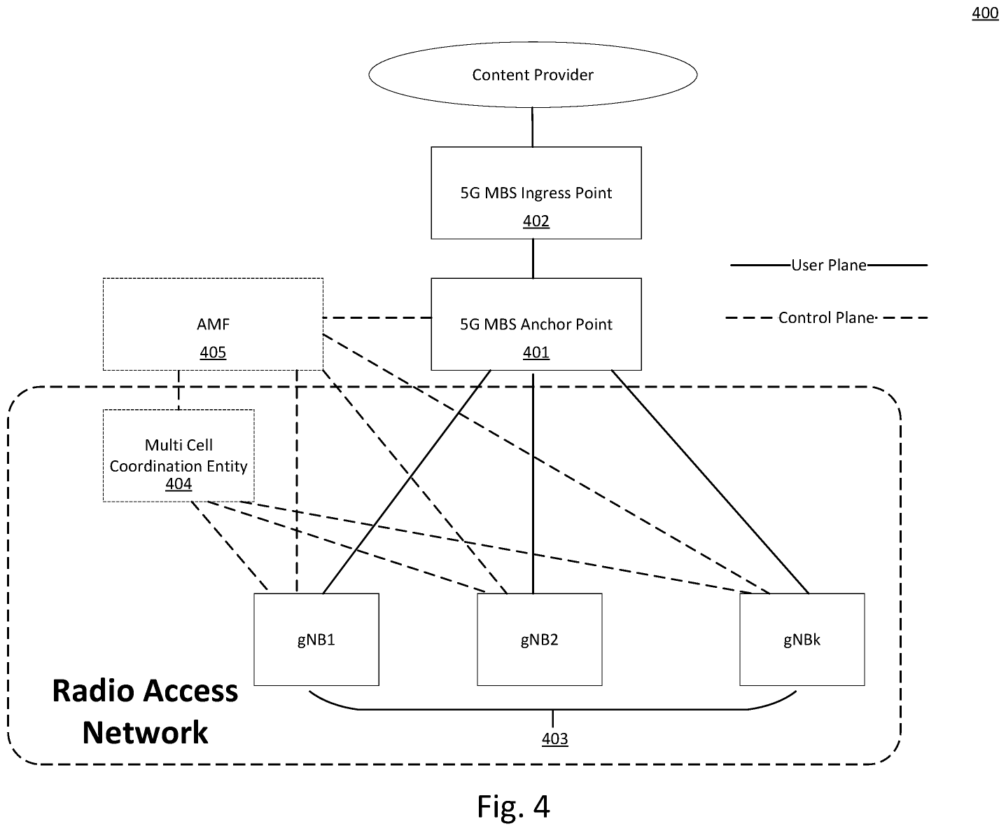

FIG. 4 shows an example architecture 400. In this example, the 5G MBS Anchor point 401 is in the core network—for example in a UPF. The architecture may be used for all MRB types. For the MC-PTM bearer type, a synchronization functionality is needed to guarantee that the MBS transmissions from the multi-cells are synchronized. For the MC-PTM bearer type, a scheduling function is needed to schedule the simultaneous 5G MBS transmissions across multiple cells. The management of MBS transmission area functionality may be located at the 5G MBS Anchor point 401, 5G MBS Ingress Point 402, in a control plane network function (such as the Access and Mobility management Function (AMF)). Alternatively, this functionality may be located in the RAN nodes (gNB1, gNB2, . . . , gNBk 403, or Multi-Cell Coordination Entity (MCE) 404). The management of RAN delivery method may be located in the core network 5G MBS Anchor point 401, 5G MBS Ingress Point 402, or AMF 405). This may be the case for multicast/broadcast services that may be transmitted over the MC-PTM radio bearers. Alternatively, the management of RAN delivery method may be located in the RAN nodes (gNB1, gNB2, . . . , gNBk 403, or MCE 404). As another alternative, the management of the RAN delivery method functionality may be located in both a core network node as well as a RAN node. The management of resource allocation functionality may be located in the RAN nodes (gNB1, gNB2, . . . , gNBk 403, or MCE 404).

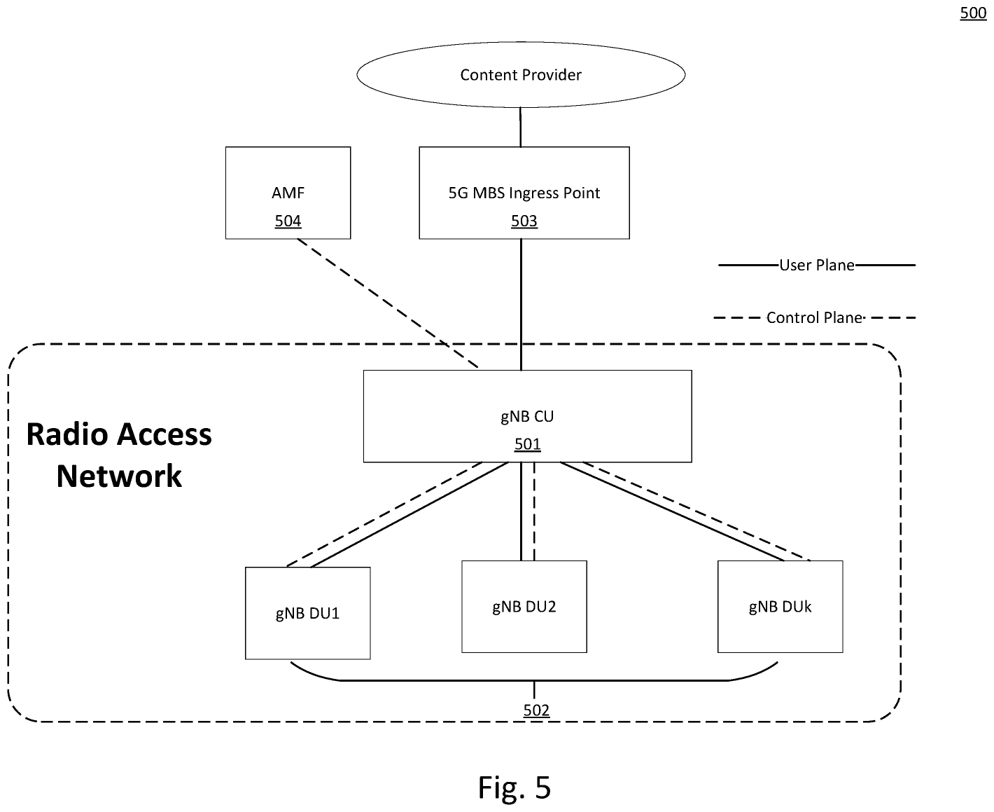

FIG. 5 shows another example architecture 500. In this example, the 5G MBS Anchor point is in a gNB-CU 501 (gNB Centralized Unit), which distributes the MBS traffic to the gNB-DUs 502 (gNB Distributed Units). This example also shows the 5G MBS Ingress Point 503 and AMF 504. Transmission from the RAN node may rely on any of the RAN delivery methods. In particular for the MC-PTM radio bearer type, the transmission is synchronized over one or more gNB-DUs 502. As a result, for the MC-PTM bearer type, a synchronization functionality may be used to guarantee that the MBS transmissions from the multi-cells are synchronized. For the MC-PTM bearer type a scheduling function is needed to schedule the simultaneous 5G MBS transmissions across the multi-cells. In this example, the gNB-CU 501 may host the following functionality: management of MBS transmission area, management of the RAN delivery method, and management of resource allocation. Alternatively, these functionalities may reside in the core network (for example at the AMF or some network function dedicated to 5G MBS).

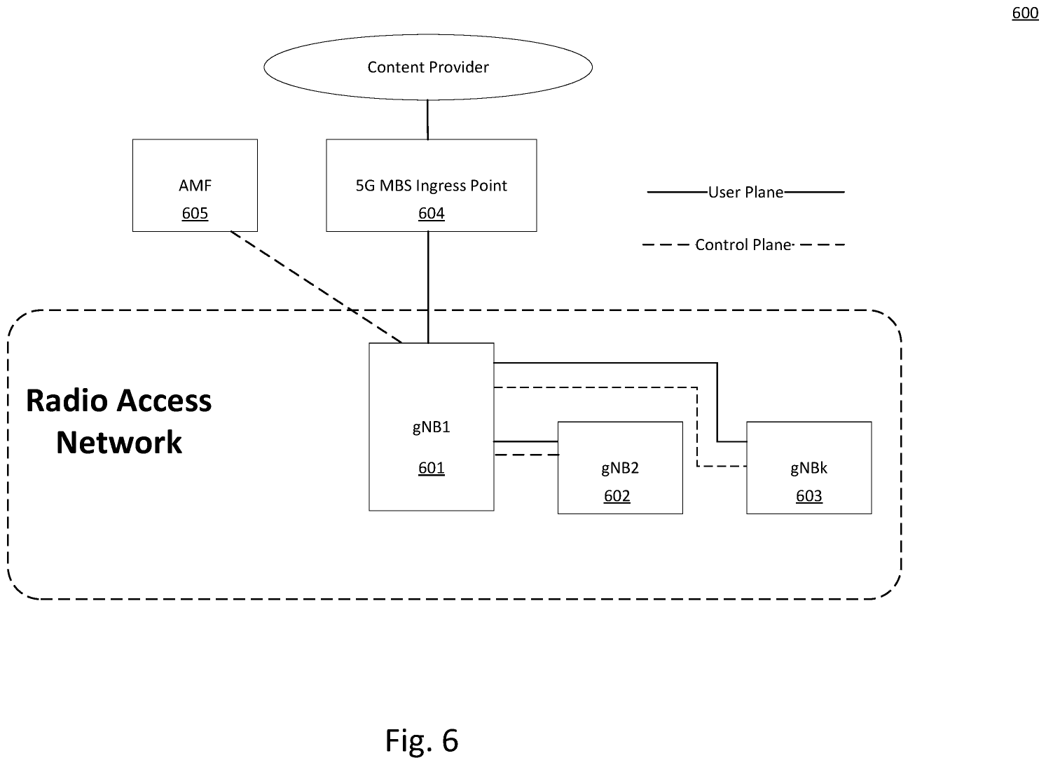

FIG. 6 shows another example architecture 600. In this example, the 5G MBS Anchor point is a primary gNB or master gNB (gNB1 601), which distributes the MBS traffic to other gNBs (or secondary gNBs) (gNB2 602, gNBk 603) in a form of multi-connectivity. This example also shows the 5G MBS Ingress Point 604 and AMF 605. Transmission over the RAN node may rely on any of the RAN delivery methods. In particular for the MC-PTM radio bearer type, the transmission is synchronized over one or more gNBs. For the MC-PTM bearer type, a synchronization functionality is needed to guarantee that the MBS transmissions from the multi-cells are synchronized. For the MC-PTM bearer type, a scheduling function is needed to schedule the simultaneous 5G MBS transmissions across the multi-cells. In this architecture, the master gNB (gNB1 601) may host the following functionality: management of MBS transmission area, management of the RAN delivery method, and management of resource allocation. Alternatively, some of these functionalities may be split between the master gNB 601 and the secondary gNBs 602, 603. In another alternative, these functionalities may reside in the core network (for example at the AMF or some network function dedicated to 5G MBS).

Note that the 5G MBS architecture may also be a combination of the three example architectures shown in FIGS. 4-6. For example, the example of FIG. 4 may have the gNBs deployed in a CU/DU split.

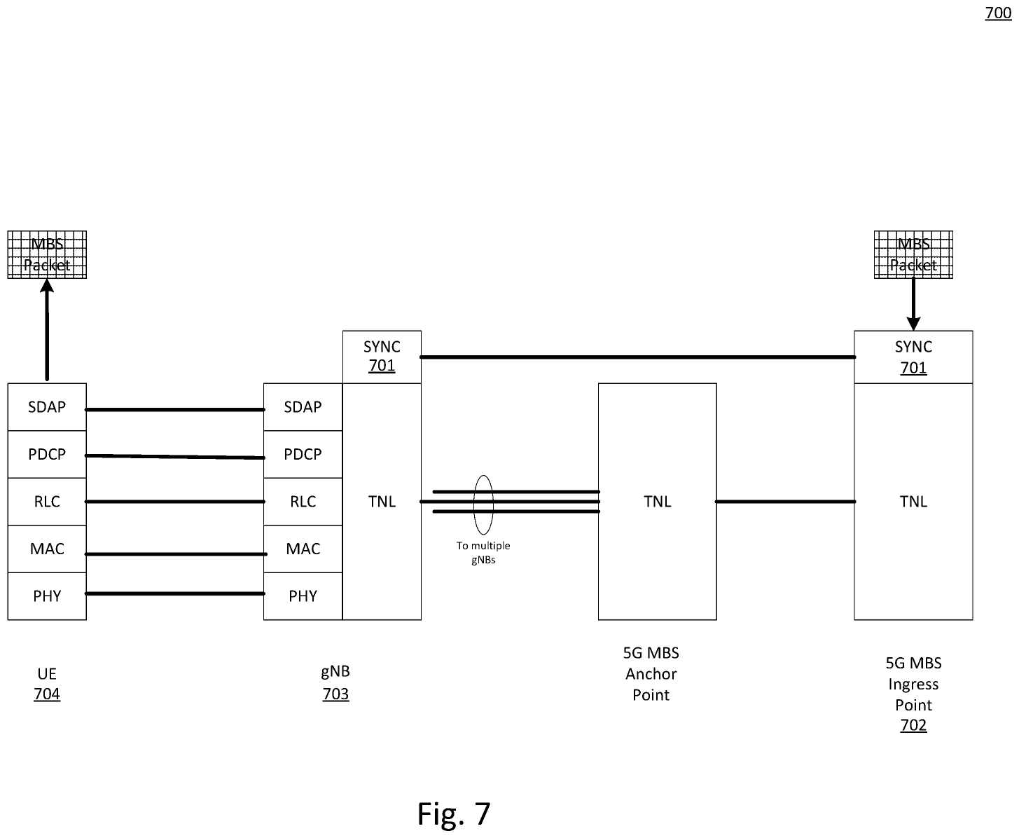

FIG. 7 shows an example user plane protocol architecture 700. In the example of FIG. 7, the QoS flow is mapped to SC-PTP, SC-PTM, or SFN MC-PTM radio bearers. For SC-PTP, SC-PTM, or SFN MC-PTM radio bearers, there may be a SYNC layer protocol 701 between the 5G MBS Ingress Point 702 and the gNBs 703 involved in the transmission of the MBS traffic. This protocol is used for the SFN MC-PTM radio bearer type, as it allows synchronous MBS transmission from the multiple gNBs 703. A gNB 703 may receive multiple MBS QoS flows. At the gNBs 703, these MBS QoS flows are mapped to MRBs or unicast radio bearers and sent to the UE 704. The protocol stack for the user plane performs the functionalities described with respect to the L2 Data Structure described below (e.g., QoS mapping, header compression, scheduling, etc.). For MC-PTM radio bearers, all the gNBs 703 involved in the MBS transmission may have a synchronized radio frame timing such that the radio frames are transmitted at the same time and have the same system frame number (SFN).

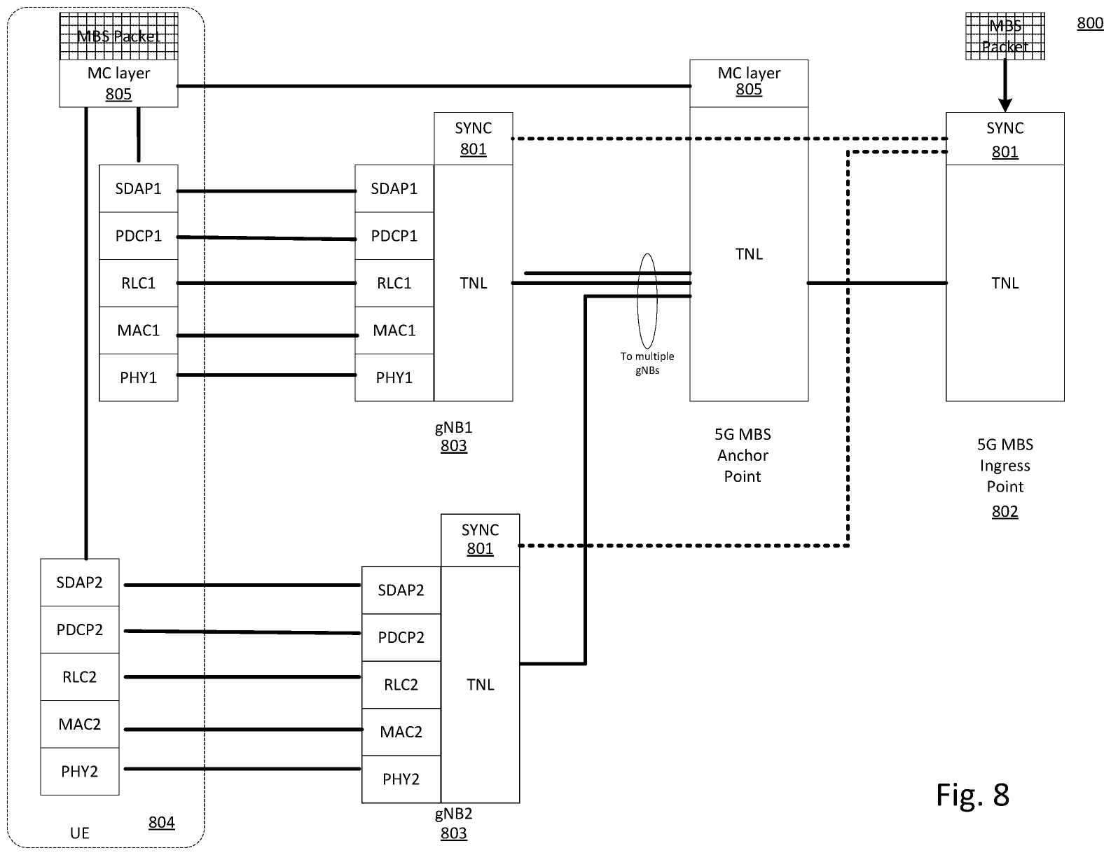

FIG. 8 shows an example in which the QoS flow is mapped to a non-SFN MC-PTM radio bearer 800. For non-SFN MC-PTM radio bearers, there may be a SYNC layer protocol 801 between the 5G MBS Ingress Point 802 and the gNBs 803 involved in the transmission of the MBS traffic. This protocol allows synchronous MBS transmission from the multiple gNBs 803. The UE 804 has multiple reception paths or legs—one leg for each cell participating in the multi-cell transmission. In addition, there is a protocol layer (MC layer 805) between the MBS GW and UE 804 to manage the potential duplication of MBS packets across these different RAN reception legs. The protocol stack for the user plane performs the functionalities described with respect to the L2 Data Structure described below (e.g., QoS mapping, header compression, scheduling, etc.).

Hereinafter, the term “synchronous MBS transmission” may be used to refer to transmissions from multiple sources that may be time synchronized, frequency synchronized, or both. Time synchronized may refer to transmissions that arrive during the same subframe, slot, or minislot. Frequency synchronized may refer to transmissions that arrive over the same bandwidth part, or frequency resources. The granularity of the time and frequency synchronization depends on the type of MC-PTM bearer and the configuration of these bearers.

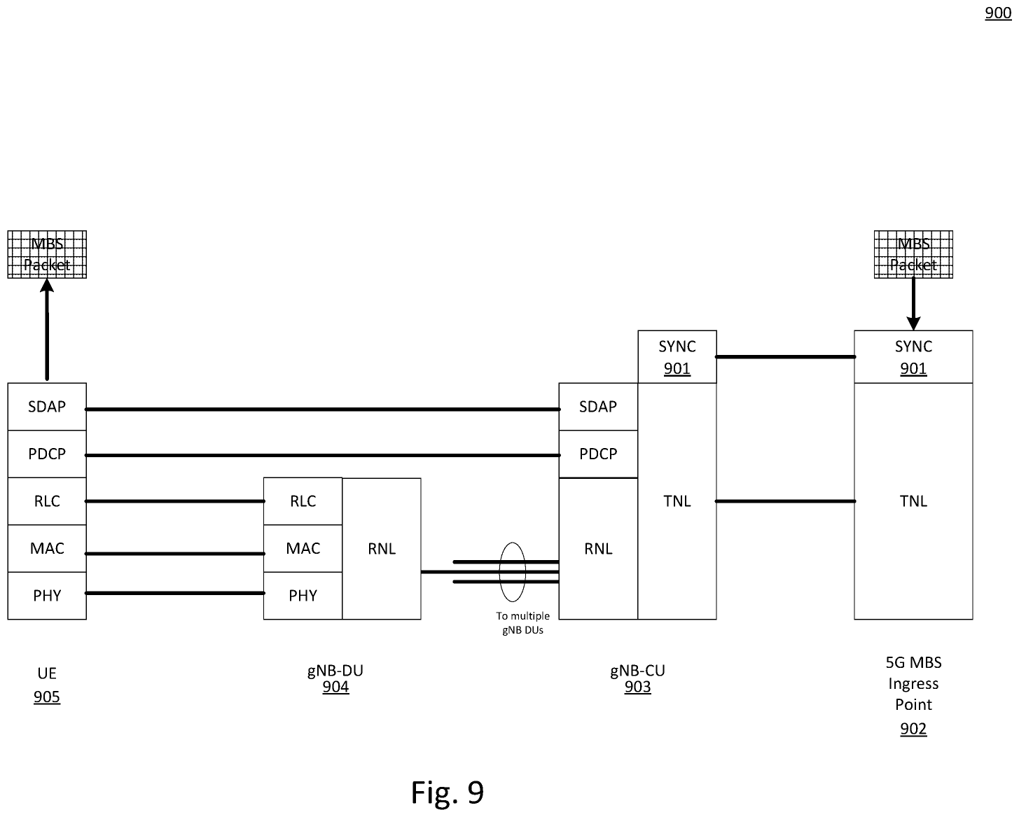

FIG. 9 shows another example User Plane protocol architecture 900. In the example of FIG. 9, the QoS flow is mapped to a SC-PTP bearer. For the SC-PTP, there may be a SYNC protocol 901 layer between the 5G MBS Ingress Point 902 and the gNB-CU 903, if the MBS QoS flow to UE 905 is destined across multiple gNBs. In addition, the layer 2 protocol stack is split between the gNB-CU 903 and the multiple gNB-DUs. The split shown in FIG. 9 has the SDAP and PDCP layer in the gNB-CU 903 and the lower layers in the gNB-DUs 904. The functionalities of these layers are described with respect to the L2 Data Structure described below (e.g., QoS mapping, header compression, scheduling, etc.). It should be noted that the split below the PDCP layer is only one option. The split may be done below the SDAP, below the RLC, or above the SDAP.

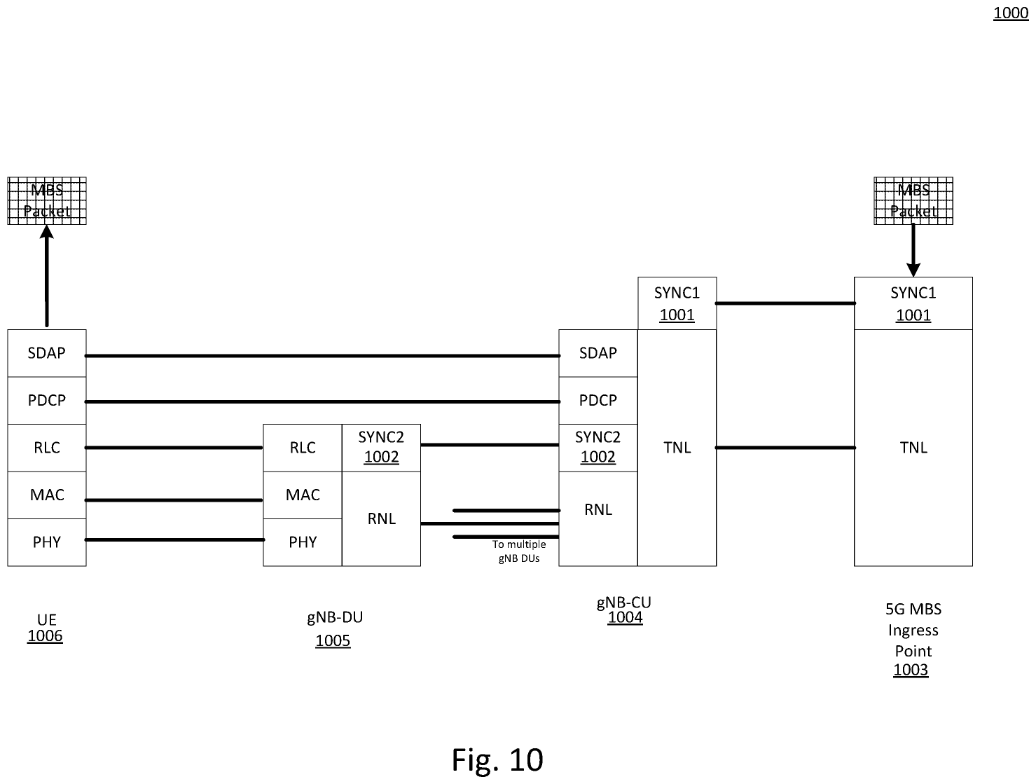

FIG. 10 shows another example User Plane protocol architecture 1000. In the example of FIG. 10, the QoS flow is mapped to a SC-PTM bearer or SFN MC-PTM bearer. For a SC-PTM or SFN MC-PTM bearers, there may be two separate SYNC layers. This is shown as SYNC1 1001 between the 5G Ingress Point 1003 and the gNB-CU 1004, and as SYNC2 1002 between the gNB-CU 1004 and the gNB-DUs 1005 involved in the 5G MBS transmission to the UE 1006. These SYNC protocols guarantee that the MBS traffic sent between by the gNB-DUs 1005 (and across the gNB-CUs 1004) is synchronized. For the SFN MC-PTM radio bearer, the gNB DUs 1005 involved in the MBS transmission may be time and frequency synchronized, such that the radio frames are transmitted at the same time, have the same system frame number, and are transmitted over the same frequency resources.

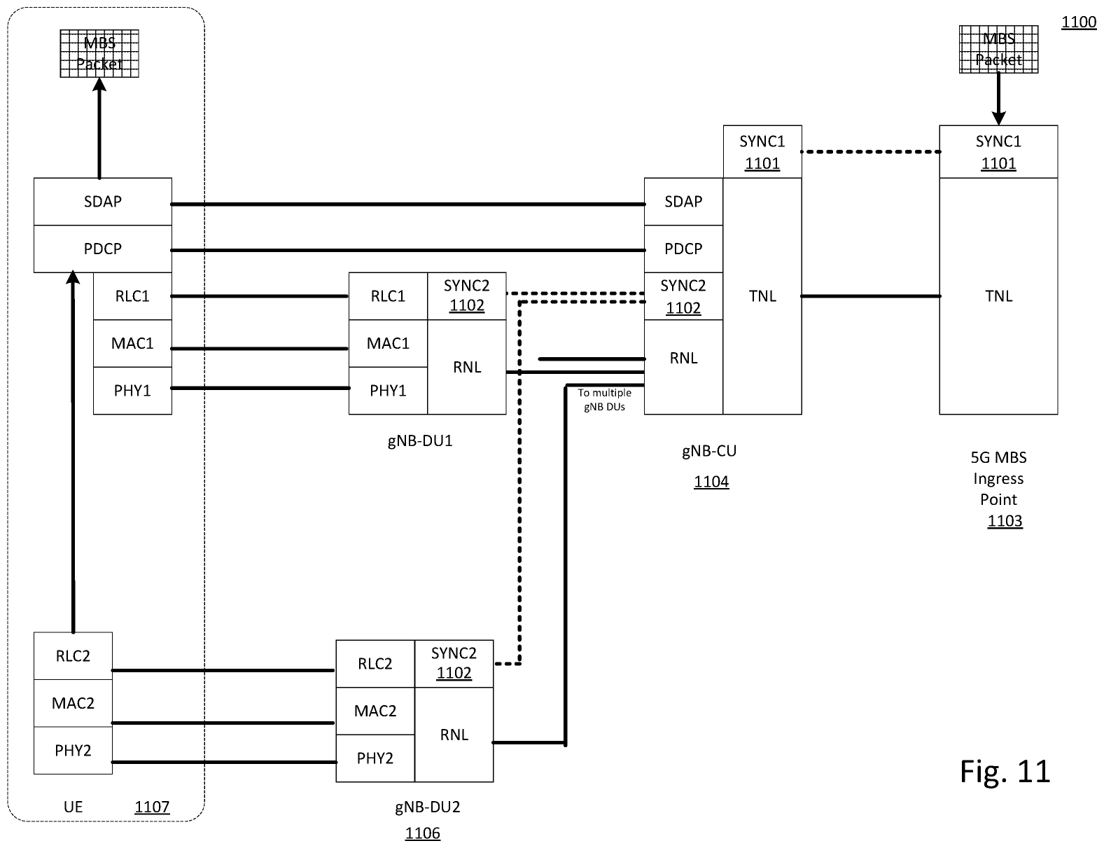

FIG. 11 shows another example User Plane protocol architecture 1100. In the example of FIG. 11, the QoS flow is mapped to a non-SFN MC-PTM bearer. The 5G Anchor Point functionality resides in the gNB-CU 1102. For a non-SFN MC-PTM bearer, there may be two separate SYNC layers (shown as SYNC1 1101 between the 5G Ingress Point 1103 and the gNB-CU 1104, and as SYNC2 1102 between the gNB-CU 1104 and the gNB-DUs 1105, 1106 involved in the 5G MBS transmission). These SYNC protocols guarantee that the MBS traffic sent between by the gNB-DUs 1105, 1106 (and across the gNB-CUs 1104) is synchronized. The gNB DUs 1105, 1106 involved in the MBS transmission may be time synchronized. They may also be frequency synchronized if necessary. The UE 1107 has a split radio bearer across multiple legs. Here, the split is shown below the PDCP layer. As such, the PDCP layer in the gNB-CU 1104 is responsible for MBS packet duplication, while the PDCP layer in the UE 1107 is responsible for detecting duplicate MBS packets and discarding. The UE 1107 may use the multiple legs to increase reliability of the MBS transmission, or to increase the capacity for the MBS traffic. Note that the location of the split may have also been chosen above the SDAP layer, below the SDAP layer, or below the RLC layer.

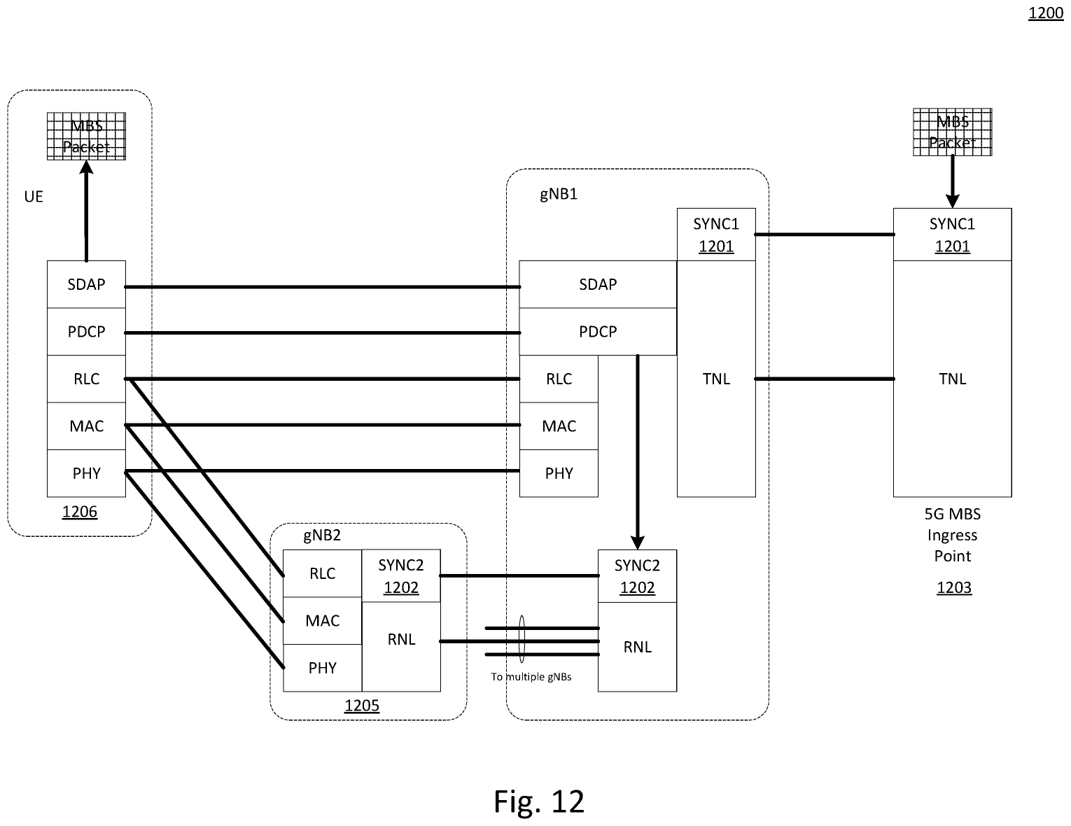

FIG. 12 shows another example User Plane protocol architecture 1200. In the example of FIG. 12, the QoS flow is mapped to a SFN MC-PTM bearer. For a SFN MC-PTM bearer, there may be two separate SYNC layers (shown as SYNC1 1201 between the 5G Ingress Point 1203 and the master gNB (gNB1 1204), and as SYNC2 1202 between the master gNB 1204 and the secondary gNBs 1205 involved in the 5G MBS transmission. These SYNC protocols guarantee that the MBS traffic to the UE 1206 that is sent between by the gNBs is time synchronized and frequency synchronized. For the SFN MC-PTM radio bearer, all the gNBs involved in the MBS transmission may have a synchronized radio frame timing such that the radio frames are transmitted at the same time and have the same SFN. The MC-PTM radio bearer is split over multiple gNBs, each of which may share the same configuration of RLC/MAC/PHY.

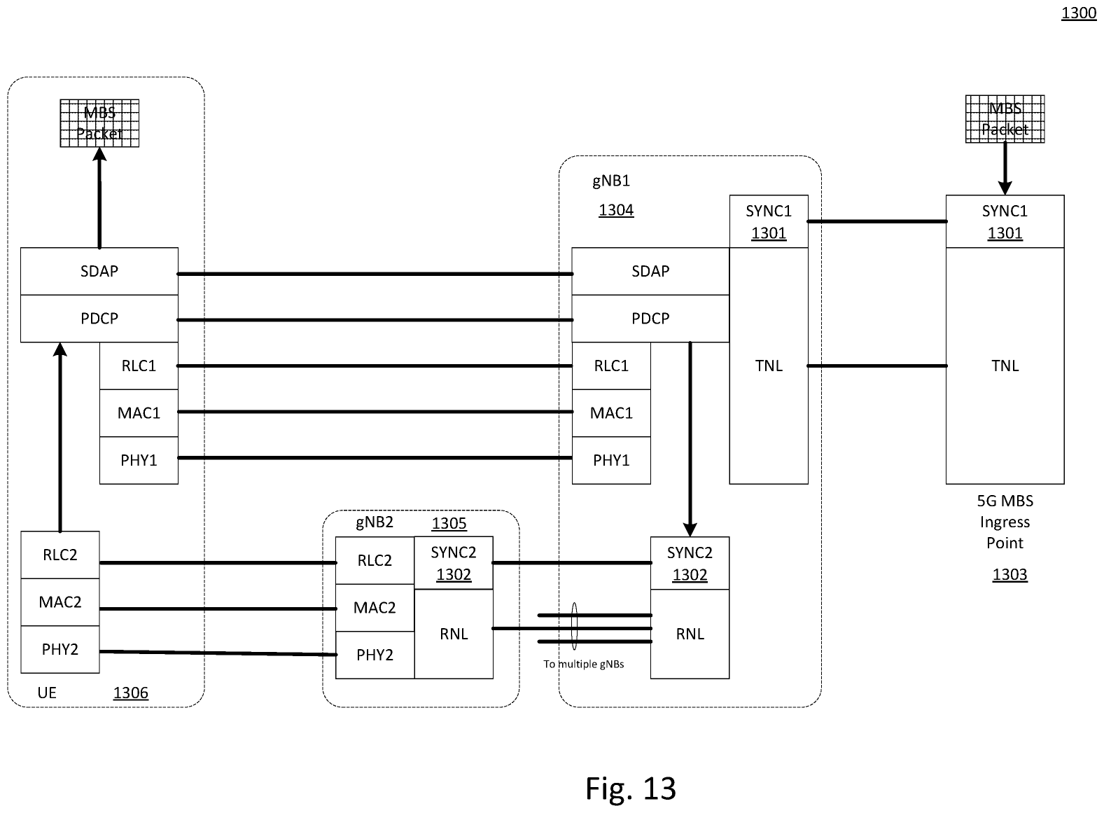

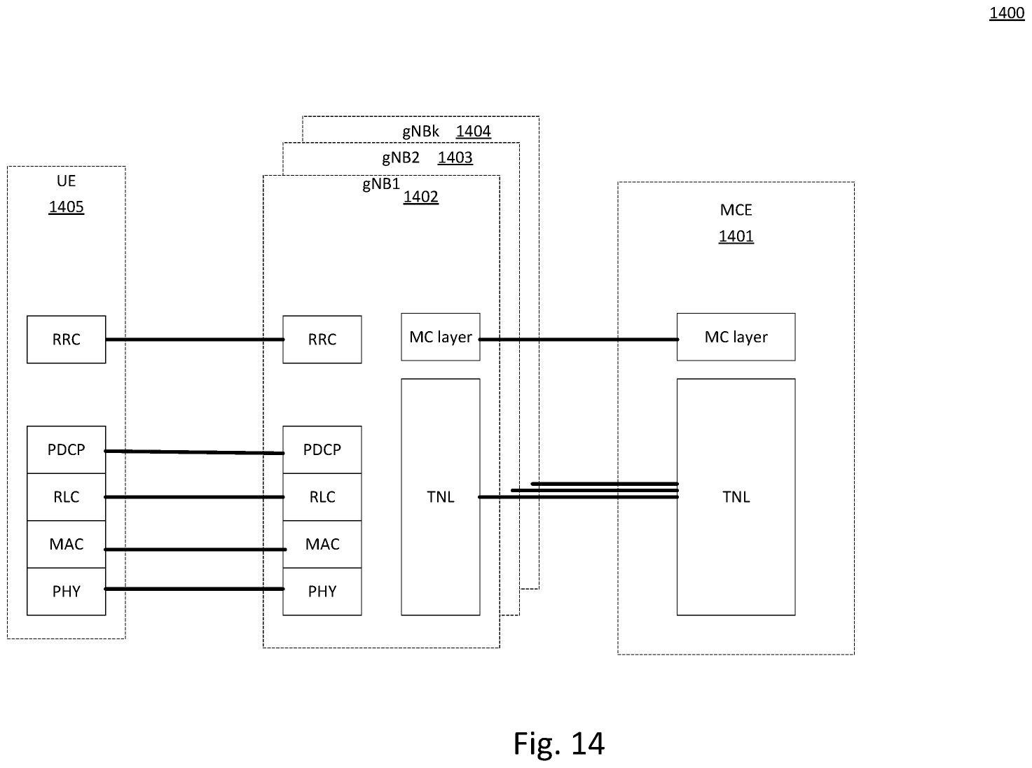

FIG. 13 shows another example User Plane protocol architecture 1300. In the example of FIG. 13, the QoS flow is mapped to a non-SFN MC-PTM bearer. The 5G Anchor Point functionality resides in the gNB1 1304 (the primary gNB). For a non-SFN MC-PTM bearer, there may be two separate SYNC layers (shown as SYNC1 1301 between the 5G Ingress Point 1303 and the master gNB (gNB1 1304), and as SYNC2 1302 between the master gNB 1304 and the secondary gNBs 1305 involved in the 5G MBS transmission. These SYNC protocols guarantee that the MBS traffic sent between by the gNBs are time synchronized. Frequency synchronization may be performed in this example. The MC-PTM radio bearer may be split over multiple gNBs, each of which may have different configuration of RLC/MAC/PHY. The non-SFN MC-PTM bearer requires multiple legs at the UE 1306. The alternative is to split the MBMS traffic below the PDCP layer. In such a case, the PDCP layer is responsible for any packet duplication and duplicate discarding. However, such a split may also be made above the SDAP layer, below the SDAP layer, or below the RLC layer.

FIG. 14 shows another example Control Plane protocol architecture 1400. In the example of FIG. 14, the MCE 1401 may be used for MC-PTM radio bearers. The Multi-Cell layer (MC layer) may be responsible for scheduling across the different gNBs 1402, 1403, 1404. Control Plane traffic may be simultaneously sent across the gNBs 1402, 1403, 1404 according to the schedule provided by the MC layer.

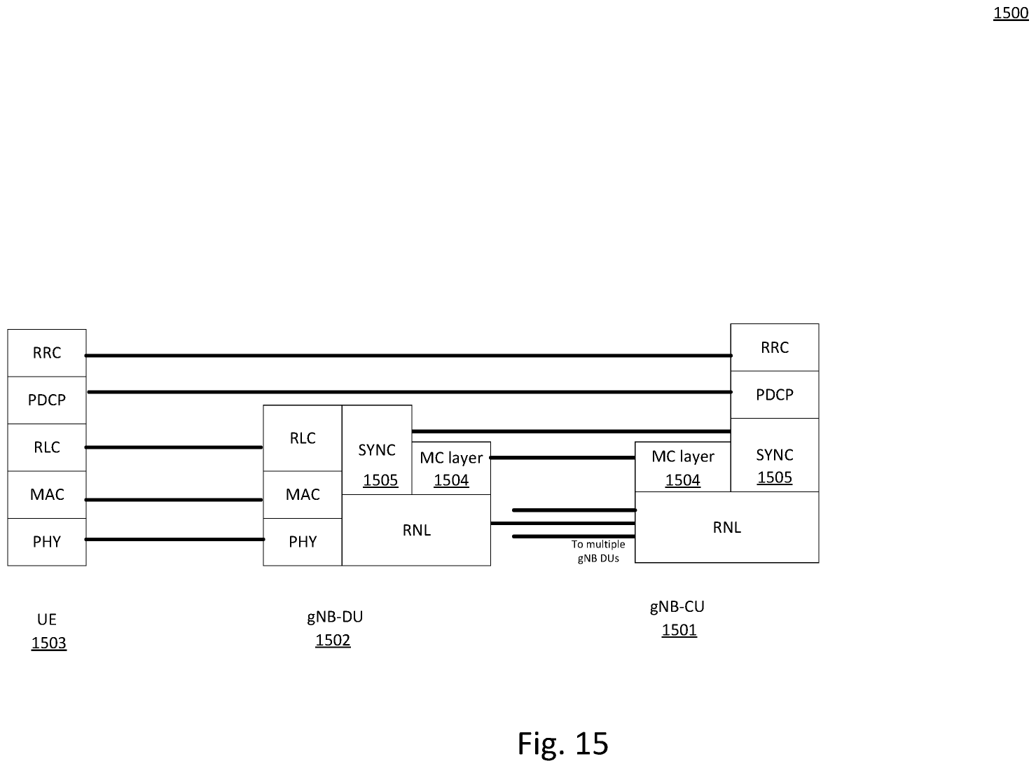

FIG. 15 shows another example Control Plane protocol architecture 1500. In the example of FIG. 15, the control plane traffic to the UE 1503 is generated by gNB-CU 1501 and sent to the gNB-DUs 1502. For MC-PTM radio bearers, the gNB-CU 1501 may have a Multi-Cell layer (MC layer 1504) responsible for scheduling across the different gNB-DUs 1502. In addition, the control plane traffic goes through a SYNC protocol 1505.

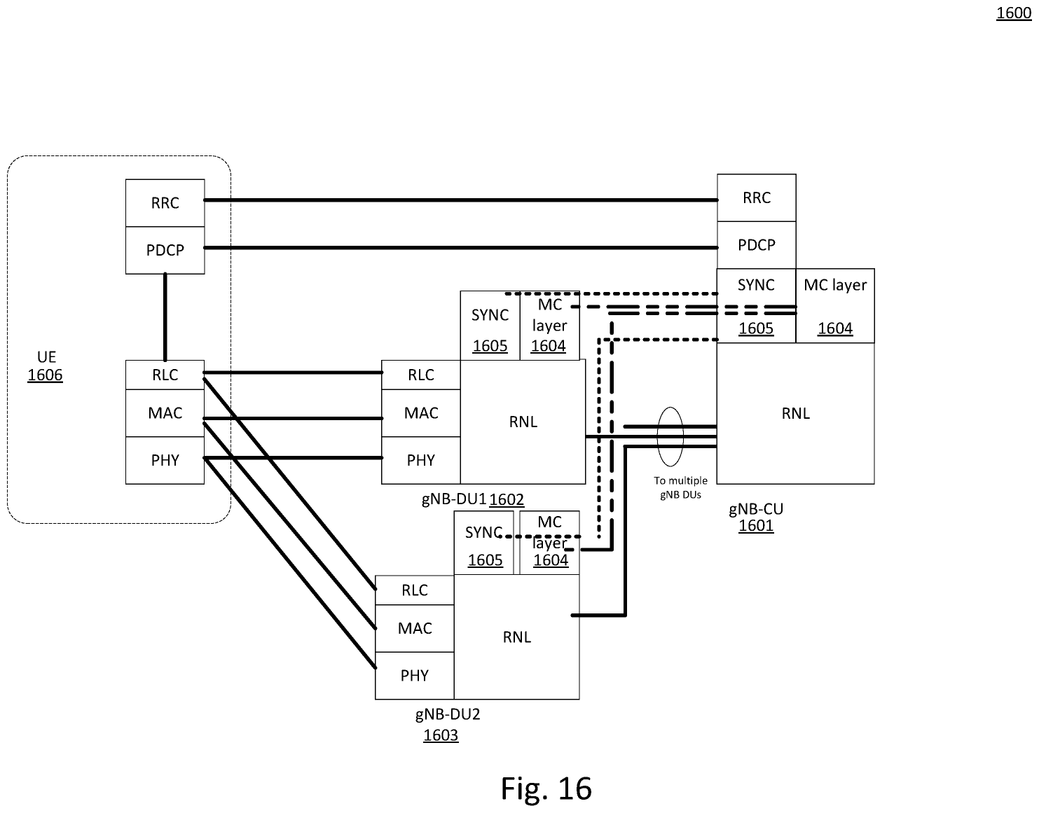

FIG. 16 shows another example Control Plane protocol architecture 1600. In the example of FIG. 16, the control plane traffic to the UE 1603 is generated by gNB-CU 1601 and sent to the gNB-DUs 1602, 1603. For MC-PTM radio bearers, the gNB-CU 1601 may have a Multi-Cell layer (MC layer 1604) responsible for scheduling across the different gNB-DUs 1602, 1603. In addition, the control plane traffic goes through a SYNC protocol 1605.

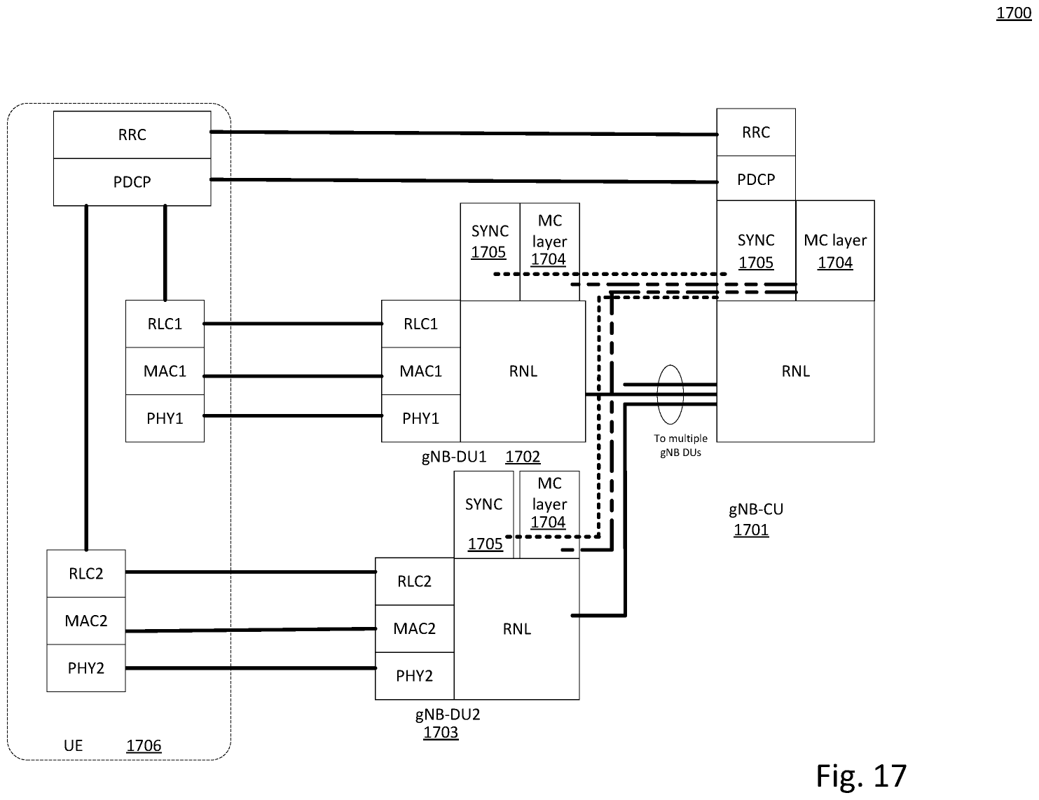

FIG. 17 shows another example Control Plane protocol architecture 1700. In the example of FIG. 17, the control plane traffic to the UE 1703 is generated by gNB-CU 1701 and sent to the gNB-DUs 1702, 1703. For MC-PTM radio bearers, the gNB-CU 1701 may have a Multi-Cell layer (MC layer 1704) responsible for scheduling across the different gNB-DUs 1702, 1703. In addition, the control plane traffic goes through a SYNC protocol 1705.

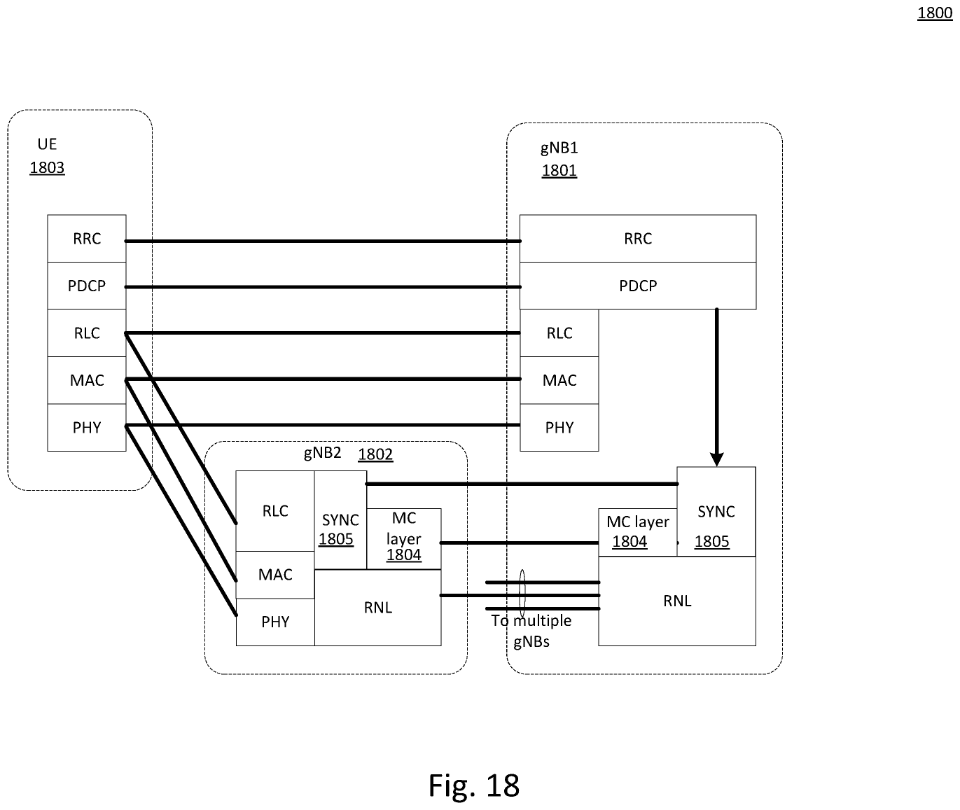

FIG. 18 shows another example Control Plane protocol architecture 1800. In the example of FIG. 18, the control plane traffic to the UE 1803 is generated by master gNB 1801 and sent to the secondary gNBs 1802. For MC-PTM radio bearer, the master gNB 1801 may have a Multi-Cell layer (MC layer 1804) responsible for scheduling across the different secondary gNBs 1802. In addition, the control plane traffic goes through a SYNC protocol 1805.

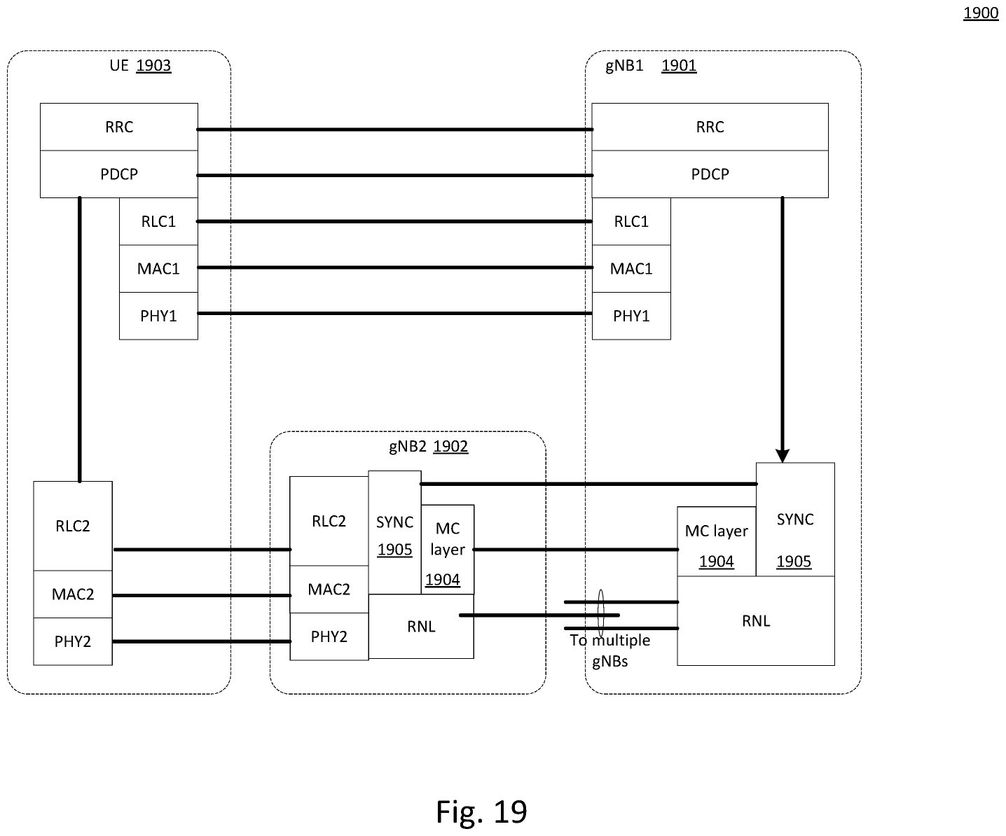

FIG. 19 shows another example Control Plane protocol architecture 1900. In the example of FIG. 19, the control plane traffic to the UE 1903 is generated by master gNB 1901 and sent to the secondary gNBs 1902. For MC-PTM radio bearer, the master gNB 1901 may have a Multi-Cell layer (MC layer 1904) responsible for scheduling across the different secondary gNBs 1902. In addition, the control plane traffic goes through a SYNC protocol 1905.

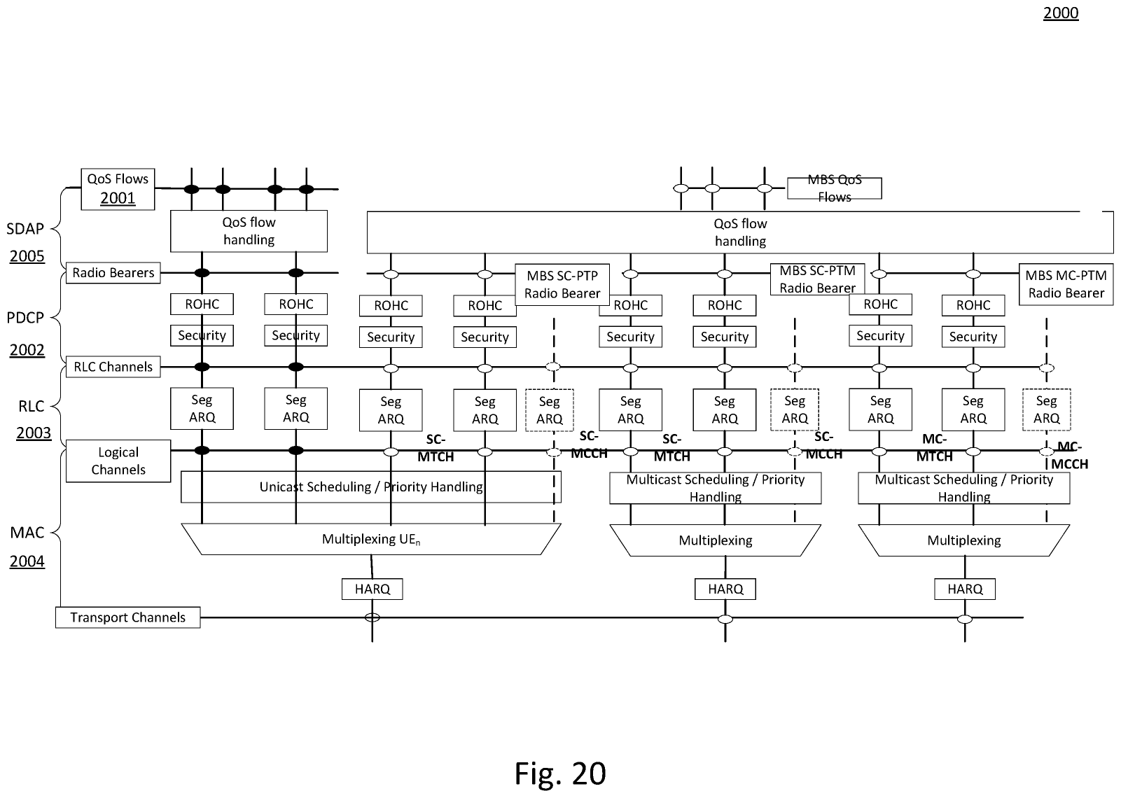

FIG. 20 shows an example L2 data structure 2000. Traffic from Multicast/Broadcast services arrive to the RAN node over one or multiple 5G MBS QoS flows. The L2 data structure processes these QoS flows 2001 so that the MBS traffic of these flows may be transmitted over the air interface. Note that for ease of presentation, the FIG. 20 does not show the MC-PTM radio bearers that are split across RAN nodes. However, it should be understood that the MC-PTM bearers are transmitted over multiple cells. In a SFN case the RLC, MAC and PHY functionality/configuration across all cells may be the same. In a non-SFN case the RLC, MAC and PHY functionality/configuration across all cells need not be the same. The processing tasks are needed at various layers, as described below.

PDCP 2002: The main MBS related services and functions of the PDCP layer may include:

Header compression: for certain MBS traffic, the header may need to be compressed:
Security: Including ciphering and integrity protection. This functionality may be shared with a higher layer node (such as the node hosting the 5G Ingress Point functionality). In some cases, the PDCP layer is a transparent (or a pass-through) layer, which does not process or add any header to the incoming PDCP SDUs;
Packet duplication and Packet Discard;
Routing;

RLC 2003: The main MBS related services and functions of the RLC layer may include:
Error Correction through ARQ (AM only);
Segmentation (AM and UM) and re-segmentation (AM only) of RLC SDUs;
Reassembly of SDU (AM and UM);
Duplicate Detection (AM only);

MAC 2004: The MBS related services and functions of the MAC layer may include:
Mapping between MBS logical channels and transport channels;
Multiplexing/demultiplexing of MAC SDUs belonging to one or different MBS logical channels into/from transport blocks (TB). MBS logical channels may be destined to different multicast group members. For example: only multiplex logical channels with same multicast group members; multiplex logical channel A with Logical channel B if multicast group members of logical channel A is a subset of group members of logical channel B; multiplex logical channels with different group members. Final group is the union of all the members from all logical channels that were multiplexed. Upon reception, at demultiplexing, UE needs to determine if the logical channel is of interest;
Error correction through HARQ;
Priority handling between multicast/broadcast services and unicast services by means of dynamic scheduling;
Priority handling between MBS logical channels by means of logical channel prioritization; and
Priority handling between overlapping resources of one UE.

In addition to the above, the following functionality may be required in the L2 data structure/protocol stack. This functionality may be located at various layers of the stack:
Selection of the RAN delivery method type for a 5G MBS QoS Flow: The 5G QoS flow may be mapped to one or multiple unicast radio bearers and/or MRBs. The selection may be made at the SDAP layer or at a lower layer (PDCP, or RLC or MAC). Alternatively, the selection may be made at the RRC layer. The selection may be made when the 5G QoS flow is started. In addition, the MRB type may be reselected depending on underlying conditions and/or metrics. Numerous metrics may be used for selection (as described in section “Bearer Type Selection/Monitoring/Switching”).

Mapping of the 5G MBS QoS Flow to selected bearer type: Once the selection of MRB type is made, the 5G QoS flow needs to be mapped to the selected MRB. The mapping may be done at the SDAP layer 2005 or at a lower layer (PDCP 2002, RLC 2003, or MAC 2004).

L2 forward error correction (FEC): To improve reliability of the 5G MBS transmissions, a FEC scheme may be used between the UE and the peer RAN node entity. This FEC may be applied to specific MBS logical channels. This layer may be located above the MAC layer (operating at the granularity of an MBS logical channel). Alternatively, this FEC layer may be a part of the MAC layer (operating at the granularity of a transport block). In the latter, existing techniques such as repetition may be used.

Mapping between MCCH message and MRB: This involves determining the MRB to map the MCCH message. For example, a UE may have multiple active MCCH logical channels, each controlling one or more MBS services. These services may be on different MRBs. An MCCH message for a particular service needs to be mapped to the MAC of the associated service.

MBS Cells/BWP Operations may be over:
MBS Dedicated cell: these are cells that are dedicated for MBS transmission; and
MBS/Unicast-mixed cell: Cells performing both MBS and unicast transmissions.

For MBS/Unicast mixed cells:
MC-MTCH and MC-MCCH are mapped on MCH or DL-SCH for MC-PTM transmission;
SC-MTCH and SC-MCCH are mapped on DL-SCH for SC-PTM transmission; and
Transmission of both unicast and MBMS in the cell is done in a coordinated manner.

In the mixed cell case, the transmission of MBS traffic may be in a dedicated bandwidth part (BWP), reserved for MBS. The unicast and MBS transmissions may then be in different BWPs. For example, this BWP may have a longer cyclic prefix making it more suitable for MC-PTM operation.

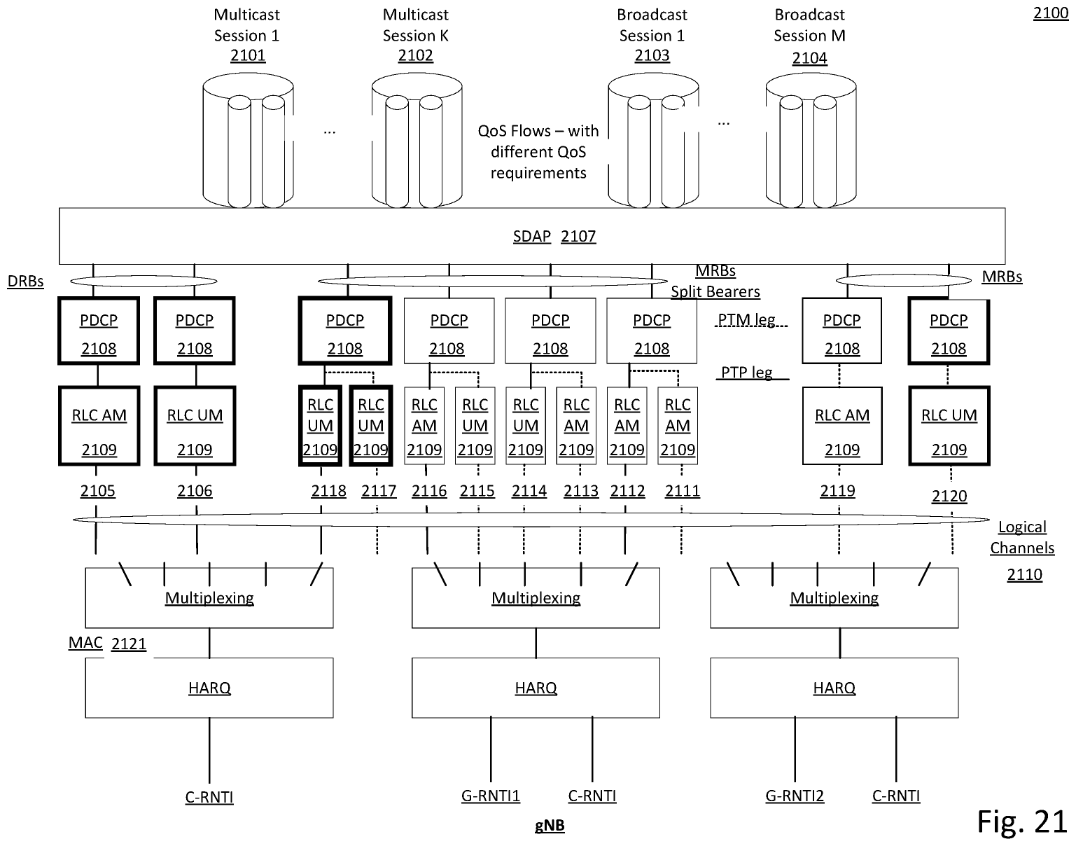

FIG. 21 shows example radio bearers for MBS traffic 2100. The MBS sessions can have multiple QoS flows 2101, 2102, 2103, 2104. Each of these flows has its own QoS requirements including but not limited to: priority level; latency in terms of Packet Delay Budget (PDB), and reliability in terms of Packet Error Rate (PER). Based on the QoS requirements of flows, and the UEs interested in receiving the service, the network determines how to transmit the service using one or more of the following radio bearer configuration options:
Data Radio Bearer (DRB) using RLC-AM 2105;
DRB using RLC-UM 2106;
One or more MRBs with split radio bearers including but not limited to:
A PTM leg using RLC-AM 2111 and a PTP leg using RLC-AM 2112;
A PTM leg using RLC-AM 2113 and PTP leg using RLC-UM 2114;
A PTM leg using RLC-UM 2115 and PTP leg using RLC-AM 2116;
A PTM leg using RLC-UM 2117 and PTP leg using RLC-UM 2118;
An MRB with a single PTM leg using RLC-AM 2119;
An MRB with single PTM leg using RLC-UM 2120.

In addition to the above, other alternatives are possible for the MRB split bearer. For example, the two legs of the split bearer may also be anchored in the RLC or at the MAC. In the RLC anchored case, the two legs share a common RLC entity but may have different MAC entities. In the MAC anchored case, the two legs share a common RLC entity as well as a common MAC entity, however, the split of MBS traffic over the two legs is handled within the MAC layer.

The UE configuration to receive MBS traffic depends on how the MBS traffic is mapped to G-RNTI, as well as how the MRB is configured. The configuration for the UE may include:

A SDAP configuration 2107, which may include the mapping of MBS service QoS flow to MRB mapping. Upon receiving traffic for an MRB, the SDAP configuration allows the UE to know which service and which QoS flow within that service the receive data belongs. If the UE has a single SDAP entity for MBS traffic, the data is forwarded to this SDAP entity. Alternatively, if the UE has a single SDAP entity per MBS service/session, the SDAP configuration informs the UE about the correct SDAP entity to which the receive data should be forwarded.

The PDCP configuration 2108, which may include details of split bearer operation.

The RLC configuration 2109 for each MRB, which may include the logical channel identity of the MRB.

The Logical Channel configuration 2110, which may include the mapping of logical channels to a specific G-RNTI.

The MAC configuration 2121, which may include the DRX configuration tied to MBS services transmitted over this G-RNTI. Alternatively, the MAC configuration may also include HARQ related configuration tied to MBS services transmitted over this G-RNTI. For example, this configuration may specify that the traffic received over this G-RNTI has HARQ feedback enabled or disabled, maximum number of HARQ retransmissions for a transport block, or uses a fixed number of HARQ retransmissions. The MAC configuration may also include an indication of whether the transport block retransmissions are allowed over the C-RNTI. This configuration may also include the C-RNTI.

The PHY configuration, which may include details on the PDSCH channel transporting the MBS traffic, the G-RNTI and/or the C-RNTI, the PUCCH configuration for any HARQ feedback, etc.

For multicast sessions, in addition to the configuration described above, a UE may also be configured with an associated DRB for the associated PDU session of the MBS service. The associated PDU session may support mobility to gNBs that do not have 5G MBS support. However, the SA2 working groups have agreed that it be possible to update the associated PDU session with associated QoS flows when the UE joins the MBS Session. As a result, the network may configure or reconfigure the associated DRB for this associated PDU session. This associated DRB may be in a suspended state, until activated by the gNB. Alternatively, this associated DRB may be one of the DRBs (default or dedicated) already set-up for the UE.

A G-RNTI is a group based radio network temporary identifier that is used to transmit PTM MBS traffic to a group of UEs. The G-RNTI is a shared RNTI, in that many UEs may use the same RNTI for reception. MBS traffic may be one or more G-RNTIs as described herein.

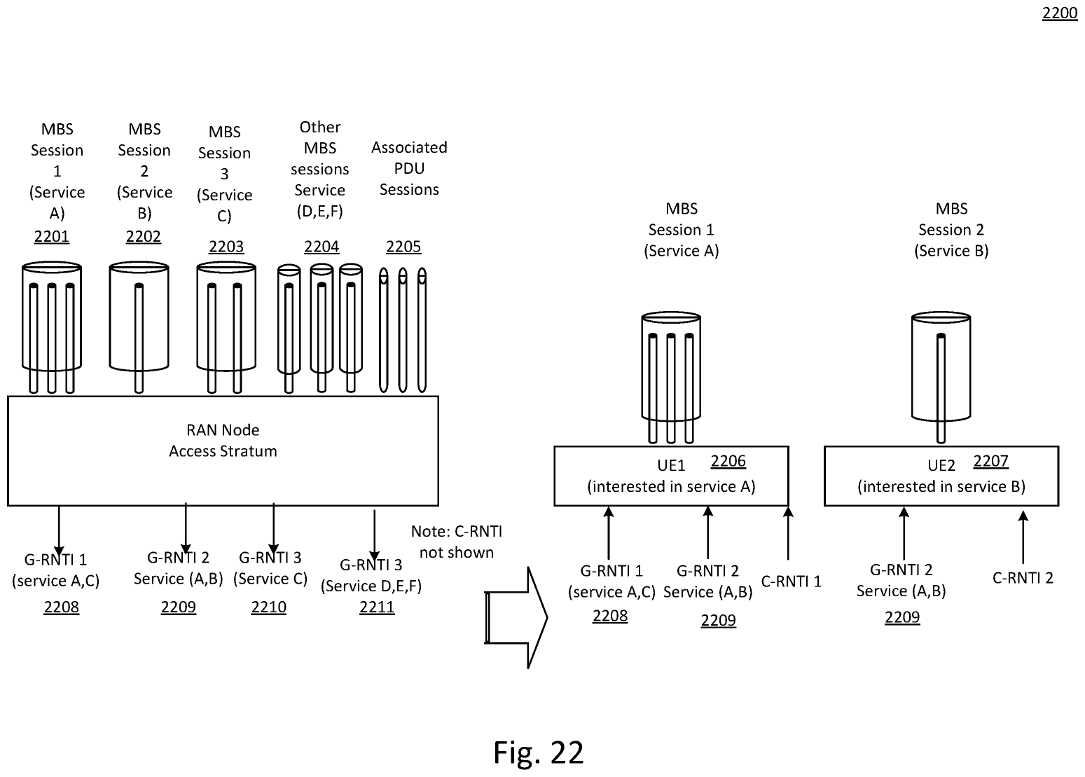

FIG. 22 shows the system architecture from the viewpoint of the G-RNTI at both the gNB and at the UEs 2200. A gNB may have one or more multicast sessions 2201, 2202, 2203 as input; one or more broadcast sessions as input 2204; and for each multicast session one or more associated PDU sessions 2205. One or more MBS QoS flows exists in each of the multicast sessions 2201 and broadcast sessions 2202. Each of these MBS QoS flows is associated with QoS attributes with regards to latency, reliability, and the like.

UEs may be interested in one or more MBS services 2201, 2202, 2203. Such services are transmitted from the gNB over one or more MBS radio bearers (MRB1, MRB2, . . . ). In order to receive the MBS services 2201, 2202, 2203, the UE should receive all MRBs associated with that service. In the case that some MRBs may be carrying the same QoS flow, the UEs 2206, 2207 need to only receive a single one of these. However, if the service has multiple QoS flows and these are mapped to different MRBs, the UE may receive each of these MRBs to recover the different QoS flows

The UEs 2206, 2207 receive the MBS traffic of the multicast sessions 2201, 2202, 2203 and/or broadcast sessions 2204. The UEs 2206, 2207 may receive the traffic over PTP legs or PTM legs. Each of the PTM legs may be associated with a G-RNTI 2208, 2209, 2210, 2211. There are many different alternatives to map the MBS traffic on the MBS QoS flows to PTM legs. The mapping may be based on service type, QoS of the service, UE location, UE type, traffic type, etc.

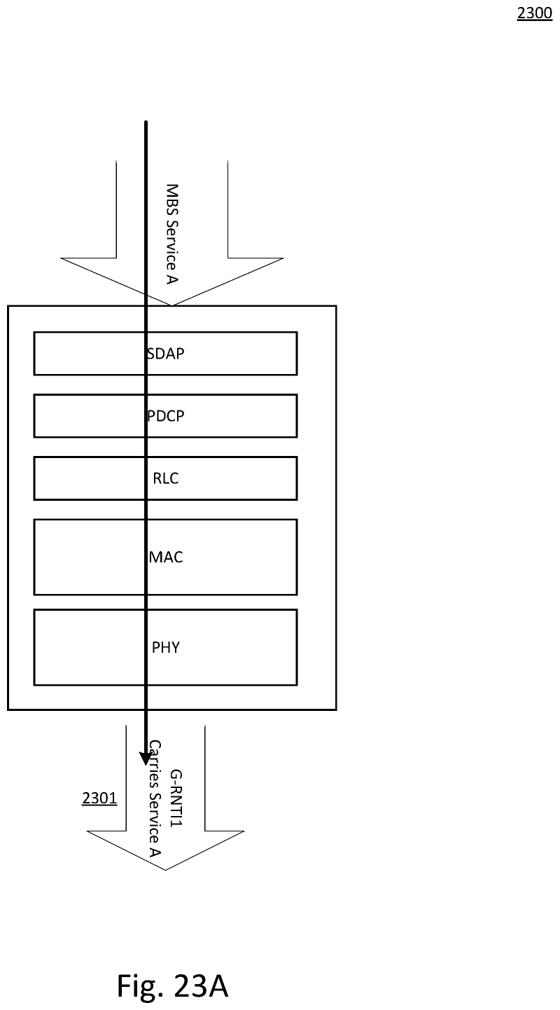

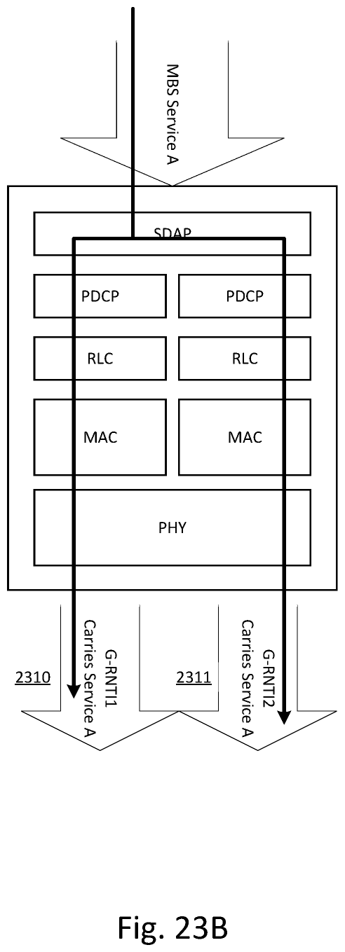

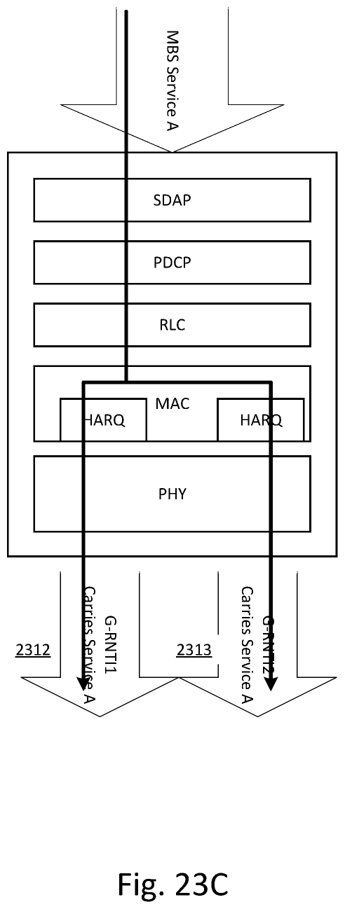

FIG. 23A shows an example mapping that may be per MBS service 2300. In this example, each MBS service may be mapped to one PTM leg that uses a single G-RNTI 2301.

FIG. 23B shows an example in which each MBS service may be mapped to more than one PTM leg, each using its own G-RNTI 2310, 2311.

FIG. 23C shows an example in which each MBS service may be mapped to one PTM leg and may be transmitted over multiple G-RNTI 2312, 2313. The alternative shown in FIG. 23C may be used for a gNB that wants to split the UEs into sub-groups (for example to manage HARQ feedback) but that doesn't need a separate radio bearer for each of these groups. In this case, the UE would only have one HARQ entity. This may also apply to the case where G-RNTI1 2312 and G-RNTI2 2313 are on different carriers. In this case, the UE may have multiple HARQ entities. The MBS service may be identified by the TMGI or source IP multicast address.

In another example, the mapping may be per Multiple MBS services. A group of MBS services may be mapped to one PTM leg using a single G-RNTI. Alternatively, a group of MBS services may be mapped to more than one PTM leg, each using its own G-RNTI. Alternatively, a group of MBS services may be mapped to one PTM leg and may be transmitted over multiple G-RNTI.

In yet another example, the mapping may be per cell. A cell may have one or more G-RNTI for PTM legs. All MBS services in the cell may use the same G-RNTI.

In yet another example, the mapping may be per geographic area. A cell may be divided into one or more geographic areas. The areas may be based on the distance/range to the gNB. For example, for UEs within a range of K1 meters, the PTM leg may use G-RNTI1; for UEs within a range of between K1 and K2 meters, the PTM leg may use G-RNTI2, and for UEs within a range that exceeds K2 meters, the PTM leg may use G-RNTI3. Alternatively, in each of the geographic areas, the MBS services may use multiple PTM legs, each using its own G-RNTI.

In yet another example, the mapping is per MBS QoS flow. An MBS QoS Flow may be mapped to one PTM leg that uses a single G-RNTI. Alternatively, each MBS QoS Flow may be mapped to more than one PTM leg, each using its own G-RNTI. Alternatively, each MBS QoS Flow may be mapped to one PTM leg and may be transmitted over multiple G-RNTI

In yet another example, the mapping may be per multiple MBS QoS flows. A group of MBS QoS flows may be mapped to one PTM leg using a single G-RNTI. Alternatively, a group of MBS QoS flows may be mapped to more than one PTM leg, each using its own G-RNTI. Alternatively, a group of MBS QoS flows may be mapped to one PTM leg and may be transmitted over multiple G-RNTI.

In yet another example, the mapping may be per QoS attribute of the MBS traffic. An MBS QoS attribute may be mapped to one PTM leg that uses a single G-RNTI. For example, the attribute may be related to reliability or latency of the MBS traffic. The attribute may be based on the 5QI. Alternatively, a group of MBS QoS attributes may be mapped to a single G-RNTI. Alternatively, a group of MBS QoS attributes may be mapped to more than one PTM leg, each using its own G-RNTI.

In yet another example, the mapping is per logical channel type. For example, logical channels carrying control plane information may be mapped to a first G-RNTI, while logical channels carrying user plane information may be mapped to a second G-RNTI. Alternatively, logical channels carrying control plane information may be mapped to a first set of G-RNTIs, while logical channels carrying user plane information may be mapped to a second set of G-RNTIs.

In yet another example, the mapping is per logical channel. The gNB and UE may be configured with a mapping of logical channel to G-RNTI. One or more logical channels may be configured to be mapped to a G-RNTI. Alternatively, a logical channel may be mapped to multiple G-RNTI.

In yet another example, the mapping is per UE category or UE type or UE feature support. The gNB and UE may be configured with a mapping of UE category/type/features to G-RNTI. For example, all UEs that support HARQ feedback for MBS, may be mapped to a first G-RNTI. As another example, all UEs of type MTC, may be mapped to a second G-RNTI. Alternatively, the UE category/type/features may be mapped to multiple G-RNTI.

In yet another example, the mapping may be based on some (pre)configured identity. For example, all the devices of a local utility company may be (pre)configured with an identity from which the UE and the gNB may determine a common G-RNTI. All MBS services sharing the (pre)configured identity may use the same G-RNTI.

In yet another example, the mapping may be random: A cell may have one or more G-RNTI for PTM legs. The MBS service, or MBS QoS flow, or logical channel, may randomly select between the G-RNTI available in the cell.

In yet another example, the mapping may be per beam or beamforming area (beam-specific geographic area): A gNB may transmit MBS traffic over a number of beamforming areas. For example, one beamforming area (beam1) the PTM leg may use G-RNTI1, another beamforming area (beam2), the PTM leg may use G-RNTI2, and so on. A UE receiving from beam1 may receive the PTM leg using G-RNTI1. Alternatively, in each of the beamforming area, the MBS services may use multiple PTM legs, each using its own G-RNTI.

Solutions to Problem 4: Signaling Design of MBS Control Information

In LTE, a cell has a single eMBMS control channel for MBMS traffic (the SC-MCCH). This channel is sent using a modification period and repetitions in this modification period. The control channel carries control, schedule, and configuration information for all MBMS traffic carried in the cell.

For NR MBS, the MBS services are expected to be very varied (having varied QoS requirements) and the mapping of services to radio bearers is also expected to be very flexible.

The UE needs to obtain the configuration information for receiving the MBS services of interest. Each of the MBS services may have an associated MBS configuration.

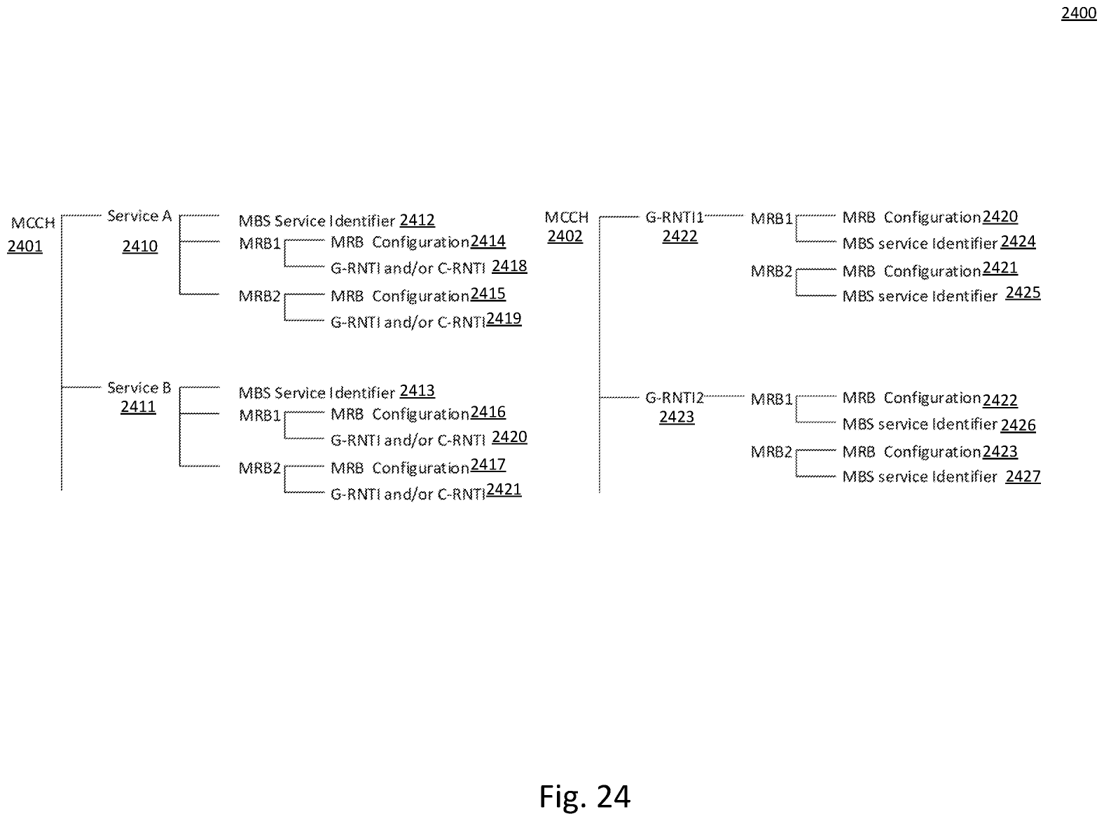

FIG. 24 shows examples of mapping the MBS control information to an MCCH 2400. Each MCCH 2401, 2402 may have the MBS control information per service. The MCCH 2401, 2402 may have a list of MBS services 2410, 2411. For each of the MBS services, the MCCH includes an identifier for the service 2412, 2413, 2424, 2425, 2426, 2427. The PDCP configuration(s), the RLC configuration(s), the MBS logical channel configuration(s), the MAC configuration(s) (including the DRX configuration), and the PHY configuration(s) may also be included. As the MBS service may be transmitted over multiple MBS radio bearers and over multiple G-RNTI, the MRB configurations 2414, 2415, 2416, 2417, 2420, 2421, 2422, 2423 and G-RNTI and/or C-RNTI configurations 2418, 2419, 2420, 2421, 2422, 2423 may be included.

Each MCCH may have the MBS control information per G-RNTI. The MCCH may have a list of G-RNTI that are used for carrying a set of MBS services. For each of the G-RNTI, the MCCH includes an identifier for the service, the PDCP configuration(s), the RLC configuration(s), the MBS logical channel configuration(s), the MAC configuration(s) (including the DRX configuration), and the PHY configuration(s). As the G-RNTI may carry multiple MBS radio bearers, each for different MBS services, the configuration for each of these may be included.

Various options are possible for receiving the MBS configuration. These options may be used individually or in some combination.

In one example, UEs in RRC Connected receive the MBS control information through dedicated signaling over the DCCH logical channel. The network may know the services the UE has joined and is interested in. The gNB may signal the MBS control information for the services the UE is interested in using an existing RRC message (e.g., RRC Reconfiguration Request) or using a new RRC message (e.g., RRC MBS Reconfiguration Request). These messages may contain the RRC configuration for the MBS services that the UE is interested in. If the UE is in RRC Idle or RRC Inactive mode, the UE may be paged to transfer the MBS configuration. After receiving the configuration, the UE may remain in RRC Connected mode if at least one of the MBS services of interest is active. Alternatively, the UE may remain in RRC Connected mode even if no MBS service of interest is active. Alternatively, if no MBS service of interest is active, the UE may transition back to RRC Idle or RRC Inactive but maintain the MBS configuration. That is, the UE may not clear the received MBS configuration.

In another example, the network may transmit the MBS configurations of the MBS services over a single MCCH logical channel. The single MCCH carries the MBS configuration for all MBS services in a cell. The MCCH logical channel may be multiplexed with MBS traffic.

In another example, the network may transmit the MBS configurations of the MBS services over a single MCCH logical channel. The single MCCH carries the MBS configuration for all MBS services in a cell. The MCCH logical channel may be transmitted repeatedly using a modification period. In such a case, the UE needs to know how to receive this MCCH, including the scheduling of the MCCH, and the logical channel configuration for this MCCH. This information may be included in the system information broadcast in the cell. Alternatively, this information may be provided to the UEs that have joined the service using dedicated signaling

In another example, the network may transmit the MBS configurations of the MBS services over more than one MCCH logical channel (MCCH1, MCCH2, . . . , MCCHk). Each of these logical channels carries the MBS configuration for a set of MBS services in a cell or for a set of G-RNTI in a cell. The MCCH logical channels may be transmitted repeatedly using a modification period. In such a case, the UE needs to know how to receive this MCCH, including the scheduling of the MCCH, and the logical channel configuration for this MCCH. This information may be included in the system information broadcast in the cell. Alternatively, this information may be provided to the UEs that have joined the service using dedicated signaling.

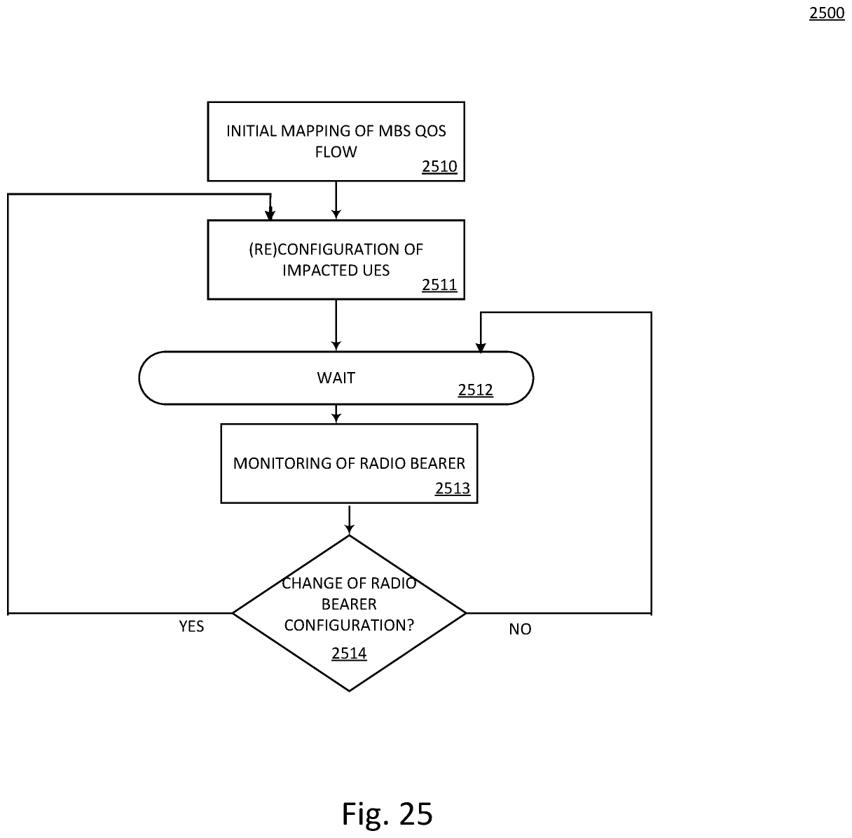

FIG. 25 shows an example procedure for radio bearer maintenance 2500. Radio bearer maintenance may include bearer type selection/(re)configuration, monitoring, or switching. At step 2510, a determination is made of the radio bearer types that may be required for an MBS QoS flow and the configuration of these flows at the UEs. For example, the initial mapping of the MBS QoS flows may be made. UE assistance may be provided to help the RAN node make this determination. Core Network assistance may also be provided to help the RAN node make this determination. At step 2511, the impacted UEs may be configured or reconfigured. After a time period (step 2512), the RAN node may monitor the status of the radio bearers (step 2513). At step 2514, the RAN node may decide to change/modify the RAN delivery method. Again, this decision may be made with the help of UE assistance information and/or core network assistance information.

A 5G MBS QoS flow arriving at a RAN node is transmitted over an xcast area using one or more radio bearers. Some of these may be unicast radio bearers while others may be multicast/broadcast radio bearers. In addition, for every cell that is part of the xcast area, the MBS traffic from this 5G QoS flow may be carried over one or multiple radio bearers. So, for example, a cell may carry the MBS traffic over a SC-PTP bearer for one UE, and over a SC-PTM bearer for a second UE.

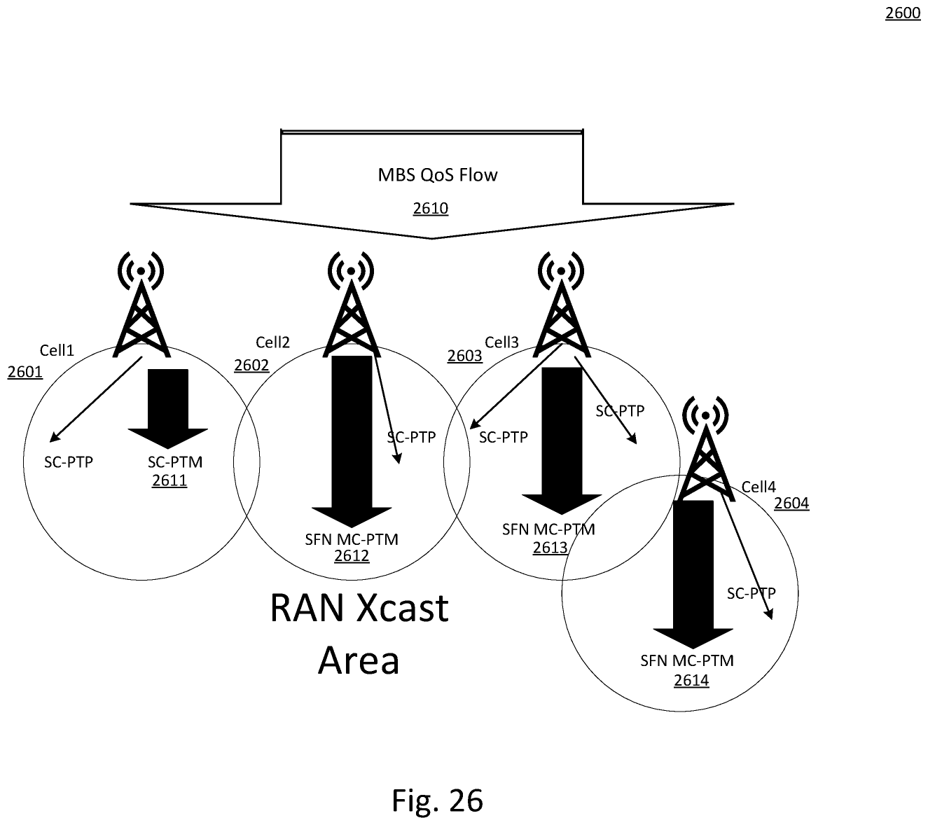

FIG. 26 shows an example of an MBS QoS flow mapped to a number of SC-PTP bearer across the cells of an RAN xcast area 2600. The RAN xcast area may comprise Cell1 2601, Cell2 2602, Cell3 2604, and Cell4 2605. This MBS QoS flow 2610 may also be mapped to a SC-PTM bearer 2611 in Cell1 2601, and to a SFN MC-PTM bearer 2612, 2613, 2614 in Cell2 2602, Cell3 2604, and Cell4 2605d.

UE assistance information is described herein. The following assistance information may be provided by the UE, to help the RAN node determine the RAN delivery method:

UE measurements. This may include RSRP, RSRQ, or SINR measurements. These measurements may be based on the synchronization signals carried in the cell or the CSI reference signals carried in the cell. The measurement results may be used by the RAN node to determine the quality of the signal received from a cell. For example, for a UE that is under poor signal conditions, a RAN node may decide that using a SC-PTP bearer for this UE would be better. A UE may be configured to send the measurement reports periodically, upon entering a cell that supports an MBS service of interest, upon entering a cell that supports MBS, upon starting an interest to an MBS service, upon change of the measured quantity by more than a configured threshold, etc.

UE counting results: This may include a list of MBS services that the UE is interested in receiving or is receiving. The RAN node may send an RRC message to signal the need for counting results. This message may contain a list of services for which counting information is requested. The message may further contain an indication if the counting response is for all UEs, or UEs in a specific state. The message may contain an indication if a one time response is expected or if the response is expected periodically. The message may contain an indication of the persistence of the request. For example, the UE may be asked to provide a response within the next K subframes. The RAN node may use the number of UEs interested in an MBS service to determine the RAN delivery method to use for that service.

UE location information: The UE may provide the RAN node with an indication of its location. The RAN node may use the geographical location of a UE to determine the RAN delivery method to provide the MBS service to the UE. In one example, the RAN node may not be able to provide the MBS service to the UE in a xcast area. In such a case, the RAN node may provide the service to the UE over a SC-PTP bearer.

UE capability: The UE may provide its MBS capability to the RAN node. For example, support of specific MRB types: non SFN MC-PTM, SFN MC-PTM, SC-PTM. This may also include information as to whether the UE is capable of determining its location information (for example if the UE as GPS capability).

UE power state: The UE may provide an indication of its current power state. For example, the UE may indicate if it is tied to a power supply or battery. If the latter, the UE may indicate its current power status. This power status may be a percentage or a general indication such as low/medium/high. The RAN node may use this information along with some other UE context information, to help decide the RAN delivery method to use for this UE.

UE Mobility State: The UE may provide an indication of its mobility state: stationary, low mobility, high mobility. The RAN node may use this information to select a RAN delivery method that would be better suited for the mobility state. For example, if a UE requires an MBS service with strict service continuity, the RAN node may favor a SC-PTP bearer type.

UE context information is described herein. The RAN node may have UE context that may help the RAN node determine the RAN delivery method. For example, this information may include:

UE serving Cell: The RAN node may use the current serving cell to select a suitable RAN delivery method. For example, the UE may be in a cell where the service is already offered by a MC-PTM bearer and the RAN node may select this bearer.

DRX status: The RAN node may be aware of the DRX status and cycles of all the UEs that are interested in a particular MBS service. So, for example, RAN node would know if the UE has an enabled DRX cycle, if UE is in eDRX, or if the UE is in PSM. Based on this information, a RAN node may select a suitable RAN delivery method. For example, the RAN node may select a SC-PTP bearer type for a UE, to allow the UE to take advantage of its configured power savings mechanisms. The RAN node may also use the UE power state assistance information to help make this decision.

RRC status: The RAN node may be aware of the RRC state of all the UEs that are interested in a particular MBS service. So, for example RAN node would know if the UE is in RRC_IDLE, RRC_INACTIVE, or RRC_CONNECTED state. Based on this information, a RAN node may select a suitable RAN delivery method.

UE Capability: The RAN node may obtain some UE capability information from the core network. For example, this may include support of specific MRB types: non SFN MC-PTM, SFN MC-PTM, SC-PTM. This may also include information as to whether the UE is capable of determining its location information (for example if the UE has GPS capability).

UE mobility state: The RAN node may be aware if the UE is stationary, slow moving, or fast moving. The RAN node may use this information to help select the RAN delivery method.

Triggers for a change in RAN delivery mode are described herein. A number of triggers may occur at the RAN node to initiate a RAN delivery mode change. The trigger may be implicit. For example, when a RAN node initially receives an MBMS QoS flow, it may not know the number of UEs that are interested in this MBS service. As a result, the RAN node may initially map an MBMS QoS flow to a SC-PTM radio bearer. Similarly, the UE may implicitly decide to change the RAN delivery method. For example, the UE may want to save power and it may want to use a MC-PTM radio bearer with no feedback.

The triggers may be based on one or more of the monitored metrics. A number of metrics may be used for RAN delivery method selection. In one alternative, the RAN node uses the counting results to select between the RAN delivery method. If the number of UEs interested in a service is above a threshold, the RAN node may decide to use a SC-PTM bearer. If these UEs are spread across a number of cells, the RAN node may decide to use a non SFN MC-PTM bearer or a SFN MC-PTM bearer. In a second alternative, the RAN node may use the measurement results from the UE to select a RAN delivery method. If the UE is in poor coverage, the RAN node may favor a SC-PTP radio bearer. In a third alternative, the RAN node may rely on HARQ feedback statistics to select the RAN delivery method. For example, the RAN node may monitor the NACK feedback from a UE and based on this monitored feedback, the RAN node may decide to use a SC-PTP bearer for the UE. The RAN node may monitor the number of NACKs in a time window, the number of consecutive NACKs, etc.

The triggers may be based on conditions or characteristics of the MBS QoS Flow. In one alternative the RAN node may rely on the QoS requirements of the MBS QoS flow to determine the MRB bearer type. For example, the MBS service may require strict service continuity, favoring the SC-PTP bearer type. In another alternative, the RAN node may rely on RRC state of the UE to select the RAN delivery method. For example, the UEs interested in an MBS service may be in RRC-IDLE or RRC-INACTIVE, favoring the MC-PTM bearer type. In another alternative, the RAN node relies on need for feedback to select RAN delivery method that support feedback. In another alternative, the RAN node relies on need for transmission of an application layer FEC flow to select between SC-PTP bearer and PTM bearer types. In another alternative, the RAN node relies on need for L2 FEC to select RAN delivery methods that support L2 feedback.

The triggers may be based on a specific request from the UE. For example, a UE may request that the RAN node select a certain RAN delivery method. Alternatively, the trigger may be based on a request from the core network. For example, the AMF may request that certain QoS Flows be mapped to certain RAN delivery methods.

(Re)Configuration of MBS radio bearers is described herein. When a RAN node decides on one or more radio bearers to transport a 5G MBS QoS flow, it may configure this/these radio bearers in the UE.

The SC-PTP radio bearer may have a configuration for the PDCP, RLC, MAC, and PHY layers. This configuration may include an indication of which other bearers are configured in the cell for the same 5G MBS QoS flow. For example, the radio bearer may have a radio bearer ID as well as an MBS QoS Flow ID. The latter may be shared by all radio bearers transporting the same MBS QoS flow. Alternatively, the radio bearer may have a radio bearer ID as well as a list of alternative radio bearer IDs. These alternative radio bearer IDs identify the other radio bearers that are available to transport the 5G MBS QoS flow. The configuration may be sent through dedicated signaling to a UE.

The SC-PTM radio bearer may have a configuration for the PDCP, RLC, MAC, and PHY layers. This configuration may include an indication of which other bearers are configured in the cell for the same 5G MBS QoS flow. For example, the radio bearer may have a radio bearer ID as well as an MBS QoS Flow ID. The latter may be shared by all radio bearers transporting the same MBS QoS flow. Alternatively, the radio bearer may have a radio bearer ID as well as a list of alternative radio bearer IDs. These alternative radio bearer IDs identify the other radio bearers that are available to transport the 5G MBS QoS flow. The configuration may be sent through dedicated signaling to a UE. Alternatively, the configuration may be sent through system information. Alternatively, the configuration may be sent partially through dedicated signaling and partially through system information.

The SFN MC-PTM radio bearer may have a configuration for a single leg. It may include configuration of PDCP, RLC, MAC, and PHY layers. This configuration may include an indication of which other bearers are configured in the cell for the same 5G MBS QoS flow. For example, the radio bearer may have a radio bearer ID as well as an MBS QoS Flow ID. The latter may be shared by all radio bearers transporting the same MBS QoS flow. Alternatively, the radio bearer may have a radio bearer ID as well as a list of alternative radio bearer IDs. These alternate radio bearer IDs identify the other radio bearers that are available to transport the 5G MBS QoS flow. The configuration may be sent through system information to a UE.

The non-SFN MC-PTM radio bearer may have a configuration for multiple legs. Depending on where the bearer is split, the configuration may include configuration for multiple PDCP, RLC, MAC, and PHY layers. This configuration may include an indication of the cells that are involved in the multi-cell transmission. For example, this may be a list of Cell IDs. This configuration may also include an indication of which other bearers are configured in the cell for the same 5G MBS QoS flow. For example, the radio bearer may have a radio bearer ID as well as an MBS QoS Flow ID. The latter may be shared by all radio bearers transporting the same MBS QoS flow. Alternatively, the radio bearer may have a radio bearer ID as well as a list of alternative radio bearer IDs. These alternative radio bearer IDs identify the other radio bearers that are available to transport the 5G MBS QoS flow. The configuration may be sent through system information to a UE. Note that it may be possible that a UE does not support all of the legs of a non SFN MC-PTM radio bearer. For example, this may be due to a lack of UE capability. A UE may only be capable of simultaneous reception over a certain number of cells. Alternatively, this may due to poor radio conditions. A UE may not be able to receive DL transmissions from all the cells transmitting the non-SFN MC-PTM radio bearer. In such cases, the UE may need to determine which of the legs to configure.

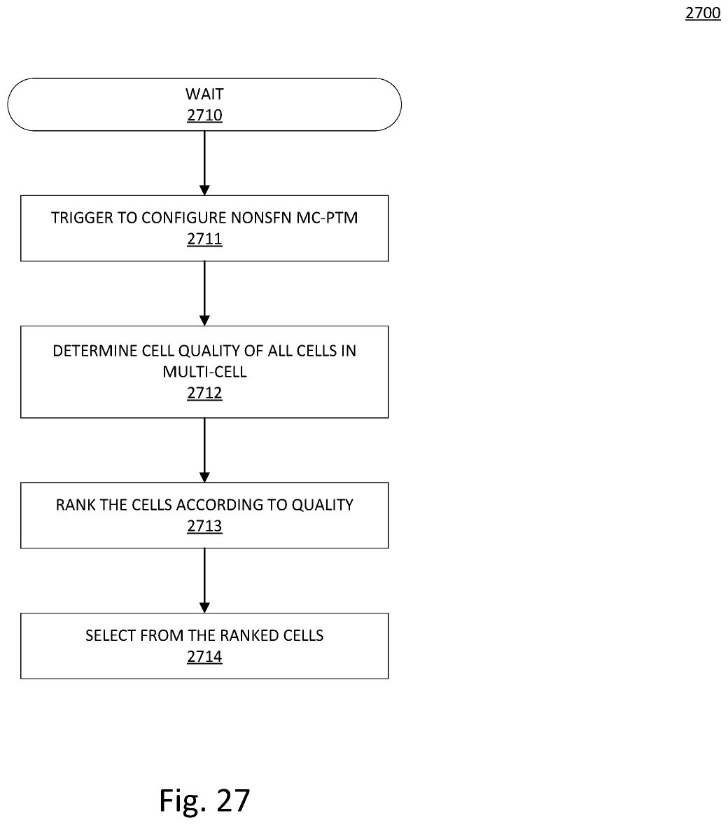

FIG. 27 shows an example procedure for determining the number of legs 2700. At step 2710, the UE may be in a wait state. At step 2711, an event may trigger the UE to configure a non-SFN MBS radio bearer. For example, the UE may become interested in an MBS service that is offered in its current serving cell; the UE may change serving cell, and the new serving cell provides a non-SFN MBS bearer that the UE is interested in; or the UE may be receiving an MBS service through one radio bearer (e.g., SCPTM) and autonomously determines to start receiving the same bearer through another radio bearer (e.g., non-SFN MC-PTM). At step 2712, the UE may determine the cell quality for each of the cells involved in the multi-cell transmission. This may be based on RSRP, RSRQ, or SINR measurements. At step 2713, the UE may rank the cells based on strongest cell quality. At step 2714, the UE may select from the ranked cells. This selection may be based on the strongest K cells, where K is (pre)configured, or established based on UE capability. This selection may be based on a threshold (thresh). The cell is selected only if the measured cell quality is above thresh. Alternatively, the UE may use both limit K and the threshold thresh.

A UE may have multiple radio bearer configurations for the same MBS QoS flow. For example, it may have a dedicated SC-PTP bearer configuration, a common SC-PTM radio bearer configuration, as well as a common SFN MC-PTM configuration. In such cases, only one of these radio bearers may be active at a time. The other radio bearers may be suspended.

An xcast area radio bearer configuration may be determined, which may be common across an xcast area. An xcast area may provide an MBS QoS flow over multiple radio bearers. The combination of these multiple radio bearers comprise an xcast area radio bearer. For example, an xcast area may have 2 DU level xcast areas, each DU-RXA with its own radio bearer. In other words, DU RXA1 may have a SFN MC PTM radio bearer, while DU RXA2 may have a different SFN MC PTM radio bearer. The xcast area radio bearer is made up of the SFN MC PTM radio bearer for DU RXA1 and the SFN MC PTM radio bearer for DU RXA2. In such cases, the xcast area radio bearer configuration may include the configuration for each of the multiple radio bearers associated with the MBS QoS flow across the RAN xcast area. As a result, as long as the UE moves within the RAN xcast area, the UE would know the details of the radio bearers transporting the MBS QoS flow. To enable this, the UE may be configured with an xcast area radio bearer. This xcast area radio bearer may include an indication of the xcast area identity, as well as list of radio bearer configurations. Each of the configurations in this list may include radio bearer ID, an MBS QoS flow ID, a Cell ID, DU RXA ID, CU RXA ID, SCA RXA ID.

If a RAN delivery method change is triggered at a RAN node, the following mechanisms may be used to inform the impacted UEs.

The RAN node may send a dedicated RRC message to the impacted UEs.

This may include the new radio bearer configuration details. If the UE already has the new radio bearer configuration details (for example the new radio bearer may have been previously configured but placed in a suspended state), then the RRC message includes only an indication of the suspended bearer to activate.

If the UE already has the new radio bearer configuration details (for example the new radio bearer may have been previously configured but placed in a suspended state), then the RAN node may send a MAC CE message to the UE, with an indication of which suspended radio bearer to activate. At the UE, the current radio bearer may be moved to a suspended state.

If the UE already has the new radio bearer configuration details (for example the new radio bearer may have been previously configured but placed in a suspended state), then the RAN node may send a DCI signal to the UE, with an indication of which suspended radio bearer to activate. At the UE, the current radio bearer may be moved to a suspended state.

RAN delivery method change may also be triggered at a UE. This may occur due to:

RRC state change: for example when a UE transitions to RRC_IDLE or RRC_INACTIVE, the UE may autonomously transition to a radio bearer that has no UL feedback (such as a non-SFN MC-PTM, or SFN MC PTM bearer, or SC-PTM radio bearer)

Mobility: a UE may change serving cell; and

Power savings: A UE may want to use a power saving feature. To take advantage of this feature it may prefer to use a SC-PTP bearer.

In cases where the RAN delivery method change is triggered at the UE, the UE may need to inform the network of the change or desire to change RAN delivery method. For example, it may send an RRC message to the network with the preferred delivery method.

In cases where the UE transitions from a RAN delivery method that supports uplink feedback to one that does not support uplink feedback, the UE may perform one or more of the following:

If the UE has any pending SR or BSR, the timers associated with these are stopped:

The UE also cancels any pending SR and/or BSR;

If the UE has traffic in the HARQ buffers, these are cleared;

The UE stops any PHR timers; and

The UE stops any CSI timers.

Procedures for radio bearer configuration selection by the network are described herein. For a single cell Xcast area, the gNB has many radio bearer configuration options for transmitting MBS traffic to a UE that is interested in the service. A gNB may additionally decide to change the radio bearer configuration for a particular UE. A gNB may use the following inputs to help it make the radio bearer configuration selection.

The radio bearer configuration option may be tied to the MBS services. The gNB may have a mapping of MBS services to radio bearer configuration type, or MBS service type to radio bearer configuration type. For example, an MBS service with high reliability that has a large number of interested UEs, may use MRB with split radio bearer: PTM leg using RLC-UM and PTP leg using RLC-AM.

The radio bearer configuration option may be tied to the QoS attributes of an MBS services. The gNB may have a mapping of QoS attribute to radio bearer configuration type, or MBS service type to radio bearer configuration type. For example, an MBS service with a very high reliability requirement, may use MRB with single radio bearer using RLC-AM. The QoS attribute may be one or more of priority, reliability, latency, 5QI (5G QoS Identifier), resource type (GBR vs non-GBR).

The radio bearer configuration option may be tied to the number of UEs interested in the service. The gNB may obtain this information from the core network, for example based on the number of UEs that have joined the MBS service. So, if this number is above a certain threshold, the gNB selects a radio bearer configuration that has a PTM leg.

The radio bearer configuration option may be tied to the location of the interested UEs. If UE is very far away, the gNB may decide to use a radio bearer configuration that has a PTP leg.

The radio bearer configuration option may be tied to the RRC state of a UE. If a UE is in RRC Idle or RRC Connected, the UE may use a radio bearer configuration that has a PTM leg and has no HARQ feedback configured.

The radio bearer configuration option may be linked to the number of HARQ transmission failures for a UE. If the number of HARQ failures for a UE crosses a threshold, the gNB may change the radio bearer configuration. The gNB MAC layer may monitor the number of HARQ failures for a Transport Block transmission for the UEs. This monitoring could be for all UEs configured with the G-RNTI. Alternatively, the monitoring could be only for those UEs supporting split bearer. Alternatively, the monitoring could be for all UEs that have split bearer configured. In cases where a TB may have multiplexed MBS services, then not all transport blocks carry MBS service of interest to a UE. For such cases, the monitoring at the gNB may also keep track of the UEs for which feedback is expected.

The radio bearer configuration option may be linked to received RLC status report from the UE. If the number of RLC status reports for a UE crosses a threshold, the gNB may change the radio bearer configuration. Alternatively, this may be based on the contents of the RLC status report

The radio bearer configuration option may be linked to received PDCP status reports from the UE. If the number of PDCP status reports for a UE crosses a threshold, the gNB may change the radio bearer configuration. Alternatively, this may be based on the contents of the PDCP status report. For example, this may be based on the number of PDCP SDUs that need to be retransmitted by the gNB.

The radio bearer configuration option may be linked to received measurement reports from the UE. gNB could use existing measurements or new measurements. For example, the UE may report some MBS signal quality.

The radio bearer configuration option may be linked to received CSI reports from the UE. The radio bearer configuration option may be based on a request from a UE. The UE may send this radio bearer configuration request using a PHY layer signal (over UCI), using a MAC CE, or over an RRC message. The request may be a simple indication to change the radio bearer configuration option, or it may provide additional information—such as the configuration option requested. The UE may send this request based on:
Monitored HARQ failures for a transport block. For example, if number of HARQ failures exceeds a threshold, the UE asks to switch to a radio bearer configuration with a PTP leg;
Radio conditions to the serving cell. For example, if the RSRP is below a first threshold, the UE asks to switch to a radio bearer configuration with a PTP leg. Similarly, if the RSRP is above a second threshold, the UE asks to switch to a radio bearer configuration with a PTM leg;
Location and range to serving cell;
RLC status;
PDCP status.

If the radio bearer configuration for MBS traffic is changed (referred to as a radio bearer reconfiguration), a UE may stop receiving MBS traffic on the old radio bearer configuration and start receiving the MBS traffic on the new radio bearer configuration. The UE procedures resulting from the radio bearer reconfiguration from a DRB to an MRB are described below. In this case, the UE is receiving MBS traffic for a service over a data radio bearer and is then reconfigured to receive the MBS traffic for the service over an MRB which may already be transporting MBS traffic for the service, but to other UEs. In such a case, at the gNB, the PDCP for the DRB and the PDCP for the MRB may receive the SDAP SDU at the same time. However, owing to the independent scheduling of the two radio bearers as well as the different multiplexing for the two radio bearers, the UEs may not necessarily receive these SDAP PDUs at the same time. That is, transmission of the same SDAP PDU across different radio bearers is not synchronized. Consequently, there is a possibility that after radio bearer reconfiguration, a UE may either be missing SDAP PDUs or may receive duplicates of some of these SDAP PDUs. To address this synchronization problem, the following solutions are proposed:

In a first example, new functionality is added to the SDAP layer. This may include sequence numbering, duplicate detection/processing, and status reporting. In such a case, the transmitting SDAP layer may add a SN to each transmitted SDAP PDU (included in the SDAP header) and the receiving SDAP layer may check the incoming SDAP SN to determine if a SDAP PDU is missing or received in duplicate. Any duplicate SDAP PDUs are discarded. If an SDAP PDU is missing, the UE may send a status report to the gNB with the SNs of the missing SDAP PDUs.

In another example, when the UE is reconfigured, it may be told the last PDCP SN that it should monitor over the old radio bearer configuration (before the reconfiguration message). The UE may use both radio bearer configurations for a transition period. Upon reception of the last PDCP SN over the old radio bearer configuration, the UE may stop using the old radio bearer configuration. Any PDCP PDUs received over the new radio bearer configuration are buffered until the UE stops using the old radio bearer configuration. A timer may also be configured to limit the duration of the transition period.

In yet another example, when the UE is reconfigured, it may be told the mapping between the SN on the old radio bearer configuration and the new radio bearer configuration. For example, the UE may be told that PDCP SNs have an offset of ‘K’. This tells the UE that a PDCP SN=x received over the old radio bearer configuration, corresponds to the same PDCP with SN=x+K, received over the new radio bearer configuration. After the reconfiguration, the UE uses the offset ‘K’ to determine if a PDCP PDU is missing or received as a duplicate. It may then discard any duplicate PDCP PDUs. It may also send a PDCP status report to request retransmission of missing PDCP PDUs. In addition, upon receiving a radio bearer reconfiguration with the offset information, the PDCP entity tied to the old radio bearer configuration may transfer the contents of its reception buffer to the PDCP entity of the new radio bearer configuration. In the process it may update the state variables of the PDCP entity to reflect the offset in the PDCP SN.

A UE may be configured with multiple radio bearer configurations for the MBS traffic of a service. In some cases, both may be active at the same time for a transition period. In other cases, only one of these is active at a time, the other may be in a suspended mode. In such a mode, the UE maintains the radio bearer configuration details, but it may clear all state variables associated with the radio bearer.

The UE may have multiple triggers to decide when to change from old radio bearer configuration to new radio bearer configuration. For example, it may use one or a combination of the following triggers:

Based on the reception of reconfiguration message.

Based on a received PDCP SN value. UE may be configured with the last PDCP SN it should monitor on the old radio bearer configuration

Based on a received SDAP SN value. UE may be configured with the last SDAP SN it should monitor on old radio bearer configuration

Based on expiry of a timer. After a reception of a reconfiguration message, the UE may be configured to use both the old radio bearer configuration and the new radio bearer configuration for a transition period. After this transition period, the UE may stop using the old radio bearer configuration.

If the old radio bearer configuration is from MRB to DRB, then the UE may also use reception activity on the DRB to stop using the old MRB radio bearer configuration.

Procedures for path switching of an MRB (PTP<- ->PTM) are described herein. For a single cell Xcast area, a UE may be configured with a radio bearer configuration option: MBS Radio Bearer (MRB) with split radio bearer. For such radio bearers, the gNB may dynamically do path switching, switching the leg/path over which the MBS traffic is sent to the UE.

A gNB may use the following inputs to help it select the path to use for transmission of MBS traffic to a UE, as well as to help make the decision to perform a path switch (from PTP leg/path to PTM leg/path and from PTM leg/path to PTP leg/path).

The path may be tied to the MBS services. The gNB may have a mapping of MBS services to path, or MBS service type to path. For example, an MBS service for multicast TV may initially use a PTM leg/path.

The path may be tied to the QoS attributes of an MBS services. The gNB may have a mapping of QoS attribute to path, or MBS service type to path. For example, an MBS service with a low reliability requirement, may initially use a PTM leg/path. The QoS attribute may be one or more of priority, reliability, latency, 5QI (5G QoS Identifier), resource type (GBR vs non-GBR).

The path may be tied to the number of UEs interested in the service. The gNB may obtain this information from the core network, for example based on the number of UEs that have joined the MBS service. So, if this number is above a certain threshold, the gNB selects a PTM leg/path.

The path may be tied to the location of the interested UEs. If a UE is very far from the serving cell, the UE may initially decide to use a PTP leg/path. Similarly, if UE is moves very far away, the gNB may decide to transition to a PTP leg/path.

The path may be tied to the RRC state of a UE. If a UE is in RRC Connected, the gNB may decide to use a PTP leg/path.

The path may be linked to the number of HARQ transmission failures for a UE. If the number of HARQ failures for a UE crosses a threshold, the gNB may change the path. The gNB MAC layer may monitor the number of HARQ failures for a Transport Block transmission for the UEs. This monitoring could be only for those UEs supporting split bearer. Alternatively, the monitoring could be for all UEs that have split bearer configured. In cases where a TB may have multiplexed MBS services, then not all transport blocks carry MBS service of interest to a UE. For such cases, the monitoring at the gNB may also keep track of the UEs for which feedback is expected.

The path may be linked to received RLC status report from the UE. If the number of RLC status reports for a UE crosses a threshold, the gNB may change the path. Alternatively, this may be based on the contents of the RLC status report.

The path may be linked to received PDCP status reports from the UE. If the number of PDCP status reports for a UE crosses a threshold, the gNB may change the path. Alternatively, this may be based on the contents of the PDCP status report. For example, this may be based on the number of PDCP SDUs that need to be retransmitted by the gNB. In one implementation, the network may configure the UE with a missing PDCP threshold. This threshold may be a number of missing PDCP PDUs observed over an observation window, a number of consecutive missing PDCP PDUs, or a percentage of missing PDUs. When the PDCP entity at the UE observes that the number of missing PDCP PDUs exceeds this threshold, the PDCP entity triggers the UE to send a PDCP status report to the gNB.

The path may be linked to received measurement reports from the UE. gNB could use existing measurements or new measurements. For example, the UE may report some MBS signal quality.

The path may be linked to received CSI reports from the UE.

The path may be based on a request from a UE. The UE may send this path request using a PHY layer signal (over UCI), using a MAC CE, or over an RRC message. The request may be a simple indication to change the radio bearer configuration option, or it may provide additional information—such as the configuration option requested. The UE may send this request based on:

Monitored HARQ failures for a transport block. For example, if number of HARQ failures exceeds a threshold, the UE asks to switch to a radio bearer configuration with a PTP leg.

Radio conditions to the serving cell. For example, if the RSRP is below a first threshold, the UE asks to switch to a radio bearer configuration with a PTP leg. Similarly, if the RSRP is above a second threshold, the UE asks to switch to a radio bearer configuration with a PTM leg.

Location and range to serving cell.

RLC status.

PDCP status.

The path switching may be transparent to the UE. In the case of transparent path switch, the UE may need to monitor both paths, and may determine as to when to stop processing one path over the other. For example, after a PTM to PTP path switch, the UE should be receiving its MBS traffic on the PTP path. However, the gNB may still be transmitting on the G-RNTI that was configured for the PTM path (as this PTM path is used by multiple UEs). In this case, the UE may be receiving transport blocks on both paths, transmitting HARQ feedback on both paths, demultiplexing MAC PDUs on both paths, etc. This leads to unnecessary processing and power consumption at the UE and may lead to wasted over-the-air resources.

As a result, rules need to be defined for the UE to determine which of the two legs/paths the UE should ‘process’. Here the term ‘process’ is used to denote reception of transport blocks over C-RNTI for the PTP path or reception of transport blocks over G-RNTI for the PTM path. These rules may include one or more of the following:

Activity based: If UE detects that traffic is present on the C-RNTI, UE starts processing the C-RNTI. When processing the C-RNTI, the UE does not process the G-RNTI, effectively turning off the processing for the G-RNTI. Alternatively, if UE detects that ‘MBS traffic’ is present on the C-RNTI, UE starts processes the C-RNTI. The MAC header may include a field to indicate that it contains MBS traffic. As another alternative, if UE detects that ‘MBS traffic for MBS services of interest’ is present on the C-RNTI, UE starts processes the C-RNTI. The MAC header may include a bit field to indicate which services are carried in the C-RNTI

Timer based: If the UE is processing traffic from the PTP leg/path but has not received any traffic on this leg for an inactivity time, the UE may start processing the G-RNTI (effectively turning on the PTM leg). This inactivity time may be (pre)configured through RRC signaling as part of the MRB radio bearer configuration. Alternatively, if the UE is processing traffic from the PTP leg/path but has not received any ‘MBS traffic’ on this leg for an inactivity time, the UE may start processing the G-RNTI. As another alternative, if the UE is processing traffic from the PTP leg/path but has not received any ‘MBS traffic for the MBS services of interest’, on this leg for an inactivity time, the UE may start processing the G-RNTI.

The path switching may be explicitly signaled to the UE. The gNB may send the switching request through a PHY mechanism (DCI), MAC CE, or RRC signaling. Alternatively, the switching request may be sent in a MAC header field of the current leg/path. For example, a MAC header may include a 1-bit NewPathIndicator. When this indicator is toggled this may indicate that the UE should change path. Alternatively, the value of the bit field may indicate that the UE should change path. For example, when a UE receives a MAC PDU with NewPathIndicator=1, the UE changes the reception leg/path of the associated MRB.

After a path switch, a UE may change its RLC configuration from an old RLC entity to a new RLC entity. The old RLC entity may have RLC PDUs stored in its reception buffer. The UE may have transport blocks received at the PHY layer that contains MBS traffic. After a PTP-PTM path switch, the UE may clear the contents of the HARQ buffers of the PTP leg; demultiplex the MAC PDU, but discard any RLC PDUs from the PTP leg/path; for the PTP leg/path, clear the contents of the RLC layer reception buffer; for the PTP leg/path, deliver the contents of the RLC layer to the PDCP layer; transfer the contents of the reception buffer from the PTP leg/path to the PTM leg/path.

After a PTM-PTP path switch, it is proposed that the UE may clear the contents of the HARQ buffers of the PTP leg; demultiplex the MAC PDU, but discard any RLC PDUs from the PTM leg/path; for the PTM leg/path, clear the contents of the RLC layer reception buffer; for the PTM leg/path, deliver the contents of the RLC layer to the PDCP layer; transfer the contents of the reception buffer from the PTM leg/path to the PTP leg/path; suspend the RLC entity of the PTM leg/path.

On a switch from PTM to PTP, the gNB may guarantee that the logical channels of the traffic multiplexed in C-RNTI may have unique LCIDs. Alternatively, if LCID collisions are possible, the MAC header may include a new field to indicate whether the logical channel belongs to a DRB or a MRB split bearer. It may additionally indicate which MRB split bearer.

Another alternative to path switching is to have the UE receive the MBS traffic over the selected path but continue to monitor the other path. For example, in a PTM-PTP switch, after the UE determines that it should begin monitoring the traffic over the PTP leg, the UE may continue to additionally monitor the MBS traffic over the deactivated PTM leg, as this traffic is still being transmitted. The UE may continue to process MBS PDUs received on the PTM leg and continue to perform HARQ combining. The UE may even collect HARQ feedback statistics for the PTM leg. The network may configure the UE to not send HARQ feedback for the deactivated PTM leg. The UE may discard any recovered transport blocks on the deactivated PTM leg. Alternatively, the UE may continue to process the recovered transport blocks and forward them to the higher layers. In such a case, it is possible that a PDCP PDU be received over both PTP and PTM legs. The PDCP layer relies on its duplicate detection functionality to eliminate duplicate PDCP PDUs. The UE may use HARQ statistics of the PTM leg to determine when to perform a path switch between PTP leg and PTM leg. The network may configure the UE with HARQ statistics related thresholds in support of a PTM versus a PTP path switch decision in the UE. The UE may autonomously decide to switch back to the PTM leg. For example, the UE may determine that the number of HARQ ACKs over the PTM path exceeds a configured threshold. In such a case, the UE may send an indication to the network that it has switched back to the PTM leg. This indication may be explicit (e.g., over PHY layer signaling, over MAC signaling, or over RRC signaling). Alternatively, the indication may be implicit. For example, the UE may start sending HARQ feedback for the traffic it receives on the PTM leg. In either case, the network receives this explicit or implicit indication and determines that it should stop scheduling the MBS service for the UE over the PTP leg. As another alternative, the gNB may decide to switch back to the PTM leg. The gNB may base this decision on some indication from the UE. In such a case, the UE may send an indication to the network that it would prefer to switch back to the PTM leg. This indication may be explicit (e.g., over PHY layer signaling, over MAC signaling, or over RRC signaling).

Multicast change of state procedures are described herein. The MBS QoS flows of an MBS service may be transmitted over one or more MRBs and one or more DRBs. A UE may need to receive multiple MRBs and/or DRBs to properly receive the MBS service. In order for the UE to know which MRBs and/or DRBs are linked to which MBS service, it is proposed that all services be identified by a unique MBS Service ID (or MBS Session ID). The unique MBS Service ID may be the TMGI, or different from the TMGI. The unique MBS Service ID may be part of the MBS control information for the service. The unique MBS Service ID may be part of the MRB configuration and/or the DRB configuration. This allows the UE to know which MRBs and DRBs are associated with an MBS service

A multicast session may change from Active to Inactive state.

Active multicast session: Established multicast session in active state. Multicast data are transmitted to UEs that joined the multicast session. 5GC resources for the multicast session are reserved. Corresponding radio resources are reserved depending on participating UE locations. UEs that joined the multicast session are in CM CONNECTED or CM IDLE state. UEs are allowed to join the multicast session (subject to authorization check).

Inactive multicast session: Established multicast session in inactive state. No multicast data are transmitted. UEs that joined the multicast session may be in CM CONNECTED or CM IDLE state. UEs are allowed to join the multicast session (subject to authorization check).

On a transition from ACTIVE to INACTIVE state, the gNB may send an indication to the UEs that the multicast service is transitioning to INACTIVE state. The gNB may send this indication through a paging message to the UEs. Alternatively, the gNB may send this indication with the MBS traffic, either through PHY signaling, MAC signaling, or RRC signaling. The gNB may include duration information in the indication. The UE may use this duration information to determine how long the service will be INACTIVE. Alternatively, the UEs may autonomously determine that a service is INACTIVE. The UEs may make this determination based on inactivity on the MRBs associated with the MBS service. In order to assist the UE in this determination, the gNB may configure the UE with inactivity timer related information. The gNB may include this inactivity timer related information in the MBS control information of the MBS service.

When a multicast service transitions to INACTIVE, the UE may use the unique MBS Service ID to identify all MRBs and DRBs associated with this multicast session. For the MRBs with a single PTM leg, the UE may stop monitoring the PTM transmissions over the configured G-RNTI if no other MBS service is multiplexed over the G-RNTI. For the MRBs with a split bearer, the UE may stop monitoring the transmissions over the configured G-RNTI of the PTM leg if no other MBS service is multiplexed over the G-RNTI. The UE may transition all MRBs and DRBs associated with the multicast session to an “inactive” state. In such a state, the UE maintains the configuration of the radio bearers, but it does not maintain any timers or windows related to these radio bearers. So, the timers are stopped and the buffers are flushed. Before transitioning these radio bearers to “inactive”, the UE may perform actions to facilitate the transition of these radio bearers back to an “active” state. For example, the RLC layer may forward all RLC PDUs in its reception/reordering windows to the PDCP entity. The PDCP entity may forward all PDCP PDUs in its reception/reordering windows to the SDAP entity. In addition, if the PDCP entity determines that there are missing PDCP PDUs, the PDCP entity may send a PDCP status report to the gNB so that these missing PDCP PDUs may be resent. The RLC and PDCP entities may also maintain/store the value/content of their state variables. That is, the state variables of the RLC and PDCP layer are not cleared when a radio bearer transitions to “inactive”.

When this multicast service later transitions to ACTIVE, the impacted UEs need to be made aware. The network may page the UEs in RRC_IDLE and RRC_INACTIVE. The paging message may include the unique MBS Service ID. The gNB may also page UEs in RRC_CONNECTED state. Alternatively, the gNB may notify these UEs through dedicated signaling. The UE uses the unique MBS Service ID to identify the MRBs and DRBs associated with this multicast session. For the MRBs with a single PTM leg, the UE may begin monitoring the PTM transmissions. For the MRBs with a split bearer, the UE may begin monitoring the transmissions over the PTM leg. The UE may transition all MRBs and DRBs associated with the multicast session to an “active” state. The following options are possible for the state variables maintained by the PDCP and RLC layers:

The UE may be provided with the initial values of these state variables for all the MRBs and DRBs associated with the multicast session. The network may provide these initial values through dedicated signaling and/or through the paging message.

The UE may use the stored values of the state variables (stored when the radio bearers were transitioned to inactive).

The UE may use default initial values for these state variables, the default values known to both the UE and the network.

Xcast area management procedures are described herein. An xcast area is a grouping of cells over which the MBS service is offered. The xcast area may provide the MBS service over one or more of the RAN delivery methods (SC-PTM, non-SFN MC-PTM, SFN MC-PTM). The xcast area may be made up of a grouping of individual cells, or a grouping of a set of cells (for example all the cells under a DU, all the cells under a CU, etc.). The xcast area may be a grouping of a single cell level xcast areas, a grouping of CU level xcast areas, a grouping of DU level xcast areas, or a mixed grouping of single cell level xcast areas, CU level xcast areas, and DU level xcast areas. The xcast area may be denoted as a set of cell IDs, set of CU IDs, and/or set of DU IDs. For example: xcast-area=set {Cell_ID1, . . . , Cell_IDk, CU_ID1, . . . CU_IDj, DU_ID1, . . . , DU_IDm}.

The xcast area may be maintained for an MBS service or group of MBS services (typically with similar QoS requirements, traffic patterns, coverage requirements, etc.). An initial xcast area for an MBS service or group of MBS services may be defined. The core network may provide this initial xcast area to the RAN. For example, this may be provided when the MBS session is started. It may be based on the geographical area that the MBS content provider wants to cover. After this initial xcast area is defined, the xcast area may be dynamically changed depending on a number of conditions:

UE state change: a UE receiving MBS services over an xcast area, may change from an RRC_CONNECTED to RRC_IDLE or RRC_INACTIVE. If this is the first UE in the cell receiving the MBS service, the RAN node may decide to add the cell to the xcast area (and configure a suitable PTM radio bearer (SC-PTM, non-SFN MC-PTM, SFN MC-PTM) for this cell). Alternatively, if this is the first UE in the DU receiving the MBS service, the RAN node may decide to add the DU to the xcast area (and configure a suitable PTM radio bearer (SC-PTM, non-SFN MC-PTM, SFN MC-PTM) for this DU). Alternatively, if this is the first UE in the CU receiving the MBS service, the RAN node may decide to add the CU to the xcast area (and configure a suitable PTM radio bearer (SC-PTM, non-SFN MC-PTM, SFN MC-PTM) for this CU).

UE mobility: a UE receiving MBS services over an xcast area, may change serving cell. The new serving cell may be added to the xcast area. In some cases, this may be the last UE receiving the MBS service over PTM radio bearers in the old serving cell. In such a case, the old serving cell may be removed from the xcast area.

A RAN delivery method change: the RAN node may decide to change the RAN delivery method to a UE. For example, it may change the delivery method to a PTP radio bearer (SC-PTP) for a given cell. If this is the last UE in the cell using the PTM radio bearer, the RAN node may decide to remove the cell from the xcast area. If this is the last UE in the DU using the PTM radio bearer, the RAN node may decide to remove the DU from the xcast area. If this is the last UE in the CU using the PTM radio bearer, the RAN node may decide to remove the CU from the xcast area.

UE losing interest in an MBS service: a UE in a given cell, may decide that it is no longer interested in an MBS service. If this is the last UE in the given cell using this service, the cell may be removed from the xcast area.

UE becoming interested in an MBS service: a UE in a given cell, may decide that it is interested in an MBS service. If this is the first UE in the given cell using this service, the cell may be added to the xcast area.

UE powering on.

Request from the core network: the content provider may request that the xcast area be changed (for example to reduce the coverage area or to increase the coverage area).

Note that the RAN node may also use other metrics/conditions to determine the xcast area. These are the same metrics/conditions used by the RAN node to make RAN delivery method decisions. For example, the RAN node may use the number of UEs interested in the MBS service. In addition, the UE may provide further assistance to the RAN node to help determine the xcast area. For example, this information may be provided in the following RRC messages: MBSInterestIndication, RRCSetupRequest, RRCResumeRequest.

The xcast area may be provided to the UEs using an Information Element (IE), for example xcastAreaList. This IE would comprise the set of Cell IDs, CU IDs, and/or DU_IDs. This IE may be sent as part of the system information, in a new MBS SIB (e.g. SystemInformationBlockTypeX). In such a case, a change in xcast area would be achieved through SI change indication procedure, as defined in TS 38.331, NR; Radio Resource Control (RRC); Protocol specification, V16.1.0. The system information may include multiple xcastAreaList IEs, one for each xcast area that the cell belongs to (as a cell may belong to more than one xcast area).

Alternatively, this IE may be sent as part of the xcast area configuration that is transmitted over the SC-MCCH, MCSF-MCCH, or MCMF-MCCH in the xcastAreaConfiguration message. In such a case, a change in xcast area would be achieved through MCCH change notification procedure. Note that separate messages and/or IEs may be used for each of the MCCH logical channels.

As another alternative, this IE may be sent as part of an RRCReconfiguration message over DCCH. As yet another alternative, the UE may be sent an indication to read the xcastAreaConfiguration message carried over the MCCH.

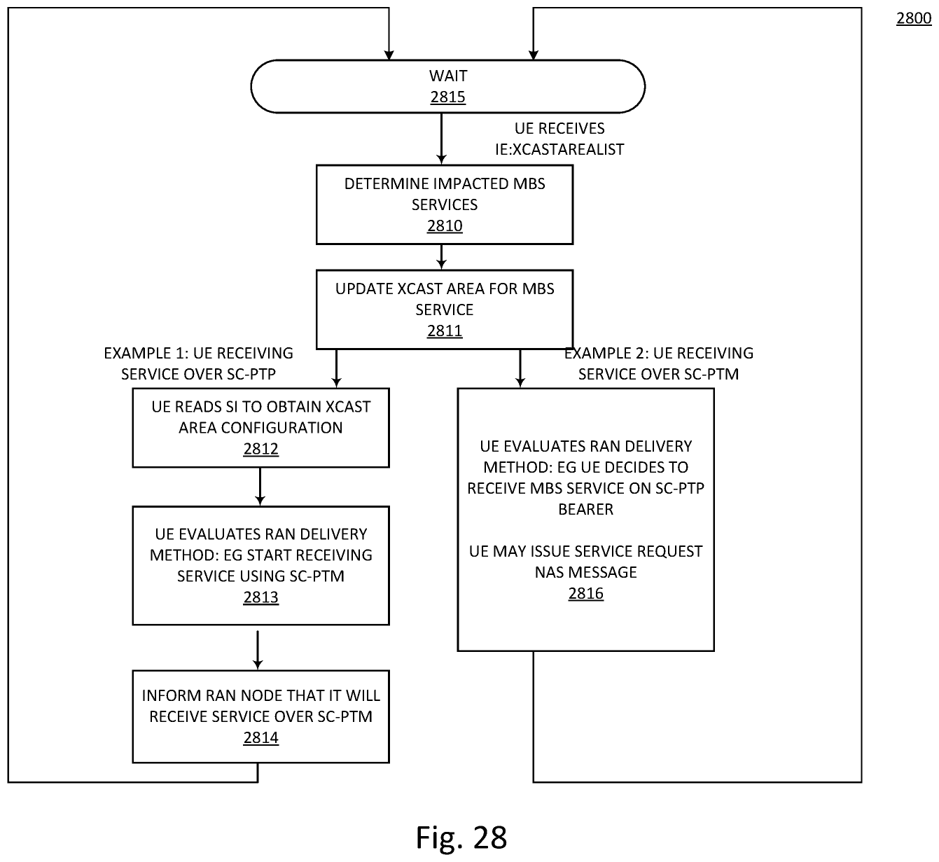

FIG. 28 shows an example of UE actions upon change on xcast area 2800. At step 2810, the UE may determine the impacted MBS services. At step 2811, the UE may update the xcast area it is maintaining for this MBS service. For example, a UE may currently be receiving the MBS service over a SC-PTP bearer, and the current serving cell may be newly added to the xcast area. At step 2812, the UE may read the system information and then may obtain the xcastAreaConfiguration message to determine the xcast area radio bearer configuration or the MBS radio bearer configurations in the current serving cell. For example, the MBS service may be offered over a SC-PTM radio bearer in the current serving cell. At step 2813, the UE may decide to change the RAN delivery method for the MBS service. For example, the UE may decide to continue receiving the service over a SC-PTM bearer. At step 2814, the UE may inform the RAN node that it may be receiving the service over the SC-PTM bearer and that, as a result, it no longer needs the SC-PTP connection. After some time, the UE receives another xcast area update (step 2815). The UE may then repeat steps 2810 and 2811. For example, the UE may be currently receiving the MBS service over a SC-PTM bearer, and the current serving cell may be removed from the xcast area. At step 2816, the UE may decide to change RAN delivery mode for the MBS service. For example, the UE may decide to send a Service Request NAS message, in order to establish a SC-PTP bearer to obtain the MBS service. Alternatively, the UE may decide to stop receiving the MBS service and inform upper layers.

The following Abbreviations and Definitions are used herein:
3GPP 3rd Generation Partnership Project
5G 5th Generation
5GS 5G System
AMF Access and Mobility Management Function
ARQ Automatic Repeat Request
BM-SC Broadcast Multicast Service Center
CFI Control Format Indicator
CP Cyclic Prefix
CN Core Network
CU Central Unit
CU-RXA Central Unit RXA
DCI Downlink Control Information
DL-SCH Downlink Shared Channel
DRX Discontinuous Reception
DU Distributed Unit
DU-RXA Distributed Unit RXA
eNB enhanced Node B
EN TV Enhanced Television
EPS Evolved Packet System
E-UTRA Evolved UMTS Terrestrial Radio Access
eMBMS Enhanced MBMS
FeMBMS Further enhancements MBMS
FR2 Frequency Range 2 (frequency bands from 24.25 GHz to 52.6 GHz)
gNB 5G Node B
GPRS General Packet Radio Service
G-RNTI Group RNTI
GW Gateway
HARQ Hybrid ARQ
ID Identity
IE Information Element
IoT Internet of Things
ITS Intelligent Transport System
LTE Long Term Evolution
MAC Media/Medium Access Control
MBMS Multimedia Broadcast Multicast services
MBMS GW MBMS Gateway
MBS Multicast/Broadcast Service
MBS GW Multicast/Broadcast Service GW
MBSFN Multicast-broadcast single-frequency network
MCCH Multicast Control Channel
MCE Multi-cell/multicast coordination entity
MCH Multicast transport channel
MCMF-MCCH Multi-Cell Multi-Frequency MCCH
MCMF-MTCH Multi-Cell Multi-Frequency MTCH
MCSF-MCCH Multi-Cell Single-Frequency MCCH
MCSF-MTCH Multi-Cell Single-Frequency MTCH
MC-PTM Multi-Cell PTM
MC-RXA Multi-Cell RXA
MCS Modulation and Coding Scheme
MIMO Multiple Input Multiple Output
MooD MBMS operation on Demand
MRB Multicast/Broadcast Radio Bearer
MTCH Multicast Traffic Channel
NAS Non-Access Stratum
OFDM Orthogonal Frequency Division Multiplexing
PDCCH Physical Downlink Control Channel
PDCP Packet Data Convergence Protocol
PDSCH Physical Downlink Shared Channel
PMCH Physical Multicast Channel
PSM Power Save Mode
PTP Point-to-Point
QoS Point-to-Multipoint
RAN Radio Access Network
RLC Radio Link Control
ROM Receive-only-Mode
RNL Radio Network Layer
RNTI Radio Network Temporary Identifier
RSRP Reference signal received power
RSRQ Reference Signal Received Quality
RXA RAN Xcast Area
SC-MCCH Single Cell MCCH
SC-MTCH Single Cell MCTH
SC-PTP Single Cell PTP
SC-PTM Single Cell PTM
SC-RNTI Single Cell RNTI
SC-RXA Single Cell RXA
SDAP Service Data Adaptation Protocol
SFN Single Frequency Network
SFN System Frame Number
SIM Subscriber Identity Module
SINR Signal-to-noise and Interference Ratio
STMGI Super TMGI
STU System Time Unit
STUN System Time Unit Number
TBS Transport Block Size
TDM Time Division Multiplexing
TMGI Temporary Mobile Group Identity
TNL Transport Network Layer
UE User Equipment
UL Uplink
UM Unacknowledged Mode
UPF User Plane Function
V2X Vehicle to Anything

The following terms/definitions are used herein:

Multicast Service: A unidirectional point-to-multipoint service in which data is efficiently transmitted from a single source to a multicast group in the associated multicast service area. Multicast services can only be received by such users that are subscribed to the specific multicast service and have joined the multicast group associated with the specific service.

Broadcast Service: A unidirectional point-to-multipoint service in which data is efficiently transmitted from a single source to multiple UEs in the associated broadcast service area. Broadcast services may be received by all users who have enabled the specific broadcast service locally on their UE and who are in the broadcast area defined for the service.

MBS Session: The core network delivery mechanism for an MBS service

Multicast Session: The core network delivery mechanism for a multicast session

Broadcast Session: The core network delivery mechanism for a broadcast session

Service Continuity in relation to MBS: Service Continuity implies that the UE would continue to receive (with no or little service interruption) an MBS service despite changing serving cell, changing RRC state, or changing RAN delivery method for the MBS service.

Single Frequency Network: A set of cells operating on the same frequency. In the context of MBMS, it further implies that the transmissions from all the cells are synchronized and use the same transmission format (MCS, TBS, . . . ).

PTP: A term used in the radio access network to denote a case that the over the air transmissions are from a single RAN node to a single UE. gNB individually delivers separate copies of MBS data packets to each UEs independently, i.e. gNB uses UE-specific PDCCH with CRC scrambled by UE-specific RNTI (e.g., C-RNTI) to schedule UE-specific PDSCH which is scrambled with the same UE-specific RNTI.

PTM: A term used in the radio access network to denote a case that the over-the-air transmissions are from a single RAN node to multiple UEs. PTM transmissions from multiple cells may be combined to create a Multi-Cell PTM transmission. gNB delivers a single copy of MBS data packets to a set of UEs, i.e., gNB uses group-common PDCCH with CRC scrambled by group-common RNTI to schedule group-common PDSCH which is scrambled with the same group-common RNTI.

MBS transmission area: The transmission area over which an MBS service is offered.

RAN delivery method: Method by which a RAN node transmits the MBS traffic over the Uu interface. RAN delivery methods may be of unicast radio bearer type or MBS radio bearer (MRB) type.

Xcast Area: A RAN Xcast area may be considered a grouping of one or more cells that provide an MBS service, or group of MBS services, through one or more RAN delivery methods that are known to the UE or may be determined by the UE. In other words, a UE receiving an MBS service (or group of MBS services) in one cell (for example cell1) of an RXA, may also know how to receive the same MBS service (or group of MBS services) in another cell of the RXA (for example cell2).

MBS Radio bearer: a radio bearer for MBS traffic. The MBS radio bearer may be of split bearer type, with a PTP leg and a PTM path. Alternatively, an MBS radio bearer may be a single bearer of PTM type.

Split Bearer: a type of radio bearer that has two legs. In the context of MBS, one of these legs is a PTP leg, while the other is a PTM leg. The anchor of the split bearer may be at different layers: SDAP, PDCP, RLC, MAC.

Group RNTI: an RNTI that is destined for a group of UEs. May also be referred to as a group-common RNTI

PTP Path or PTP leg: One leg of a split bearer, where the transport block is transmitted to a single UE using a C-RNTI

PTM Path of PTM leg: One leg of a split bearer, where the transport block is transmitted to a number of UEs, all sharing the same G-RNTI.

MBS transmissions: Transmissions of MBS services.

Unicast transmissions: Transmissions of unicast services.

1.-20. (canceled)

21. A wireless transmit/receive unit (WTRU) comprising a transceiver and one or more processors configured to:
receive, from a base station, a configuration for a split multicast-broadcast service (MBS) radio bearer, wherein the split MBS radio bearer comprises a point-to-point (PTP) leg and a point-to-multipoint (PTM) leg;
receive, from the base station via the PTP leg of the split MBS radio bearer, multicast traffic associated with the MBS service;
determine that no MBS traffic has been received, via the PTP leg of the split MBS radio bearer, for a configured period of time; and
receive, from the base station via the PTM leg of the split MBS radio bearer, multicast traffic associated with the MBS service.

22. The WTRU of claim 21, wherein when receiving, from the base station via the PTP leg of the split MBS radio bearer, the multicast traffic associated with the MBS service, there is no reception of the multicast traffic on the PTM leg of the split MBS radio bearer.

23. The WTRU of claim 21, wherein when receiving, from the base station via the PTM leg of the split MBS radio bearer, multicast traffic associated with the MBS service, there is no reception of the multicast traffic on the PTP leg of the split MBS radio bearer.

24. The WTRU of claim 21, wherein the WTRU is further configured to:
send, to the based station, an acknowledgment indicating a switch from the PTP leg to the PTM leg for reception of multicast traffic associated with the MBS service.

25. The WTRU of claim 21, wherein the WTRU is further configured to:
send, to the based station, an acknowledgment indicating a switch from the PTM leg to the PTP leg for reception of multicast traffic associated with the MBS service.

26. The WTRU of claim 21, wherein the WTRU is further configured to:
receive, from the based station, information indicating a switch from the PTM leg to the PTP leg for reception of multicast traffic associated with the MBS service.

27. The WTRU of claim 21, wherein the WTRU is further configured to:
receive, from the based station, information indicating a switch from the PTP leg to the PTM leg for reception of multicast traffic associated with the MBS service.

28. A method for use in a wireless transmit/receive unit (WTRU) comprising a transceiver and one or more processors, the method comprising:
receiving, from a base station, a configuration for a split multicast-broadcast service (MBS) radio bearer, wherein the split MBS radio bearer comprises a point-to-point (PTP) leg and a point-to-multipoint (PTM) leg;
receiving, from the base station via the PTP leg of the split MBS radio bearer, multicast traffic associated with the MBS service;
determining that no MBS traffic has been received, via the PTP leg of the split MBS radio bearer, for a configured period of time; and
receiving, from the base station via the PTM leg of the split MBS radio bearer, multicast traffic associated with the MBS service.

29. The method of claim 28, wherein when receiving, from the base station via the PTP leg of the split MBS radio bearer, the multicast traffic associated with the MBS service, there is no reception of the multicast traffic on the PTM leg of the split MBS radio bearer.

30. The method of claim 28, wherein when receiving, from the base station via the PTM leg of the split MBS radio bearer, multicast traffic associated with the MBS service, there is no reception of the multicast traffic on the PTP leg of the split MBS radio bearer.

31. The method of claim 28, further comprising:
sending, to the based station, an acknowledgment indicating a switch from the PTP leg to the PTM leg for reception of multicast traffic associated with the MBS service.

32. The method of claim 28, further comprising:
sending, to the based station, an acknowledgment indicating a switch from the PTM leg to the PTP leg for reception of multicast traffic associated with the MBS service.

33. The method of claim 28, wherein the WTRU is further configured to:
receiving, from the based station, information indicating a switch from the PTM leg to the PTP leg for reception of multicast traffic associated with the MBS service.

34. The method of claim 28, wherein the WTRU is further configured to:
receiving, from the based station, information indicating a switch from the PTP leg to the PTM leg for reception of multicast traffic associated with the MBS service.

35. A method for use in a network node comprising a transceiver and one or more processors, the method comprising:
sending, to a wireless transmit/receive unit (WTRU), a configuration for a split multicast-broadcast service (MBS) radio bearer, wherein the split MBS radio bearer comprises a point-to-point (PTP) leg and a point-to-multipoint (PTM) leg;
sending, to the WTRU via the PTP leg of the split MBS radio bearer, multicast traffic associated with the MBS service; and
sending, to the WTRU via the PTM leg of the split MBS radio bearer, multicast traffic associated with the MBS service.

36. The method of claim 35, wherein when sending, to the WTRU via the PTP leg of the split MBS radio bearer, the multicast traffic associated with the MBS service, there is no sending of the multicast traffic on the PTM leg of the split MBS radio bearer.

37. The method of claim 35, wherein sending, to the WTRU via the PTM leg of the split MBS radio bearer, the multicast traffic associated with the MBS service, there is no sending of the multicast traffic on the PTP leg of the split MBS radio bearer.

38. The method of claim 35, further comprising:
receiving, from the WTRU, an acknowledgment indicating a switch from the PTP leg to the PTM leg for reception of multicast traffic associated with the MBS service.

39. The method of claim 35, further comprising:
receiving, from the WTRU, an acknowledgment indicating a switch from the PTM leg to the PTP leg for reception of multicast traffic associated with the MBS service.

40. The method of claim 35, wherein the WTRU is further configured to:
sending, to the WTRU, information indicating a switch from the PTM leg to the PTP leg for reception of multicast traffic associated with the MBS service, or from the PTP leg to the PTM leg for reception of multicast traffic associated with the MBS service.
